(19) United States
(12) Patent Application Publication
(10) Pub. No.: US 2013/0297066 A1
(43) Pub. Date: Nov. 7, 2013

(54) Product Provisioning System

(71) Applicant: Stein Alvern, London (GB)

(72) Inventor: Stein Alvern, London (GB)

(73) Assignee: Pheonix Gruppen, Oslo (NO)

(21) Appl. No.: 13/988,308

(22) PCT Filed: Nov. 30, 2011
(86) PCT No.: PCT/EP2011/071449

§ 371 Date: Jul. 10, 2013

(30) Foreign Application Priority Data
Nov. 30, 2010 (GB) 1020292.7
Mar. 8, 2011 (GB) 1103927.8
Mar. 25, 2011 (GB) 1105059.8
Apr. 18, 2011 (GB) 1106536.4
Jul. 15, 2011 (GB) 1112302.5

(51) Int. Cl. G07F 11/62

(52) U.S. Cl. CPC G07F 11/62
USPC 700/232

(57) ABSTRACT

Product provisioning methods and systems are described. A product provisioning system is arranged, in use, to deliver to a user substantially simultaneously a plurality of heterogeneous discrete products. The product provisioning system comprises a plurality of independently-controllable product dispensing mechanisms each configured to dispense different predetermined types of said discrete products from one another. The product provisioning system also comprises a product collector arranged to collect together products dispensed by the plurality of product dispensing mechanisms. Furthermore, the product provisioning system also comprises a control system. The control system is in communication with the product dispensing mechanisms, and is arranged to receive a user-specified product order for multiple heterogeneous products and, in response, control a set of the plurality of product dispensing mechanisms in parallel to dispense specified products of that product order.

### FIELD OF THE INVENTION

The present invention relates to an improved product provisioning system and its various components. In particular, the present invention relates to a product provisioning system that is arranged to simultaneously dispense multiple discrete, generally packaged products, thereby increasing product delivery throughput.

### BACKGROUND TO THE INVENTION

Product provisioning systems such as vending machines vend packaged products to users on-demand, and can conveniently be provided at locations where it is difficult or uneconomical to station staff, especially at all hours of the day. A common example of a vending machine is a soft drinks machine.

Such vending machines contain and dispense a limited number of products, and may be restricted to certain product ranges (for example, drinks, confectionary or tobacco products). As such, products may sell-out quickly and so these systems need to be frequently restocked by staff. Furthermore the limited range restricts consumer choice.

There are a number of reasons why such prior known systems may be restricted in terms of the number of or range of products. One reason relates to how many different products can be physically contained within the machine. Separate dispensing mechanisms are generally required for each set of products. Therefore, a large number of different sized and shaped products generally require a large number of different dispensing mechanisms—each of which take up valuable space within the vending machine.

Another issue is the difficulty in showing which product brands are contained within the machine, and which of those brands are in stock. One way to do this is to show a picture of the brand of a product on a product selection button on the vending machine. Each button may be illuminated in a way that indicates whether that corresponding product is in stock. Unfortunately, this arrangement makes it difficult to change the brand of products within the vending machine, as the selection buttons would need to be changed to reflect a substitute product brand.

It will be appreciated that in such vending machines, it is not actually possible for users to see the products that are on offer until purchase. This may make a user uncertain about the quality and quantity of a product, even if the quality is assured and the quantity is listed. Specifically, unlike a shop, the user cannot pick up and examine the product in detail before purchase.

To address this issue, some vending machines have transparent fascias that allow a user to see the products that are in stock. Generally, multiple products of the same type are arranged in rows, with the price of the product listed adjacent the row, along with a reference associated with the row. Once a product has been decided upon, and correctly paid for, users need to select the correct item through the use of an alphanumerical keypad. The keypad is used to key in the reference associated with the product row. Choosing products in this way can be time consuming and the user may accidentally select the wrong product if the reference is not keyed-in correctly. Unfortunately, these vending machines are prone to damage or vandalism. In particular, as the fascia is transparent—and so made of glass or plastic—it can be relatively easy for criminals to attempt to break into the vending machine to gain access to the products within it. Criminals may be particularly tempted when the machine is visibly well stocked.

Another problem with such systems in general is that they are not set up to be able to efficiently dispense more than a single product at time. If multiple products are required, each product generally needs to be paid for, selected and dispensed individually. This can be frustrating for users wanting to purchase multiple products quickly.

Part of the reason for this stems from a poor user interface. Users may need to check whether a particular product is in stock, then feed the vending machine with coins totalling the exact price of the product, and then select the product to be dispensed. This process needs to be repeated for each product and requires a user to have the correct coin denominations. Another reason for this is that the mechanisms within the vending machines are generally only able to dispense only single items at a time.

A further consideration is that associated with energy efficiency. Firstly, a lot of energy can be consumed dispensing products. For example, a substantial amount of energy may be consumed by a vending machine attempting to drive a row of products horizontally against the frictional forces presented by the floor of the row. Additionally, the necessarily limited product range of such vending machines cannot benefit from the economies of scale, and so heating and/or cooling of products within the vending machine is energy inefficient.

It is against this background that the present invention has been devised.

### SUMMARY OF THE INVENTION

According to a first aspect of the present invention there is provided a product provisioning system arranged, in use, to deliver to a user substantially simultaneously a plurality of heterogeneous discrete products. The product provisioning system may comprise a plurality of independently-controllable product dispensing mechanisms each configured to dispense different predetermined types of said discrete products from one another. The product provisioning system may comprise a product collector arranged to collect together products dispensed by the plurality of product dispensing mechanisms. The product provisioning system may comprise a control system. The control system may be in communication with the product dispensing mechanisms. The control system may be arranged to receive a user-specified product order for multiple heterogeneous products and, in response, control a set of the plurality of product dispensing mechanisms in parallel to dispense specified products of that product order.

Advantageously, as the product provisioning system can simultaneously dispense multiple products in parallel, this maximises the speed with which multiple products can be delivered to a product-ordering user.

Preferably, at least one of said product dispensing mechanisms comprises a substantially vertically-oriented channel through which said discrete products travel during product dispensing. Ideally, products travel through the channel under action of gravity. Preferably, said product dispensing mechanism is configured to control the passage of products through the channel.

Preferably, at least one product dispensing mechanism comprises a restriction means for controlling the effective cross-sectional area of the channel, and thereby controlling the passage of products through the channel.

Preferably, the product provisioning system further comprises a plurality of product channels, each corresponding to a respective product dispensing mechanism. Each product channel may comprises a channel inlet arranged to receive products. Said channel inlets may be located adjacent to one another. Said product channels may be aligned with one another. Advantageously, this can facilitate restocking of products into each channel inlet, and maximises the utilisation of space.

Preferably, the product collector comprises a cushioned surface onto which said dispensed products are dropped. Ideally, the products are dropped from the product dispensing mechanisms.

Said cushioned surface may be inclined and may comprise a friction-reducing means for facilitating collection together of products dispensed thereon under action of gravity.

The product provisioning system may comprise a product ordering interface configured to display a list of orderable products to a user. The product ordering interface may be arranged to receive a user interaction to select multiple products of that list. The product ordering interface may be arranged to receive a user-driven command to transmit said selected multiple products as the user-specified product order to the control system.

The product ordering interface may be configured to display the multiple selected products together with their total price to the user, prior to receiving the user-driven command to transmit the product order to the control system.

The product provisioning system may further comprise an authentication device arranged to determine that a product-ordering user is authorised to receive products of the user-specified product order, and in response control user-access to said products. Said authentication device may comprise a payment card reader.

The product provisioning system may comprise a product router for routing products of a product order to one of a plurality of delivery locations, each associated with an individual product-ordering user.

Preferably, the product provisioning system is arranged to receive an authorisation to dispense a plurality of discrete products and in response control the dispensing mechanisms.

It will be appreciated that the product provisioning system may be used in contexts broader than simply vending discrete products. In particular, the product provisioning system may be arranged to dispense products in response to receiving an authorisation to do so that is not necessarily associated with receiving payment for the products to be dispensed. For example, the authorisation to dispense products may be associated with the identification of a user entitled to receive products. The product provisioning system may comprise an authentication device for authenticating the identity of a user and/or authenticating the products for dispensing. The authentication device may comprise a user database. The user database may list the products that users may be entitled to receive.

As mentioned above, the product provisioning system may be applicable to situations broader than simply vending of products in exchange for payment. For example, the product provisioning system may be used in a scenario where products contain medicines, and the users are entitled to those medicines without necessarily paying for them. In such a situation, it will be appreciated that it is important for users to be correctly identified by the product provisioning system, so that the correct products can be dispensed. If medicines are incorrectly dispensed, then this could have disastrous implications for the recipients of that medicine. Even if the recipient of a medicine realises that the incorrect medicine has been dispensed, then this still presents a problem of depleting the stock of medicines that can otherwise go towards helping others. In such a scenario, it is envisaged that users requiring medicines would pre-register themselves with the system—for example, via a doctor or clinic. At this stage, the doctor or clinician—or other authority—could specify a number of different parameters to the product provisioning system. For example, the identity of the user could be associated with the type of medicine required for that user and/or dependent users. The language that the user understands may be recorded by the system. Furthermore, data relating to repeat prescriptions can be entered into the system. Also at this pre-registration stage, data associated with uniquely identifying a user can be received. For example, the user's eyes can be scanned with an iris scanner or the user's fingerprints can be scanned. Alternatively, the user may be assigned with a unique identifier and be provided with a way of communicating that identifier with the product provisioning system. For example, if the identifier is a number, the user may be given a printout of that number and be informed that the number can be keyed into the system. Alternatively, the user may be given a barcode, or other unique machine-readable code.

As such, once a user has been registered with the system, the user does not necessarily need to consult the doctor for prescriptions. The user simply needs to approach the product provisioning system, provide the system with information relating to user's identity—and received the dispensed products.

The product provisioning system may comprise a user interface that guides the user into providing the requisite data needed for authentication and/or product ordering. For example, if the authentication device comprises an iris scanner, the user-interface may guide the user to face the iris scanner in the correct manner. Alternatively, the user-interface may prompt the user to receive a fingerprint scan, or to provide other information, for example, to type in a code uniquely identifying the user. Of course, the information may be presented in the predetermined language that the user understands. Alternatively, instructions or information may be provided in a set of different languages.

Once identified by the authentication device, the system may then consult a set of rules to determine which products to dispense to the identified user—if any. For example, if the user is attempting to access repeat prescriptions of a medicine too early, then such medicines may not be dispensed. Instead, the user-interface may provide the user with a message to signify that the user has attempted to access the medicines too early, and may also provide information about when the user should next return to access medicines.

If users attempt to access the product provisioning system without pre-registering and/or if the product provisioning system does not have information relating to an identified user, the user can be instructed to pre-register, or take another appropriate action.

Preferably, the product provisioning system comprises a storage region in which products are stored prior to dispensing. The product provisioning system and/or storage region may comprise a plurality of product channels. Each product channel may feed a product dispensing mechanism. Each product channel may comprise a channel inlet arranged to receive products into the product channel. Channel inlets may be located adjacent to one another. Advantageously, locating channel inlets adjacent to one another facilitates restocking of products into each channel inlet, and can also maximise the utilisation of space.

Preferably, the product channels are aligned with one another. Advantageously, products can be loaded into the channels by transferring (e.g. driving) the products into the inlets along a common direction. This can facilitate automated loading of multiple products into the product channels.

It will be appreciated that the storage region may be physically large in size, and so can be very heavy, especially when laden with a variety of different products. As such, the storage region may be part of a fixed installation to which products will need to be transported for the purposes of refilling the storage region.

Preferably, the product provisioning system comprises a product refill module. Preferably, the product refill module comprises a product buffer from which products can be transferred into the storage region. The product buffer may be divided into a plurality of buffer sections, a separate section intended for each product type. The product refill module may be arranged to align with the storage region to refill products within the product channels. Each buffer section may comprise a plurality of outlets that correspond to channel inlets of the storage region. As such, when the product refill module is aligned with the storage region, the outlets of the product refill module can align with the channel inlets, and products can be transferred from the product buffer into respective product channels within the storage region.

It will be appreciated that each of the product channels ideally is dedicated to a single type or brand of product; with different product channels holding heterogeneous discrete products. As such, it is desirable for the product buffer to have products arranged within its sections so as to restock the product channels with the correct product lines.

Preferably, each buffer section is independently operable to allow products to be transferred into the storage region. Advantageously, this allows product channels to be restocked independently. It will be appreciated that one consideration for product restocking is that certain product lines may be more popular than others. As such, some product channels may be more depleted of products than others. Advantageously, the product refill module can provide a convenient way in which depleted product lines can be restocked to the same level as less popular items.

The buffer sections may be operable to transfer products into the storage region by allowing the products to fall, under the action of gravity, into the appropriate product channel. Accordingly, the buffer sections may comprise a release mechanism to control the dispensing of products. Advantageously, this can prevent the products being dispensed prematurely—for example, before the product refill module and the storage region have been aligned.

Alternatively, the product refill module may be provided with one or more drive means to drive the products from the buffer sections into the appropriate product channels. This can be particularly useful to drive products into the storage region against the action of gravity—for example, when transferring the product up into the storage region.

Preferably, the product refill module is separably engageable with the storage region. Advantageously, this allows the product refill module to be a modular component of the product provisioning system. In particular, this can allow a depleted product refill module to be substituted with a fully stocked product refill module. For example, multiple product refill modules may be transported to the product provisioning system and substituted to quickly replenish multiple product lines.

A loading system may be provided to unload depleted product refill modules, and replace the depleted product refill modules with fully-stocked product refill modules.

The loading system may comprise a transfer mechanism for loading and/or unloading product refill modules from the product provisioning system. The transfer mechanism may comprise a crane arm. The transfer mechanism may comprise sliding structures to allow depleted product refill modules to be slidingly transferred from the product provisioning system. The sliding structures may comprise rails and/or ramps. The rails and/or ramps may comprise rolling members, such as wheels, to facilitate sliding movement between the product refill modules and the storage region.

The loading system may be provided on a transport vehicle. In such a case, it is envisaged that the loading system would unload depleted product refill modules from the provisioning system onto a carriage of the transport vehicle. Furthermore, the carriage of the transport vehicle could support fully-stocked product refill modules which could be unloaded and transferred to the product provisioning system.

It will be appreciated that once a product refill module has been depleted, it does not necessarily need to be replaced with another completely fully-stocked product refill module. So long as a replacement product refill module contains sufficient products to restock—in whole or in part—at least one of the product channels, then a product restocking operation may be considered to be acceptable.

Furthermore, a product refill module does not necessarily need to be replaced at all. Rather, the products within it can be restocked—for example, manually by restocking staff. In such a situation, it will be appreciated that it can be advantageous to provide a product refill module that is easily accessible to restocking staff.

For purposes of security the storage region may be located at a position that is relatively inaccessible. For example, the storage region may be at a raised position above the normal reach of users. Advantageously, this can reduce the chance of product theft—and also has a synergistic effect with regard to the operation of the product provisioning system. In particular, by raising the height of the storage region, gravity can play a useful role in the dispensing of products. Furthermore, if the storage region is raised above head-height, for example, then this can lead to a better utilisation of space. I.e. it makes it possible to utilise the space underneath the storage region for accommodating users and vehicles. Generally, the term ‘above head-height’ will be understood to mean safely above the height of at least 98% of users. This height would typically be at a minimum of 1.9 to 2 metres above the ground.

As mentioned, in the case where the storage region is located above head height (along with the product refill module), it is useful to allow restocking staff to easily access the product refill module to facilitate restocking. As such the product provisioning system may be provided with access means to allow the restocking staff to access the product refill module. For example, the access means may be a ladder to allow staff to access the top of the and to load products directly to the product refill module and/or the storage region.

Alternatively, the access means may be arranged to reconfigure the product provisioning system so that the product refill module and/or the storage region is accessible at ground level. For example, the product provisioning system may comprise guides for guiding the product refill module between a first position in which the product refill module is engaged with the storage region, and a second position in which the product refill module is separated from the storage region. The second position would typically be at a lowered position at which the product refill module becomes easily accessible to restocking staff. Preferably, the guides substantially support the weight of the product refill module, as well as any products contained within the product refill module. The product refill module may be counterweighted to facilitate manual handling of the product refill module and reduce the chance of injury.

The product provisioning system may be provided with indicia to guide correct manual restocking of the product provisioning system. Typically, the indicia can indicate where specific products are to be inserted into the storage region and/or the product refill module. In particular, a product channel should generally only be stocked with a product of a particular type. As such, it is important to be able to indicate where that product of a specific type is to be loaded to obviate the automatic dispensing of incorrect products. Thus, the indicia provide restocking staff with useful feedback as to which products are to be restocked, and where they go. The indicia may be a picture of the product. Advantageously, this can improve the speed of restocking, as there can be very little confusion as to where a product is to be loaded.

Preferably, the storage region is in communication with, or is integrated with a product picking system. The product picking system may comprise a plurality of product dispensing mechanisms. Preferably, each product channel within the storage region is associated with a product dispensing mechanism. Thus, each product dispensing mechanism is arranged to dispense a different product type.

Preferably, the product provisioning system comprises a product collector for collecting together a plurality of products. The product collector may be arranged to collect together a plurality of products under action of gravity. The product collector may comprise a cushioning device to cushion the fall of products dispensed onto the product collector. The cushioning device may comprise friction-reducing means for facilitating collection under the action of gravity. The friction-reducing means may comprise rollers and/or a net. The net may comprise cords about which the rollers are arranged to pivot.

Ideally, the product collector is arranged to collect together a plurality of products for delivery to a delivery station or delivery location. The delivery station may comprise a product dispenser. The product collector may channel the collected products to the product dispenser via a routing means. The routing means may be a chute. The routing means may be a vertical conveyor. Preferably, the routing means is arranged to control the movement of the collected products to the product dispenser. Ideally the product collector and/or the routing means is arranged to operate under the action of gravity. Ideally, the movement of products through the product collector and/or routing means is driven by gravity acting on said products. Advantageously, the controlling of movement can minimise product damage and also can ensure that the collected products are correctly routed to the product dispenser. In particular, this avoids products becoming stuck or moving too quickly.

Preferably, the product provisioning system comprises a product dispenser to which dispensed products are delivered. Preferably, the product provisioning system and/or the product dispenser comprises an authentication device to obtain authorisation for the dispensing of goods. Preferably, the authentication device comprises a payment card reader—such as a credit card reader—to receive payment for goods to be dispensed.

Preferably, the product provisioning system comprises a product-ordering interface arranged to communicate to the product dispensing mechanisms the products to be dispensed. Preferably, the product-ordering interface comprises a touch-screen tablet device. The product-ordering interface may comprise the authentication device.

Preferably, the product dispenser may be arranged to dispense goods other than discrete goods. For example, the product dispenser may be arranged to dispense liquids—including fuel, and beverages such as tea or coffee. Said dispensing may comprise metering the goods.

Preferably, the product dispenser comprises a window through which dispensed items are visible. Preferably, the window can be opened under the control of the product dispenser in response to receiving an authorisation, for example as received when the ordered products have been paid for.

Advantageously, this allows the products that have been ordered to be viewed by users before deciding whether or not to pay for those products. It will be further understood that by limiting the products on display to those as ordered (but not yet paid for) reduces the motivation for criminally damaging the product provisioning system to gain access to the products. In other words, unlike prior art vending machines that display all of the stocked products, only a limited number of items are displayed.

Furthermore, the product provisioning system may be arranged to limit the quantity of items that can be ordered. This can minimise the motivation for theft, and may also be required in view of the capacity of the product dispenser to hold a certain quantity of items.

Preferably, the product dispenser comprises a rejection bin. The product dispenser may be arranged to route products to the rejection bin on receipt of a rejection command. For example, if a user has ordered certain products, viewed them through the window, and decided that they are not suitable for purchase, the user thus can send the rejection command instead of paying for the products. The rejection command can be issued via the product-ordering interface.

Preferably, the product dispenser comprises a receptacle dispenser—for example, a plastic bag dispenser. Thus if a user has ordered and paid for a number of products, the user can advantageously gather those products together within a receptacle thereby aiding with the handling and portability of those products.

Preferably, the product provisioning system is arranged for use within a vehicle service station.

Advantageously, the inventors of the present invention have realised that providing a product provisioning system within a service station allows certain advantages to be realised in an environment where such systems are not usually encountered. By providing a product provisioning system within a vehicle service station allows the problems associated with inefficient use of time and space to be overcome. In particular, products can be dispensed at the location of a user's vehicle, minimising the time needed for a user to travel between the vehicle and a shopping area, or even the need for a shopping area at all. This increases the comfort of users—who may not even need to leave their vehicles as products can be delivered directly to an open vehicle window. This is particularly advantageous for disabled users who may not be able to easily leave their vehicles. Furthermore, delivery of products directly to the vehicle also increases safety, as users do not need to traverse a potentially dangerous vehicle forecourt.

It will be understood that the term ‘service station’ refers mainly to passenger vehicle petrol filling stations or forecourts. However, the present invention can also extend to other types of service stations.

As mentioned previously, the delivery station may comprise the product dispenser. The delivery station may also comprise other features relevant to the context of a vehicle service station. In particular, the delivery station may comprise a bay in which vehicles can be stationed during product dispensing. The bay may be marked to indicate where a vehicle should be positioned. Advantageously, the product dispenser is positioned relative to the bay to facilitate access to the product dispenser from the interior of the vehicle. In particular, when the vehicle is stationed within the bay, as indicated by the markings of the bay, the product dispenser is positioned to be accessible via an open driver's window of a typical road vehicle.

The delivery station may comprise one or more vehicle fluid dispensers. For example, the delivery station may comprise one or more fuel pumps for refuelling a vehicle, an air hose for inflating tyres of the vehicle, a windscreen-wiper fluid dispenser, a water dispenser and/or an antifreeze fluid dispenser. Advantageously, by providing multiple dispensers within the vicinity of a common delivery station allows multiple services to be conveniently provided to the vehicle and users. Of particular advantage is being able to service the vehicle—for example, refuelling it, at the same time as dispensing products to it, without requiring users to leave the vicinity of the vehicle, or even the vehicle at all. Naturally, if users are not to leave the vehicle at all, and require the vehicle to be refuelled, then a fuel pump attendant may be necessary. Alternatively, an automated refuelling system may be provided.

Optionally, the vehicle service station comprises a plurality of storeys, at least a first storey accommodating the product provisioning system for the delivery of products to one or more product delivery stations situated on another storey.

Advantageously, by situating product storage and delivery systems at storeys separate to the delivery stations, the space efficiency of the service station can be maximised. For example, non-fuel products such as packaged food can be stored on a level of the service station separate to those levels accommodating user vehicles. In particular, the delivery systems can be positioned on one or more levels above the vehicles and can be arranged to selectively drop the products to appropriate delivery stations in response to an order from a user of that vehicle. By comparison with a traditional shopping area of a petrol station, the goods do not need to be set out for display and user picking but rather can be stored in a more space efficient arrangement within the product storage and delivery system. Furthermore, the security of service station can be maximised. As users cannot necessarily gain access to the products prior to ordering and payment of those goods, this reduces the chance of product theft.

According to a further inventive aspect there may be provided a product ordering system arranged to receive product orders from users for use in determining products to be delivered to at least one delivery station. The product ordering system may comprise the product ordering interface.

The product ordering system may be suitable for use with a vehicle service station. The product ordering system may be arranged to receive product orders from vehicle service station users for use in determining the products to be delivered at the at least one delivery station. It will be understood that the product ordering system will typically be associated with a product provisioning system that can subsequently deliver the ordered products.

Optionally, the product ordering system comprises a product menu arranged to receive an input from a user to signify which products the user would like to order. Optionally, the product menu comprises an electronic menu system such as a touch-screen computing device, the electronic menu system displaying a listing of orderable products, the electronic menu system being arranged to receive a user selection of products.

Optionally, the product menu may be tethered to an appropriate delivery station to prevent removal of the product menu from the delivery station. Advantageously, the tether may comprise a power and/or data cable. A further inventive aspect may be an electronic menu system such as a touch-screen computing device, the electronic menu system displaying a listing of orderable products, the electronic menu system being arranged to receive a user selection of products. Optionally, the electronic menu system comprises an integrated payment card reader for receiving payment for ordered goods. Advantageously, this can provide authorisation to release ordered products to a user.

Optionally, the electronic menu system is arranged to wirelessly communicate a product order. Optionally, the electronic menu system is arranged to present a series of pages to a user in a sequence to receive user selections relating to products having a longer delivery time before receiving user selections relating to products having a relatively shorter delivery time.

Optionally, the product ordering system comprises a progress indicator providing dynamic feedback regarding the progress of the delivery of one or more ordered products. Optionally, the progress indicator provides dynamic feedback regarding the expected time at which ordered products will be delivered. It will be understood that the progress indicator may be provided via the electronic menu system and/or may be provided by another means—for example a display mounted adjacent the delivery station.

It will be understood that the product ordering system may comprise a plurality of order receiving devices—for example, the electronic product menus. The plurality of order receiving devices may be arranged to allow product orders to be compiled in parallel. After each product order is complied, it may be confirmed as being completed. Advantageously, the product ordering system may be arranged to sequence product order fulfillment in order of completion. Advantageously, this reduces the amount of time taken for a group of product orders to be compiled, confirmed and then completed.

The product provisioning system may be arranged to receive product orders from the product ordering system and schedule the delivery of the ordered products to a delivery target.

Optionally, the product provisioning system is arranged to direct a delivery target to a product delivery system located at a delivery station.

Optionally, the product delivery system comprises a product delivery channel arranged to dispense discrete goods to a vehicle located at the delivery station.

Advantageously, by delivering discrete goods to the delivery station means this minimises the amount of carrying involved in getting the goods into the vehicle. If there are a large number of items, or the items are bulky, the user does not need to travel back and forth between the vehicle and a shopping area.

There may be a plurality of product delivery channels located at each delivery station. Advantageously, this allows convenient delivery of different types, sizes, shapes and/or weights of products.

Optionally, the product provisioning system comprises a detector arranged to detect an appropriate product delivery position relative to the vehicle and/or a user within the vehicle.

It will be understood that an appropriate position may be an open window of the vehicle. However, there may be other appropriate positions, such as a boot/trunk opening.

Optionally, the detector is arranged to determine the appropriate product delivery position by analysing images of the vehicle.

Optionally, the detector is arranged to determine the appropriate product delivery position by detecting the registration number of the vehicle, and using the detected registration number to query a servicing requirements database.

For example, the servicing requirements database may comprise data relating to the height of a vehicle window from the floor.

Optionally, the product provisioning system comprises at least one adjustment mechanism for adjusting the relative position of the vehicle and the product delivery channel so as to deliver products to the detected appropriate product delivery position.

A further inventive aspect may constitute an adjustment mechanism for adjusting the relative position of a vehicle and a product delivery channel so as to deliver products via the product delivery channel to an appropriate product delivery position.

Optionally, the at least one adjustment mechanism comprises a vehicle support plate for supporting and moving a parked vehicle thereon relative to the product delivery system.

Optionally, the product delivery channel comprises the at least one adjustment mechanism.

Optionally, the product delivery channel comprises an adjustable arm, operable for extension towards an open window of a vehicle, ordered products being deliverable via said adjustable arm.

Advantageously, this allows a user of the vehicle to receive ordered goods without needing to leave the vehicle. In particular, the extendible arm is arranged to deliver goods to within reaching distance of a user sitting aside the open window of the vehicle.

Optionally, the adjustable arm may be used to deliver a receptacle containing ordered products to the open window. Preferably, the receptacle is arranged to allow a user to remove products therefrom, the receptacle being retrieved after user product collection. For example, where the receptacle is a smart-box, the extendible arm may provide a smart-box return system.

Optionally, the product delivery channel is gravity-fed ordered goods.

Optionally, the product provisioning system comprises a plurality of delivery targets each relating to a separate product delivery order. It will be appreciated that each delivery target will generally relate to an order originating from a specific user. A user may order multiple products as part of the same order, and these products will generally be assigned to one of the delivery targets.

Optionally, the product provisioning system comprises a routing mechanism arranged to route delivery targets to an appropriate product delivery channel at an appropriate time. The product delivery system may comprise the routing mechanism. The product router may comprise the routing mechanism. The routing mechanism may comprise one or more conveyor belts.

Optionally, the routing mechanism determines the appropriate product delivery channel at the appropriate time in response to a routing input associated with a tracked position of a product-ordering user, or vehicle associated with that user.

A further inventive aspect may be a routing mechanism arranged to route delivery targets in response to a routing input associated with a tracked position of a product-ordering user, or vehicle associated with that user. Optionally, the tracking input is derived from a tracking system arranged to track the position of a product-ordering user, or vehicle associated with that user. Optionally, the tracking system is arranged to track the position of the or each delivery target. Optionally, the or each delivery target comprises a receptacle into which one or more products from a common product delivery order are received. Alternatively, the delivery target may relate to an allocated position of one or more products relating to an order that is controlled by the product provisioning system. For example, the delivery target could be an allocated position of products on a series of conveyor belts. Optionally, where the delivery target is a receptacle, the receptacle may comprise a smart box.

A further inventive aspect may comprise a receptacle for use with a product provisioning system. Optionally, the receptacle comprises a support frame and a carrier insert positioned about the support frame, the insert being removable from the support frame so as to separate received products away from the support frame. Optionally, the insert may comprise a flexible material, such as a plastics material. The insert may be a carrier bag. Optionally, the receptacle comprises a release mechanism for releasing the insert. The release mechanism may comprise a hinged flap. Optionally, the receptacle comprises a unique identifier to allow tracking of the receptacle. Optionally, the identifier of the receptacle is a visual identifier such as a barcode. Optionally, the receptacle comprises a product sensor arranged to detect the presence of products contained within the receptacle. Optionally, the product sensor is arranged to detect the quantity of products contained within the receptacle. Optionally, the product sensor comprises a weight sensor for detecting the weight of products within the receptacle. Optionally, the receptacle comprises a transceiver for transmitting data relating to the receptacle. Optionally, the transceiver is arranged to transmit data relating to the quantity of products contained in the receptacle. Advantageously, such data can be received by the product provisioning system and used to control delivery of items to the receptacle. For example, if the receptacle is full, the provisioning system can prevent further products being deposited within the receptacle. Optionally, the transceiver is arranged to transmit data relating to the location of the receptacle. Optionally, the transceiver comprises a positioning module, such as a GPS module.

Optionally, the product provisioning system may comprise a product picking system. The product picking system may comprise the plurality of product dispensing mechanisms. Optionally, the product provisioning system comprises a product collector for collecting together a plurality of products ordered as part of a product order for delivery to the or each delivery target. Optionally, the product collector is arranged to collect together a plurality of products under action of gravity. For example, the product collector may comprise a collating funnel or series of slides that allow multiple products to be collected together under the action of gravity. Advantageously, mechanisms such as slides make use of gravity to propel products to an appropriate location, reducing the complexity and energy utilisation of active devices such as conveyor belts.

Optionally, the product collector comprises a cushioning device to cushion the fall of products dispensed onto the product collector.

A further inventive aspect may be a product collector comprising a cushioning device to cushion the fall of products dispensed onto the product collector. Optionally, the cushioning device comprises friction-reducing means for facilitating collection under the action of gravity. Optionally, the friction-reducing means comprises rollers. Optionally, the cushioning device comprises a net. Optionally, the net comprises cords about which the rollers are arranged to pivot. Optionally, the product collector is arranged to receive a plurality of products for collecting together from a plurality of product dispensing mechanisms. Optionally, the product provisioning system comprises a plurality of product dispensing mechanisms, each being arranged to dispense a different product type. Generally, each product dispensing mechanism is arranged to dispense a product of a uniform type. This simplifies the operation of each product dispensing mechanism. Furthermore, each product dispensing mechanism generally contains a stack of products. Generally a dispensing mechanism comprises a vertically oriented channel of regular cross-section.

Advantageously, as the products are held in a stack, according to a FIFO (first in, first out) goods that have an expiry date closer in the future are the ones that are dispensed first. In contrast, if users are given a choice as to the products to select from a shelf, they often select the goods that they perceive to be the freshest (i.e. those with a longer shelf life). Additionally, as the product provisioning system may have a means by which to track the expiry date of products, the product provisioning system may be arranged to control all dispensing mechanisms to quickly and simply purge all products that have an expiry date at the end of the day.

Optionally, each product dispensing mechanism is arranged to control the dispensing of a quantity of products in response to and as defined by a dispensing command.

For example, a dispensing command may be issued to dispense exactly one product. Generally, the products are discrete products, each being of a predetermined size and shape, and so each constitute a single product unit. Thus, dispensing of a quantity in this context relates to the number of product units rather than a quantity in terms of weight or volume. Advantageously, by dealing with discrete, usually packaged goods (rather than loose or liquid goods), the operation of the product dispensing mechanisms can be simplified.

Optionally, each product dispensing mechanism comprises a product buffer, such as a stack, and a dispensing outlet, the products being held in the product buffer prior to being dispensed at the dispensing outlet.

Optionally, the dispensing outlet is gravity-fed products from the product buffer.

Optionally, the product dispensing mechanism is arranged to control movement of products within the product buffer so as to facilitate dispensing of an accurate quantity of products.

It will be understood that where products are stored on top of one another within the product buffer, the combined weight of a number of stacked products could interfere with an outlet of the product dispensing mechanism—potentially dispensing a greater number of products than intended in error. Furthermore, if further products are introduced into the product buffer, and drop freely within the buffer, this may also interfere with the outlet, and may even cause damage to the products or product dispensing mechanism. Therefore, it is advantageous, to control movement through the product buffer, especially if the product buffer is vertically oriented.

Preferably, the product dispensing mechanism comprises a sequential dropping mechanism for lowering products within the product dispensing mechanism gradually.

A further inventive aspect may be a product dispensing mechanism comprising a sequential dropping mechanism.

Optionally, at least one of the plurality of product dispensing mechanisms is a fluidly actuated product dispensing mechanism. It will be understood that the term ‘fluid’ herein may refer to liquid and/or gas. Optionally, the fluidly actuated product dispensing mechanism comprises a plurality of bladders or balloons controllably inflatable to control dispensing and/or movement of products through it. A further inventive aspect may be a fluidly actuated product dispensing mechanism comprising a plurality of bladders controllably inflatable to control dispensing and/or movement of products through it. Generally, when a bladder is inflated, it presses against a product, holding it in place and/or blocks passage of a product beyond the inflated bladder. Generally when a bladder is deflated, a product is free to move beyond the bladder. The bladders (or balloons) may be fluidly coupled to electronically controlled valves for inflation and/or deflation. Advantageously, inflatable bladders allow the fluidly actuated product dispensing mechanism to be compatible with a large variety of products. In particular, an inflatable bladder can conform to products of different sizes and shapes. Furthermore, the inflatable bladders can easily handle products of different temperatures. For example, a product dispensing mechanism of the provisioning system may be used to store and dispense products that have to be kept at cold temperatures (e.g. ice-cream). Whilst certain mechanisms may seize as a result of ice build-up, the bladders are particularly suited to operating in such environments. This is because the moving parts are the bladders, which resist the build-up of ice.

Optionally, the fluidly actuated product dispensing mechanism comprises a product buffer in the form of a product chute, each inflatable bladder being inflatable to occupy a volume within the product chute.

Optionally, the plurality of inflatable bladders are disposed along the product chute in an array and are arranged so that progressive deflation of adjacent bladders in the array progressively lowers a product within the chute.

Optionally, the plurality of inflatable bladders are arranged in pairs so that a product item can be gripped between an inflated pair.

Advantageously, this gripping action allows products to be closely stacked on top of one another in the product chute without burdening the product dispensing mechanism with a stacked weight at its lower end. This is because each pair of inflatable bladders bears the majority of the weight of a respective gripped product. As well as increasing the reliability of product dispensing, this arrangement is very space efficient.

Optionally, at least one of the product dispensing mechanisms comprises a hot food dispenser. Optionally, the hot food dispenser comprises a hot food processing conveyor belt arranged to pass chilled food via a heating system for heating food. Optionally, the hot food dispenser comprises a packaging device for packaging heated food. Optionally, each product dispensing mechanisms comprises a product-receiving region for receiving products to be loaded into the product dispensing mechanism.

Optionally, product receiving regions of the plurality of product dispensing mechanisms are disposed adjacent one another.

Optionally, the product provisioning system comprises a filling system for refilling product-dispensing mechanisms. A further inventive aspect may be a filling system for refilling product-dispensing mechanisms. Optionally, the filling system comprises a placement mechanism for placing products into an appropriate product dispensing mechanism. Optionally, the placement mechanism is arranged to place sets of homogenous products into an appropriate product dispensing mechanism. Optionally, the sets of homogenous products are contained within a loading cassette.

Optionally, the filling system transmits product-handling instructions to control the placement mechanism. Optionally, the filling system comprises a scanner for electronically identifying a product, or set of products. It will be understood that the scanner may be arranged to scan a computer-readable image such as a barcode of a product to electronically identify that product. Optionally, the scanner comprises an illumination means. Optionally, the filling system is arranged to receive the electronic identification of a product and in response transmit product-handling instructions to the placement mechanism. Optionally, the filling system comprises a refill buffer for receiving unpacked goods. Optionally, the refill buffer comprises a refill buffer conveyor belt. Optionally, the filling system comprises a transfer mechanism for transferring products between the refill buffer and the placement mechanism.

Optionally, the transfer mechanism comprises a robotic arm. Optionally, the robotic arm comprises a grab head adapted to receive products of different sizes and shapes. Optionally, the robotic arm comprises pressure sensors for use in controlling the handling of products by the robotic arm. Optionally, the robotic arm comprises a/or the scanner. Optionally, the filling system is arranged to receive the electronic identification of a product and in response transmit product-handling instructions to the robotic arm. A further inventive aspect may be a filling system arranged to receive an electronic identification of a product and in response transmit product-handling instructions.

A further aspect of the present invention may be a product dispensing mechanism for use with the product provisioning system according to the previous aspects of the present invention.

Another aspect of the present invention may be a vehicle service station comprising a product provisioning system according to the previous aspects of the present invention.

A further aspect of the present invention may be a provided a product provisioning method for delivering to a user substantially simultaneously a plurality of heterogeneous discrete products, the method comprising receiving a user-specified product order for multiple heterogeneous products and, in response, controlling a set of a plurality of product dispensing mechanisms in parallel to dispense products of that product order.

It will be appreciated that features of different aspects of the invention may be combined where context allows. Furthermore, features of the aspects of the invention may constitute further independent inventive aspect. Furthermore methods of providing the functions of any one or combination of the features of the different aspects of the invention may be provided. Furthermore, computer controllers may be provided for controlling and/or receiving inputs from the systems relating to aspects of the present invention, and/or for carrying out methods relating to aspects of the present invention.

### BRIEF DESCRIPTION OF THE DRAWINGS

In order that the invention may be more readily understood, reference will now be made, by way of example, to the accompanying drawings in which:

FIG. 1 shows a flowchart depicting a general overview of a product provisioning process and associated product provisioning system of the embodiments of the present invention;

FIG. 2 shows a perspective view of a product provisioning system according to a first embodiment of the present invention in the form of a vending machine;

FIG. 3 shows a more detailed view of the fascia of the vending machine of FIG. 2;

FIG. 4 shows a perspective schematic view of the interior of the vending machine of FIG. 2 comprising product delivery nets and support structures;

FIG. 5 shows an enlarged perspective view of an interface between a vertical spar of the support structure and the product delivery net of FIG. 4, the interface defining a spring-loaded linkage;

FIGS. 6 and 7 show enlarged perspective exploded views of the spring-loaded linkage of FIG. 5;

FIG. 8 shows a cross-sectional schematic view of ball-bearings forming part of a product cushioning surface of the product delivery net of FIG. 4;

FIG. 9 shows a perspective view of one of the ball-bearings of FIG. 8;

FIG. 10 shows a perspective front view of a product delivery box of the vending machine of FIG. 2;

FIG. 11 shows a rear perspective cut-away view of the product delivery box of FIG. 10;

FIG. 12 shows a partial perspective view of a frame and a trolley provided within the vending machine of FIG. 2;

FIG. 13 shows two trolleys of FIG. 12 loaded with product cassettes defining channels;

FIGS. 14a and 14b show partial underneath perspective view of the trolley of FIG. 13 including product ramps;

FIG. 15 shows a front sectional view of one of the product ramps of FIG. 14b;

FIG. 16 shows an overhead view of the ramps of FIG. 15;

FIG. 17 shows a partial side perspective view of products and product ramps of FIG. 14b;

FIGS. 18a and 18b shows partial perspective underneath views of the trolley of FIG. 12 provided with a product dispensing mechanism comprising a solenoid-actuated trap-door;

FIG. 19 shows an underneath view of the product, product ramps and solenoid-actuated trap-door of FIGS. 18a and 18b;

FIG. 20 shows a partial perspective view of an alternative product dispensing mechanism for use in the product provisioning system of FIG. 2, comprising a rotating trap-door;

FIG. 21 shows a partial perspective view of another product dispensing mechanism for use in the product provisioning system of FIG. 2, comprising a solenoid-controlled ratcheted rotating trap-door;

FIGS. 22 and 23 show perspective views of further product dispensing mechanisms for use in the product provisioning system of FIG. 2, comprising motor-driven lifts;

FIG. 24 shows a partial perspective view of a further product dispensing mechanism for use in the product provisioning system of FIG. 2, utilising a motor-driven spring-loaded clamp system;

FIG. 25 shows a side view of a further product dispensing mechanism for use in the product provisioning system of FIG. 2, comprising a motor-driven rack;

FIG. 26 shows a side view of a further product dispensing mechanism for use in the product provisioning system of FIG. 2, comprising solenoid-driven leaf-springs;

FIG. 27 shows a partial perspective view of a further dispensing mechanism for use in the product provisioning system of FIG. 2, comprising a motor-driven rotary clamp;

FIG. 28 shows an enlarged perspective underneath view of a trolley similar to that shown in FIG. 12 fitted with a base-plate and a further product dispensing mechanism for use in the product provisioning system of FIG. 2, comprising a motor-driven trap-door arm;

FIG. 29 shows a side view of a further product dispensing mechanism for use in the product provisioning system of FIG. 2, comprising two hinged trap-doors actuated by a common solenoid;

FIG. 30 shows a partial perspective view of a further product dispensing mechanism for use in the product provisioning system of FIG. 2, comprising a solenoid-actuated combined trap-door and leaf-spring;

FIG. 30a shows a reverse perspective view of a product dispensing mechanism alternative to that of FIG. 30 and for use in the product provisioning system of FIG. 2;

FIGS. 31a to 31g show various perspective schematic views of a further product dispensing mechanism for use in the product provisioning system of FIG. 2, comprising motor-driven product spirals;

FIGS. 31g and 31h show partial side views of a product dispensing mechanism for use in the product provisioning system of FIG. 2 similar to those detailed in relation to FIGS. 31a to 31f;

FIG. 32a shows a perspective view of another product dispensing mechanism for use in the product provisioning system of FIG. 2, comprising a product channel restrictor;

FIG. 32b shows an exploded perspective view of one of the product channel restrictors of FIG. 32a;

FIG. 33 shows a schematic view of a trolley base-plate alternative to that shown in FIG. 28, with regions of the trolley base-plate designated for supporting a variety of product dispensing mechanisms for use in the product provisioning system of FIG. 2;

FIG. 34 shows a underneath view of another trolley base-plate alternative to FIG. 33, showing an alternative arrangement of product dispensing mechanisms for use in the product provisioning system of FIG. 2 supported by the trolley base-plate;

FIGS. 35 and 36 show partial underneath perspective views of a trolley having the trolley base plate of FIG. 34 together with product dispensing mechanisms suitable for use in the product provisioning system of FIG. 2;

FIGS. 37 and 38 show partial perspective views of the trolley and the product dispensing mechanisms of FIGS. 35 and 36;

FIGS. 39 to 41 show various perspective views of each of the product dispensing mechanisms of FIGS. 35 and 36;

FIG. 42 shows a schematic perspective view of a vehicle service station in which two product provisioning systems according to a second embodiment of the present invention are installed;

FIG. 43, shows a schematic front view of one of the product provisioning systems of FIG. 42;

FIGS. 44 to 47 show various schematic perspective view of one the product dispensing mechanisms of FIG. 42;

FIG. 48 shows a perspective view of a dispenser of one of the product provisioning systems of FIG. 42;

FIGS. 49 to 52 show schematic side views of a product refill module of one of the product provisioning systems of FIG. 42;

FIGS. 53 and 54 show perspective views of the product provisioning systems of FIG. 42 in alternative configurations;

FIG. 55 shows an overhead partial view of an upper end of a product buffer section of the product provisioning systems of FIG. 42;

FIGS. 56 to 59 show perspective views of the product provisioning systems of FIG. 42 in alternative configurations illustrating examples of automated product refill;

FIG. 60 shows a schematic front view of a product provisioning systems alternative to that shown in FIG. 43;

FIGS. 61 to 63 show perspective schematic views of an alternative product provisioning system to that shown in FIG. 42, but corresponding to the second embodiment of the present invention and comprising a product chute of an alternative configuration;

FIG. 64 shows a perspective view of a similar product provisioning system to that shown in FIG. 42 but corresponding to the second embodiment of the present invention;

FIGS. 65 and 66 show an exploded perspective view of the product provisioning system of FIG. 64;

FIG. 67 shows a schematic overview of a multi-storey vehicle service station comprising a product provisioning system according to a third embodiment of the present invention;

FIG. 68 shows a schematic overhead view of part of the semi-automated refilling system of the product provisioning system of FIG. 67;

FIG. 69 shows a perspective schematic view of the automated product picking system and the automated product routing and delivery system of the product provisioning system FIG. 67;

FIG. 70 shows an enlarged sectional schematic view of a cushioning structure of the automated product picking system of FIG. 69;

FIGS. 71 and 72 show schematic sectional views of an air-pressure powered product dispensing mechanism for use in the product provisioning system of FIG. 67;

FIGS. 73 to 76 show sectional schematic views different types of vertically-orientated dispensing mechanisms for use in the product provisioning system of FIG. 67;

FIG. 77 shows a schematic sectional view of a further product dispensing mechanism in the form of a boxed product dispenser for use in the product provisioning system of FIG. 67;

FIG. 78 shows a schematic perspective view of the smart box of the automated product picking system of FIG. 69;

FIGS. 79 and 80 show schematic side views of the drop chute of the automated product routing and delivery system of FIG. 69;

FIG. 81 shows a sectional schematic view of a vertical conveyor system that conveys smart boxes of FIG. 78 to the product dispenser as shown schematically in FIG. 67; and

FIGS. 82 and 83 show schematic side views of the tilt and slide mechanism of the product dispenser of FIG. 81.

### DETAILED DESCRIPTION OF THE PREFERRED EMBODIMENTS

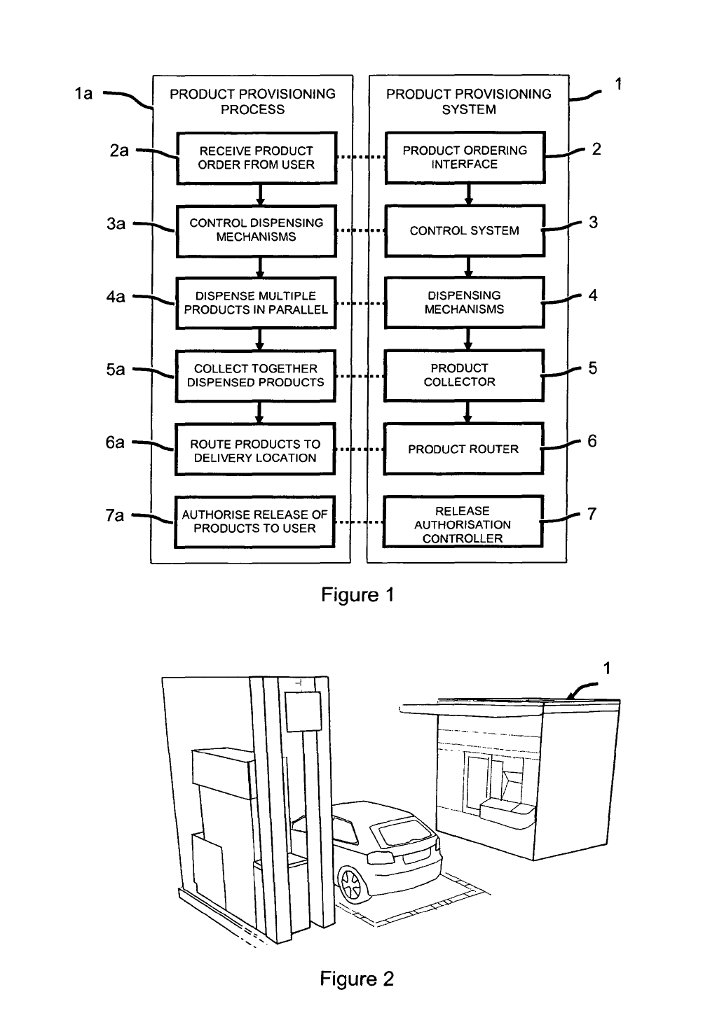

FIG. 1 shows a flowchart depicting a general overview of a product provisioning process 1a and associated product provisioning system 1 according to various embodiments of the present invention. Hereinafter, if reference is made to a product provisioning process 1a, then it will be understood that the described features or advantages are also applicable to a product provisioning system 1, and visa versa.

In general terms, the product provisioning system 1 comprises a product ordering interface 2 for receiving a product order from a user, a control system 3 for controlling a plurality of dispensing mechanisms 4 of the product provisioning system 1 such that multiple products can be dispensed simultaneously. The product provisioning system 1 further comprises a product collector 5 for collecting the simultaneously dispensed products together, and a product router 6 for routing the collected products to a delivery location. Further, the product provisioning system comprises a release authorisation controller 7 for authorising the release of products to the user.

Accordingly, the product provisioning process 1a comprises the respective steps of receiving a product order from a user 2a, controlling dispensing mechanisms 3a, dispensing multiple products in parallel 4a, collecting together simultaneously dispensed products 5a, routing those products to a delivery location 6a and authorising the release of products to a user 7a.

In more detail, in certain embodiments, the product provisioning system 1 is arranged to receive from a user an order for products stocked by the product provisioning system 1, via the product ordering interface 2. Products selection options are presented to a user, and the product provisioning system 1 is arranged to receive user input to select multiple products thereby forming a product order. The product provisioning system 1 will typically be arranged to present the product order to a user, allowing the user to quickly understand which items have been selected and also the total cost of those products at a single glance.

The product provisioning system 1 is then arranged to receive confirmation from the user that a product order is to be fulfilled, and in response control product dispensing mechanisms such that multiple products are dispensed in parallel. As various product dispensing mechanisms 4 of the product provisioning system 1 are typically spaced from one another, the products that they dispense are released at different locations about the product provisioning system 1. These simultaneously dispensed products are then collected together 5 by the product collector. When collected together, the products constituting the product order are then routed to a delivery location for pick-up by the user. Prior to pick-up, the product provisioning system 1 is arranged to receive a command authorising the release of the products to the user. Typically, this authorisation takes place in response to the user paying for the ordered products. However, it will be understood that this authorisation may take place at any stage during the product provisioning process 1a carried out by the product provisioning system 1.

This arrangement allows a user to undertake a single transaction to obtain multiple products quickly and efficiently rather than, for example, paying for each item individually, as is normally the case with vending machines.

This general arrangement of the product provisioning system 1 and process 1a is applicable to several different embodiments of the present invention as will be described, ranging from a relatively small, self-contained vending machine to a large-scale product ordering and delivery system. The inventor's motivation for each variant stems from the need to maximise the efficiency—in terms of time, space and other resources—with which products can be ordered and then delivered to a user. The invention has been conceived, and is particularly applicable in the context of the delivery of discrete products at locations such as service station forecourts where self-service of fuel is already prevalent. However, it will be appreciated that embodiments of the present invention will be applicable in other scenarios also.

FIG. 2 shows a perspective view of a product provisioning system in the form of a relatively small-scale vending machine 1′ according to a first embodiment of the present invention located on-site at a petrol filling station, adjacent to a delivery station incorporating a vehicle bay. As shown, the front fascia of the vending machine 1′, faces towards the vehicle bay for visibility and convenient user access.

The top of the vending machine 1′ is provided with an overhang, thereby defining a shelter under which a user may take cover from the rain during use of the vending machine. It will be appreciated that the overhang also protects the controls of the vending machine 1′ from the rain. In alternative configurations, a security housing may be fitted to the front of the vending machine 1′. Such a security housing can further protect the vending machine controls, and a user from the elements. Furthermore, such a security housing can allow the user to conduct secure transactions within the comfort and protection of the security housing. The security housing may be provided with ‘one-way’ glass, security cameras and the door of the security housing may be user-lockable.

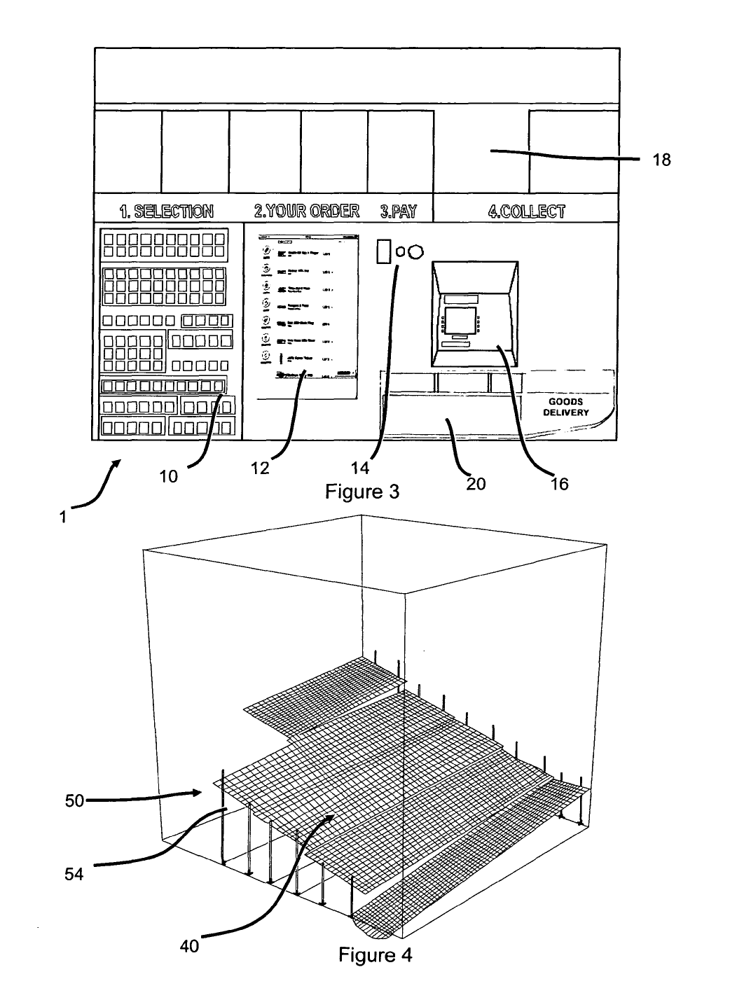

FIG. 3 shows a more detailed view of the fascia of the vending machine 1′ which comprises the product ordering interface 2. In particular, the vending machine 1′ comprises a product selection interface 10, a chosen product display 12, a payment interface 14, an ATM 16 (automated teller machine), a product delivery location 20 as well as spaces for advertising media 18. The sides, rear and even top of the vending machine can also support advertising media. The sides of the vending machine 1′ also allows access to the interior of the vending machine 1′ for restocking products. In alternative configurations, the relative positioning of the components of the various components of the vending machine 1′ may be different. For example, the ATM may be disposed to the left of the product selection interface, the chosen product display 12 and the payment interface 14.

Products that are available for a user to order from the vending machine 1′ are listed at the product selection interface 10. The product selection interface 10 presents items by categories (e.g. drinks, snacks, cigarettes). A button is associated with each listed product, and is user-operable to indicate a selection of that product. When an item is selected by a user, it is then listed in the chosen product display 12 under “Your Basket”. If a product is out of stock, then this can be indicated by the chosen product display 12.

Contrary to the operation of most vending machines, the user is able to select multiple products using the product selection interface 10, and these chosen products are presented at the chosen product display 12. Accordingly, it is possible for a user to select multiple products before paying for them each individually. Accordingly, this can increase the speed with which multiple items can be ordered and subsequently delivered.

When an item is selected and displayed at the chosen product display 12, the user is provided with further information about the selected product—for example, a product description, its weight, its volume and/or cost. As multiple products are selected, a total cost of all products is automatically calculated and presented to the user, indicating to the user the amount that the user needs to pay to purchase all of the chosen products. As well as displaying product details, the chosen product display 12 can also permit the user to deselect one or more previously selected products. In particular, the chosen product display 12 is a touch-screen display, and so the user can interact with it to deselect a product, removing it from the “Basket” of goods to be purchased.

In other alternatives, the product selection interface 10 and the chosen product display 12 may replaced with a touch-screen display screen which can perform the function of presenting and displaying the products to be ordered, as well as receiving a user input to indicate multiple product selections.

Once the user has finished selecting products, payment for those products can be received via the payment interface 14. The payment interface 14 may comprise a card reader operable as is known in the art to receive payment for the ordered goods. Alternative payment means may also be supported—for example, cash or contactless or wireless payment means. For example, RFID payment means may be provided. In addition, authentication means may be provided at the payment interface. For example, the authentication means may be a age verification means, such as a passport reader. The verification of a users age may be required by law before certain products such as cigarettes and alcohol can be sold to the user. It will be understood that payment and authentication together fall under the ambit of the release authorisation controller 7 referred to generally above in relation to FIG. 1.

When payment and, if necessary, authentication has taken place, the list of heterogeneous products in the “basket” can be dispensed for retrieval by the user at the product delivery location 20. Importantly, products can be dispensed simultaneously by virtue of independently controllable product dispensing mechanisms contained within the vending machine 1′ as will be described below.

FIG. 4 shows a perspective schematic view of the interior of the vending machine 1′ of FIG. 2, showing the position of product delivery nets 40 within the vending machine 1′. Each of the product dispensing mechanisms are configured to dispense their respective products under the action of gravity onto the product delivery nets 40. The product delivery nets 40 act to cushion the fall of the products and are sloped to direct them to the product delivery location 20 where they can be retrieved by a user. Thus, it can be seen that product delivery nets 40 act as the product collector 5 and product router 6 referred to above in relation to FIG. 1.

The product delivery nets 40 are arranged in independent sections, which facilitates their fitment and removal from the interior of the vending machine 1′. This can allow easy access to the product dispensing mechanism within the vending machine 1′ to allow for product restocking and maintenance. The product delivery nets 40 are supported in their orientation by a support structure 50. The support structure 50 comprises vertically-oriented spars 54 which link to the product delivery nets 40 and allow the orientation and height of the product delivery nets 40 to be adjusted.

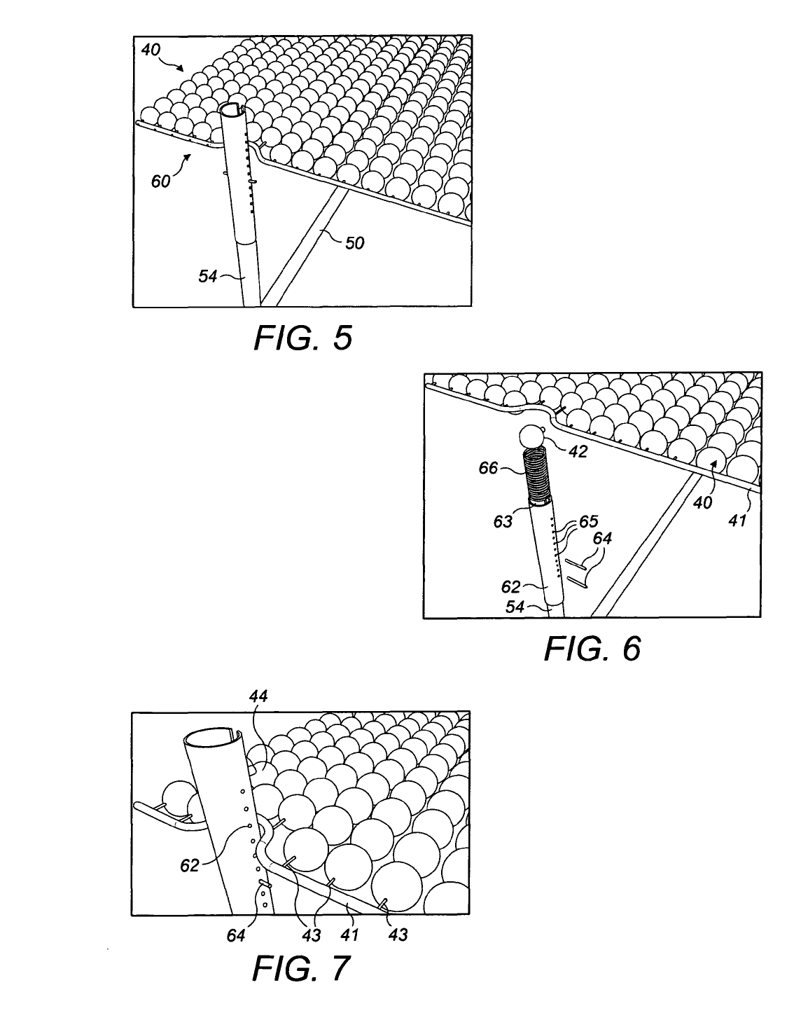

FIG. 5 shows an enlarged perspective view of an interface between a vertical spar 54 of the support structure 50 and a product delivery net 40. Horizontal spars 52 link to vertical spars 54 via joining pieces that define sleeves within which the spars are held as part of a frictional push-fit arrangement. The interface between a vertical spar 54 and the support structure is formed by a spring-loaded linkage 60. FIG. 6 shows an enlarged perspective exploded view of the spring-loaded linkage of FIG. 5, the spring-loaded linkage 60 being connected to a vertical spar 54 at its lower end, and at it upper end being connected to the product delivery net 40. The spring-loaded linkage 60 comprises a tube 62, pins 64 and a spring 66. The tube has a slit 63 running along its length and also has pairs of pin holes 65 at regular intervals along its length. The tube 62 telescopes over the vertical spar 54 and is held relative to at a chosen height by virtue of a lower pin 64 being inserted through a corresponding pair of pin holes 65. The spring 66 also fits within the tube, and is held at a chosen height within it by virtue of an upper pin 64 being inserted through a different pair of pin holes 65 below the spring 66. The product delivery net 40 comprises a rigid frame 41 connected to a ball-joint 42. The ball-joint 42 slides into and is captured within the tube 62 and is suspended by the spring 66 in the longitudinal direction.

FIG. 7 shows a further enlarged perspective view of the spring-loaded linkage of FIG. 6 assembled in this way. Each product delivery net 40 is connected to the support structure 50 by way of such spring-loaded linkages 60 located at spaced positions on the frame 41. Thus, a load introduced onto the product delivery net 40 can be cushioned by each of the ball-joint 42 bearing against and compressing respective springs 66. As mentioned, the product delivery nets 40 comprise a rigid frame 41. The frame 41 bounds and supports a set of spindles 43 arranged parallel to one another within the frame 41. Each spindle 43 supports a set of ball-bearings 44 which are shown schematically in FIG. 7. In variants, the frame 41 may also supports cross-links running transverse to the spindles 43 arranged to prevent the spindles 43 from bowing.

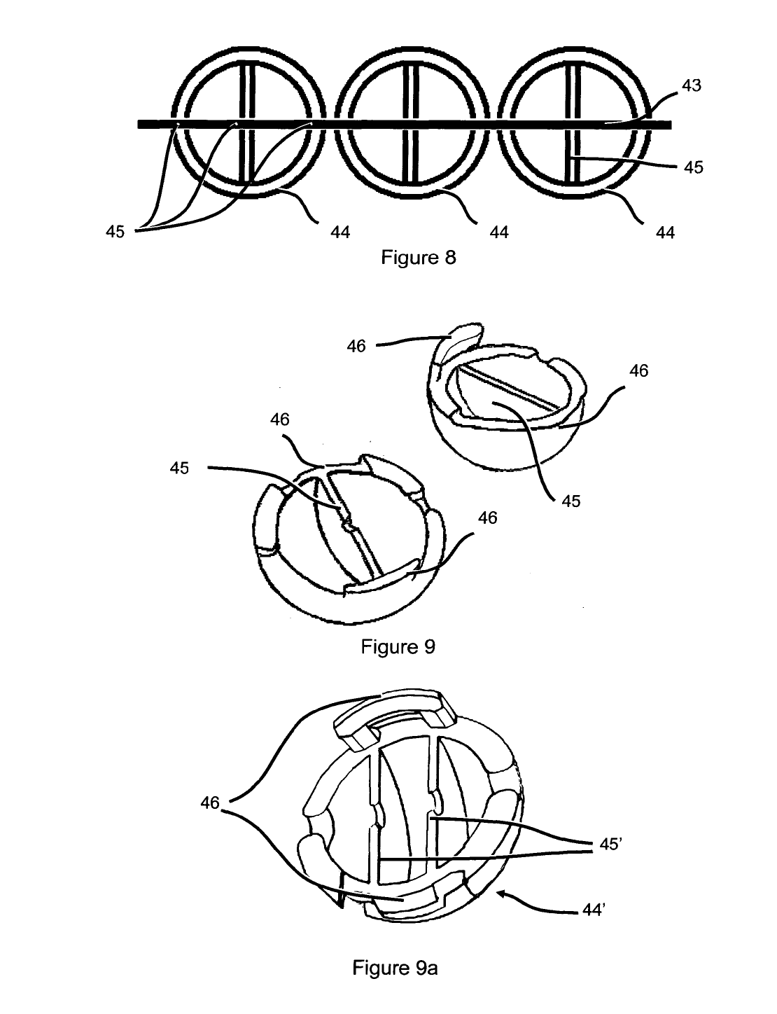

FIG. 8 shows a cross-sectional schematic view of three such ball-bearings 44 which are part of a product delivery net of FIG. 7. The ball-bearings 44 are predominantly hollow, with a central load-bearing support spine 45 splitting the hollow interior into two hemispheres. The central spine 45 and the walls of the ball-bearings define a set of three contact points with a spindle 43. Advantageously, this minimises rolling resistance of the ball-bearings 44 against the spindle 43 whilst at the same time making each ball-bearing resistance to external loads.

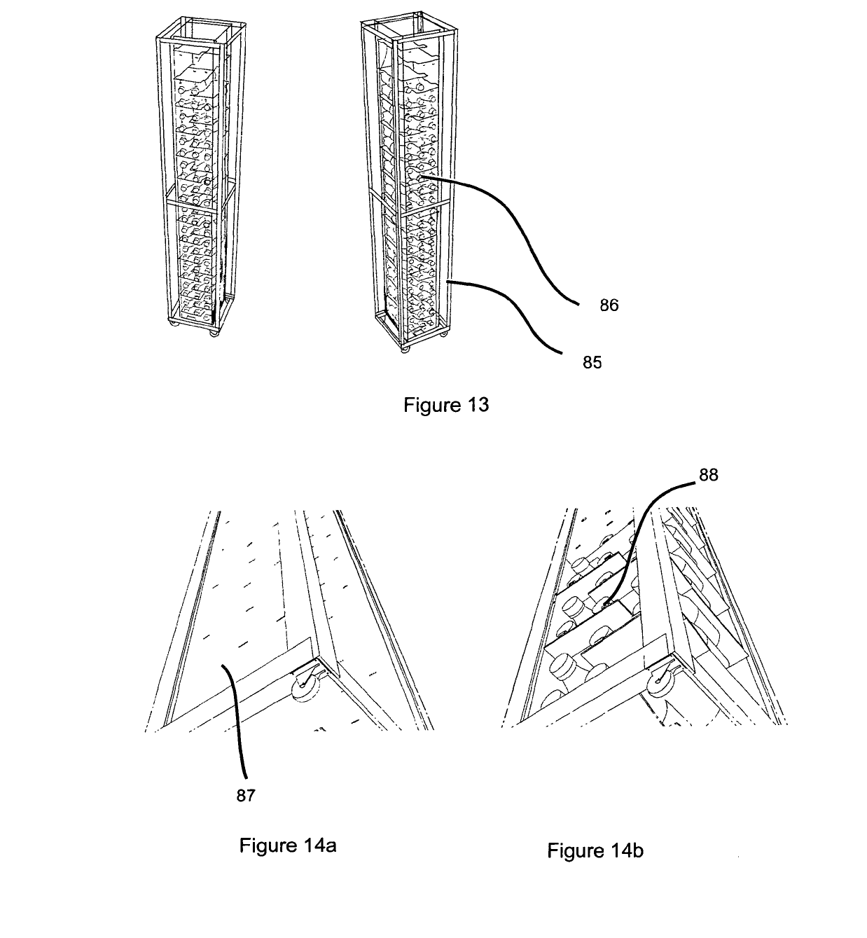

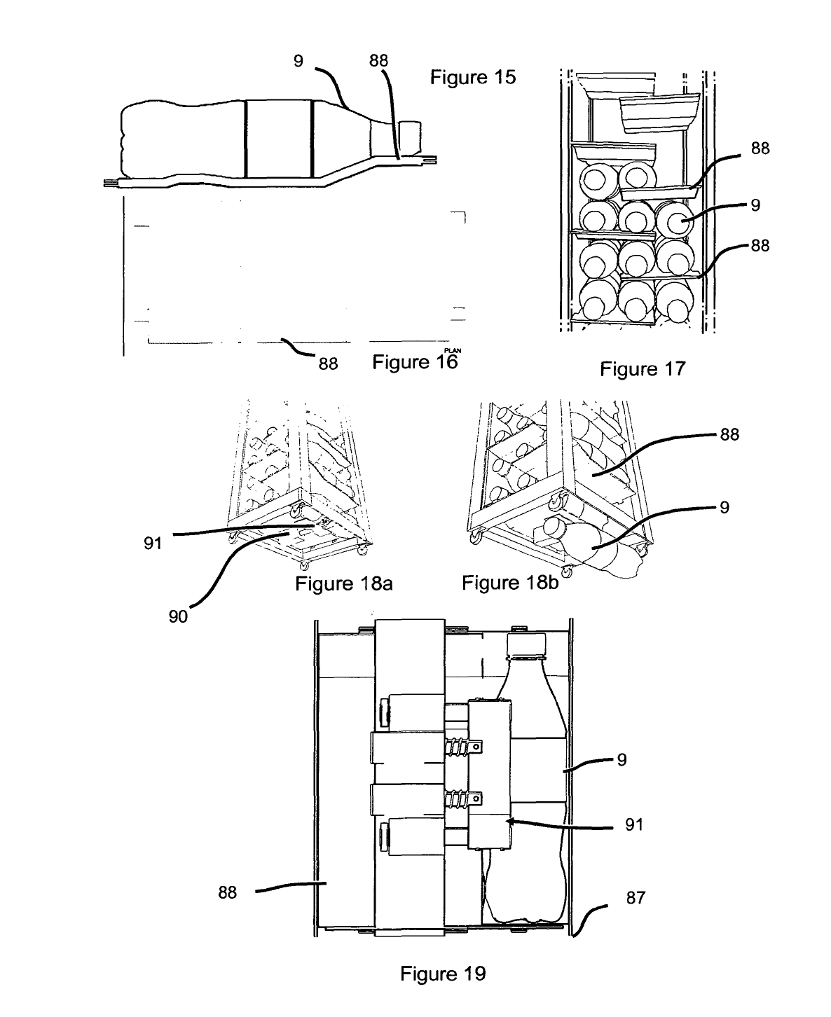

FIG. 9 shows a perspective view of one of the ball-bearings 44 of FIG. 8, split into two identical halves. The halves comprise complementary engagement formations 46 allowing the two halves to be snap-fitted to one another over the spindle 43. Advantageously, the ball-bearing halves are made of an injection moulded plastics material, and as each half is identical, each can be made from the same mould, minimising product cost. FIG. 9a shows a perspective view of one half of a variant of a ball-bearing 44′ of FIG. 13. Here, this ball bearing uses the same engagement formations 46 as the ball-bearing of FIG. 14, but has two central support spines 45′ further maximising the load-bearing capacity of the ball bearing 44′.

In use, when a product is dispensed from a product dispensing mechanism, it is dropped from above onto the cushioned product delivery net 40 and rolls over the array of ball-bearings in the direction that the product delivery net 40 is sloped, and the balls roll.

Referring back to FIG. 4, the product delivery net 40 that is situated at the lowermost position—towards which each section is sloped—feeds dispensed products to the product delivery location 20. The product delivery location comprises a product delivery box 70.

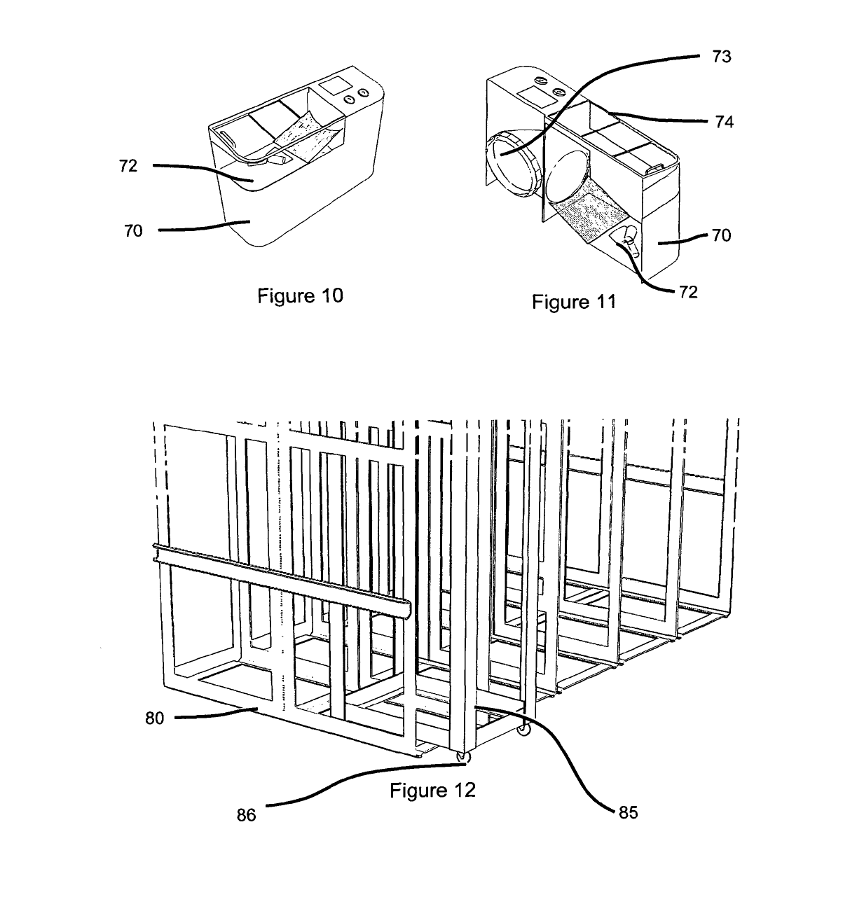

FIG. 10 shows a perspective front view of a product delivery box 70 of the vending machine of FIG. 2 shown in isolation from the vending machine with a product delivery lift 72 of the product delivery box 70 in a raised position. FIG. 11 shows a rear perspective cut-away view of the product delivery box 70 of FIG. 10 with the product delivery lift 72 in a lowered position. Referring to FIGS. 10 and 11, products fed from the lower most delivery net 40 are routed under the action of gravity by a corner pipe 73 to the lowered lift 72. The lift 72 is programmed to await the arrival of all the ordered products before lifting the products to a height convenient for a user when retrieving products through a delivery hatch 74 of the delivery box 70. The delivery hatch 74 is transparent, allowing the user to see the product that have been ordered and delivered. The product delivery box 70, and the dispensing mechanisms of the vending machine 1′ may employ product dispensing sensors such as electronic infrared or optical sensors to detect that a product has been successfully dispensed and has successfully arrived at the product delivery box 70. In alternatives, the product delivery box may be recessed into the ground.

FIG. 12 shows a partial perspective view of a frame 80 and a trolley 85 provided within the vending machine of FIG. 2. The frame 80 is arranged to hold several such trolleys 85 above the product delivery nets 40 of the vending machine. Castor wheels 86 at the base of the trolleys 85 allow easy manual handling and positioning into and within the frame 80. Although not shown, the trolleys 85 may also be provided with handles to further facilitate manual handling. Each trolley 85 can store different products to one another. Furthermore, each trolley houses one or more dispensing mechanisms adapted to drop a specific type, shape and size of product out from the bottom of the trolley 85 onto the product delivery net 40 and so to the product delivery box 70. The trolleys, and moreover, the product dispensing mechanisms contained within the trolleys are connected via a control system 3 in the form of a programmable logic controller—to the product ordering interface 2 so that the dispensing of products from an appropriate trolley/dispensing mechanism can be correctly coordinated. Such a connection may be realised physically using complementary electrical connectors on the trolleys and frame (not shown).

Hereinafter a series of different product dispensing mechanisms will be described for use and with reference to the first embodiment of the present invention. However, it will be appreciated that such dispensing mechanisms may be used in conjunction with the other described embodiments as appropriate. As will be seen, the majority of the described product dispensing mechanisms comprise or work in conjunction with at least one product channel in which discrete products can be stored and controllably released under control of the product dispensing mechanism.

FIG. 13 shows two trolleys of the vending machine loaded with product cassettes 86 defining such channels. These cassettes 86 hold products of a specific type—in this case Coca-Cola® bottles. These are stored within the cassettes 86 in a rolling shelf arrangement as will be described. FIG. 14a shows a partial underneath perspective view of a trolley provided with translucent polycarbonate sidewalls 87. FIG. 14b shows the same view of a trolley as FIG. 14a, with profiled product ramps 88 supported by the polycarbonate sidewalls 87 in said rolling shelf arrangement. Specifically, the polycarbonate sidewalls 87 are provided with tab-holes through which tabs of the product ramps 88 are inserted. Products can then be supported on the product ramps 88.

FIG. 15 shows a front sectional view of one of the product ramps 88 of FIG. 14b, a product 9 being provided on the ramp 88. FIG. 16 shows an overhead view of the profiled product ramp 88 of FIG. 15. The profiling of the ramp ensures that the product 9, when rolling down the ramp 88, does not turn out of alignment with the direction in which the ramp 88 is sloped. Thus, the chance of a product 9 getting stuck within the rolling shelves can be minimised. FIG. 17 shows a partial side perspective view of the products 9 and product ramps 88 of FIG. 14b. As the product ramps are inclined slightly, products 9 roll slowly, under the action of gravity, through the product cassette 86. Advantageously, this can reduce the load on a dispensing mechanism provided underneath the stack of products 9. In alternatives, it will be appreciated that the ramps may be substituted with other support structures that support, guide and control the delivery of products through the cassette 86. To this end, such support structures may be shaped and arranged to define a serpentine path through the cassette 86. Further, it will be appreciated that different products will require differently shaped and arranged support structures to support, guide and control properly the delivery of products through the cassette 86.

FIG. 18a shows a partial perspective underneath view of the trolley provided with a product dispensing mechanism 90 comprising a solenoid-actuated trap-door 91, the trap-door being in a position preventing release of a product. Because of the rolling shelf arrangement defined by the profiled plates 88 supports the product stack, the trap-door 91 only needs to bear the weight of a single product 9. FIG. 18b shows the same view as FIG. 18a, wherein the trap-door 91 is in a position permitting release of a product 9. Another advantage of the rolling shelf arrangement is that it is easier to guarantee to dispensing of exactly one product 9 for each actuation of the trap-door 91. This is because there is a long delay between release of one product 9 and the next product 9 rolling into position over the trap-door 91. Specifically, the timing tolerance for opening and then closing the trap-door is larger than if products were stacked vertically above the trap-door 91.

FIG. 19 shows an underneath view of the product 9, product ramps 88 and solenoid-actuated trap-door 91. As can be seen, the product 9 to be released rests between a polycarbonate side wall 87 of the product cassette 86 and the solenoid-actuated trap-door 91. As mentioned, the majority of the weight of a product 9 is supported by an extruded shelf via a pair of steel pin bearings that can slide relative to tubes. Springs normally bias the shelf outward to block the passage of a product 9. The centrally disposed pair of solenoids actuate against the spring bias to pull the shelf in towards the solenoids, thereby opening a gap between the shelf and the polycarbonate sidewall 87, allowing a product to fall through, and so be dispensed.

As will be appreciated, many different dispensing mechanisms may be employed. Furthermore, features of different product dispensing mechanism, product cassettes, trolley and even vending machines may be combined where context allows.

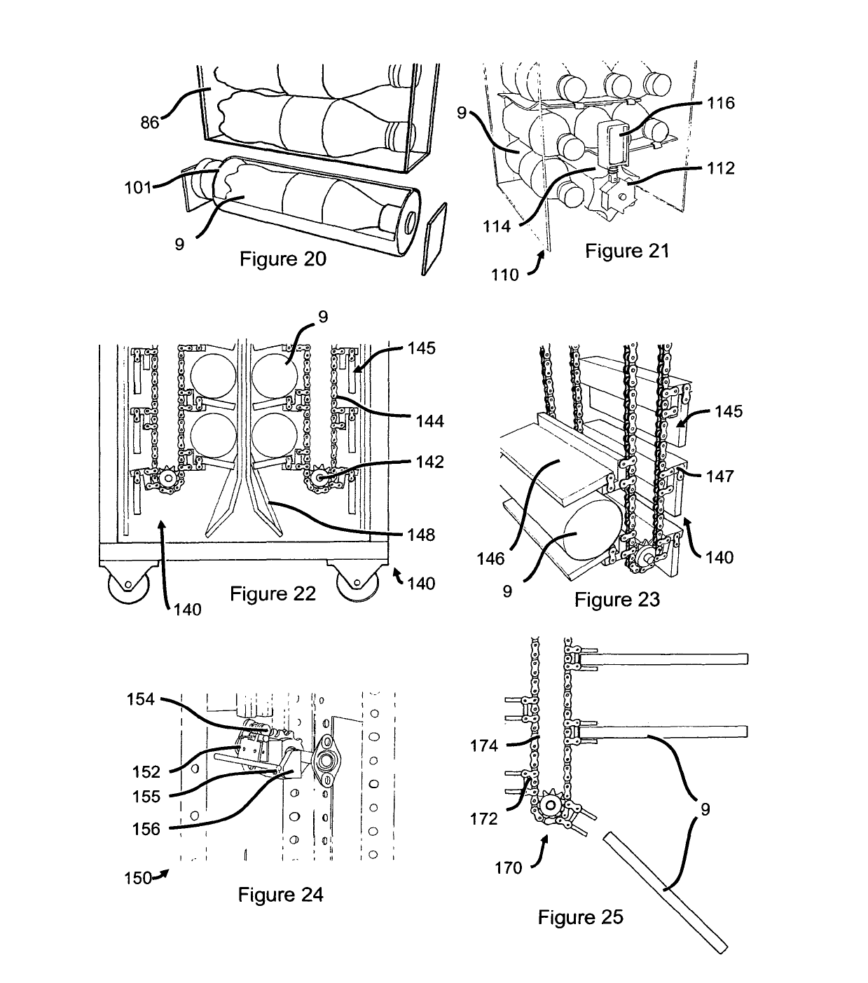

FIG. 20 shows a partial perspective view of an alternative product dispensing mechanism comprising a rotating trap-door 101. The rotating trap-door 101 comprises a barrel within which a product to be dispensed can be accommodated. The interior of the barrel is accessible to via an opening. In use, the barrel is rotated by an electro-motor under the control of the control system 3 such that the opening faces upwards to allow a product 9 to fall into the barrel, and then downward to dispense that product 9. Bearings of the trapdoor are sufficient to support the weight of the stack of products and the shape and operation of the trapdoor controls the dispensing of a single product at a time. Accordingly, the product cassette 86 does not need to be provided with ramps as with the previous dispensing mechanism, but rather the products can be vertically stacked on one another directly.

FIG. 21 shows a partial perspective view of another product dispensing mechanism comprising a solenoid-controlled ratcheted rotating trap-door 110. This product dispensing mechanism 110 comprises a ratchet wheel 112 rotationally coupled with a star wheel 114 having a star-shaped cross-section and defining indentations within which products 9 can be accommodated at least in part. In use, the star wheel 114 is prevented from freely rotating by virtue of a solenoid arm engaging with teeth of the ratchet wheel 112 until the arm is withdrawn by the solenoid 116 under control of a control system 3. When the solenoid arm is withdrawn, a product 9 rotates the star wheel as it falls past it under the action of gravity. The arm is returned to engage with the ratchet wheel 112 and ramps up the radially-outer surface of the ratchet wheel until rotation of the star wheel 114 brings the arm into engagement with next tooth of the ratchet wheel 112. Thus products 9 can be dispensed, controlled with an indexing action. In alternatives, a pair of aligned and suitably-spaced contra-rotating trapdoors 110 may be provided between which a product 9 can be controllably dispensed.

FIG. 22 shows a partial side view of further product dispensing mechanisms 140 comprising motor-driven lifts. Here, each product dispensing mechanism 140 comprises a motor-driven sprocket 142 which engages with and drives an endless chain 144 in use. The sprockets 142 comprise bearings that bear the weight and tension transmitted through the chain 144. Lift mechanisms 145 are attached to the endless chain 144 at intervals, and support products 9 to be dispensed. FIG. 23 shows a more detailed view of a lift mechanism 145 which comprises a product supporting shelf 146 attached to the chain 144 via hinge components 147. When supporting a product 9, the shelf 146 projects transversely from the chain to define a substantially horizontal surface. In use, the motor (not shown) is activated to rotate the sprocket 142 a predetermined angle to ensure the dispensing of a single product 9. Specifically, as the sprocket 142 rotates, the lowermost lift mechanism 145 reaches the bottom of its travel along the chain 144 and the shelf 146 dips downwards to dispense the product 9. Deflectors 148 ensure that the product 9 slides out smoothly, and is not dropped from a significant height from within the trolley. After product dispensing, the hinge components 147 allows the shelf 146 to fold back, close to and substantially parallel with the chain during its upward travel. Advantageously, the folding of the shelves after product dispensing can save space within the vending machine 1.

This type of product dispensing mechanism 140 may comprise a chain tension system that ensures that the chain 144 is kept taut such that the weight of the product on a shelf does not kink the chain 144 and dip the respective shelf 146 prematurely. Such a chain tension system may comprise a non-driven sprocket biased into the chain 144. Also, to prevent unwanted kinking of the chain under the weight of the product 9, the hinge components 147 are arranged to ensure a shelf 146 is attached to the chain 144 at attachment positions that are spaced along the chain 144.

In alternatives of this type of product dispensing mechanism 140, products may be dispensed without the need for a motor to drive the chain 144. This can be achieved instead by using the weight of the products 9 to cause movement of the chain 144. In such a case, an indexing mechanism, such as a solenoid-controlled latch may be employed to ensure a single product is dispensed at a time. Advantageously, this reduces the power required to dispense a product. Under certain circumstances, the weight of products alone may not be sufficient to drive the chain, in which case an additional weight appended to the uppermost region of the chain can impart the desired movement of the chain.

FIG. 24 shows a partial perspective view of a further product dispensing mechanism 150 for use in the vending machine of FIG. 2, similar to that shown in FIGS. 22 and 23 in that a motor-driven chain is indexed to dispense products. However, this product dispensing mechanism 150 utilises a motor-driven spring-loaded clamp system. The product dispensing mechanism 150 comprises a plurality of clamps 152 that are spring-loaded closed so as to hold a product within the clamp jaws—for example, a packet of crisps (not shown). The clamps 152 are provided at intervals along an endless chain 154. At the bottom of a clamp's travel, a bar 155 extending from the clamp jaws bears against the ramped surface of a clamp-opener 156, forcing the jaws apart, thereby releasing the product. In use, the motor drives the chain 154 a predetermined distance to slide the bar 155 of a single clamp 152 past the clamp-opener 156 so as to dispense a single product at a time.

FIG. 25 shows a side view of a further product dispensing mechanism 170 for use in the vending machine of FIG. 2, the product dispensing mechanism comprising a motor-driven rack. Like the product dispensing mechanisms described with reference to FIGS. 22 to 24, this dispensing mechanism 170 also uses a motor-driven chain. This product dispensing mechanism 170 is particularly useful for dispensing relatively rigid planar items 9 such as CD or DVD cases. The planar items 9 are racked in a horizontal orientation by fixed-width jaws 172. The jaws 172 are connected to an endless motor driven chain 174. In use, as the chain is rotated by the motor a predetermined distance, the lowermost product-holding rack is oriented downward to allow the product to slide out from the jaws 172 and so dispensed.

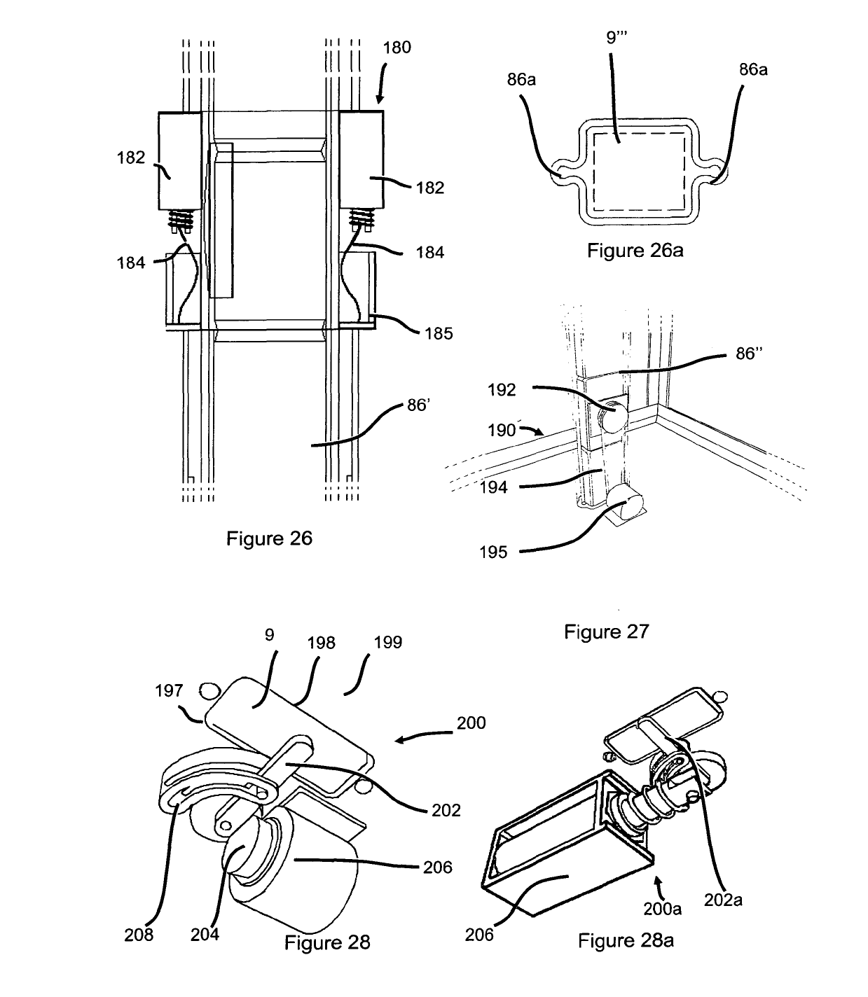

FIG. 26 shows a side view of a further product dispensing mechanism 180 for use in the vending machine of FIG. 2. This type of product dispensing mechanism 180 comprises solenoid-driven leaf-springs operative to control the passage of a product through a product cassette 86′. Each solenoid 182 has an arm connected to one end of a leaf spring 184. The other end of the leaf spin 184 is constrained within a spring-box 185. The solenoid arm is normally biased outward of the solenoid by a coil spring fitted about the solenoid arm, and this bends the leaf spring 184, extending the middle of the leaf spring 184 into a gap defined in the product cassette 86′. This urges the leaf spring 184 into a product 9 (or at least into the path of a product) within the product cassette 86′, preventing it from falling though the product cassette 86′. In use, when the solenoid is energised, the solenoid arm is retracted and the leaf spring straightens, permitting the previously held product 9 to fall through the vertical channel defined by the product cassette 86′. Accordingly, it is possible to control the dispensing of products. It should be noted, that the solenoids 182 are recessed partially into the cassette 86′. Referring to FIG. 26a, an approximate cross-section of the cassette 86′ is shown. The solenoids 182 are recessed in the wings 86a of the cassette 86′. Advantageously, this can save space within the vending machine 1.

FIG. 27 shows a partial perspective view of a further dispensing mechanism 190 for use in the vending machine of FIG. 2 comprising a motor-driven rotary clamp. Here, the product dispensing mechanism 190 comprises a threaded clamp 192 which can be extended into and retracted from the product cassette 86″ to interrupt or permit the passage of products therein by rotation of the threaded clamp 192. The threaded clamp 192 is connected to a motor 195 by an endless belt 194 which rotates in one direction or the other to extend or retract the threaded clamp 192 respectively. Advantageously, the threaded clamp 192 may comprise a resilient portion at its contact point with a product to facilitate secure clamping of the product without damaging the product.

FIG. 28 shows an enlarged perspective underneath view of a trolley fitted with a base-plate 199 and a further product dispensing mechanism 200 attached to the trolley base-plate 199, the product dispensing mechanism 200 comprising a motor-driven trap-door arm 202. The product dispensing mechanism 200 also comprises a bevel gear 204 connecting the arm 202 to a motor 206. An arm guide 208 guides the movement of the trap-door arm during use. Swinging movement of the arm 202 relative to openings in the base plate 199 controls the dispensing of products 9′″ through the openings. Specifically, the arm 202 is rotationally coupled to one half of the bevel gear 204 such that activation of the motor 206, and so rotation of the bevel gear 204 causes the arm to swing relative to the opening 198. It will also be noted that screw holes 197 for screwing into the wings 86a of an extruded cassette 86′ are provided to maintain the position of the cassette 86′ relative to the base-plate 199. Alternatively, a different actuator may be used to drive the trap-door. FIG. 28a shows an enlarged perspective underneath view of the trolley of FIG. 63, where an alternative product dispensing mechanism 200a comprises a solenoid-driven trap-door arm 202a. Here the back-and-forth swinging movement of the arm 202a is driven by the reciprocating movement of the solenoid 206a. Advantageously, the positioning of the main components of these dispensing mechanisms underneath the base plate efficiently uses the space that would otherwise be empty. This is the space formed by raising the trolley by mounting it on castor wheels.

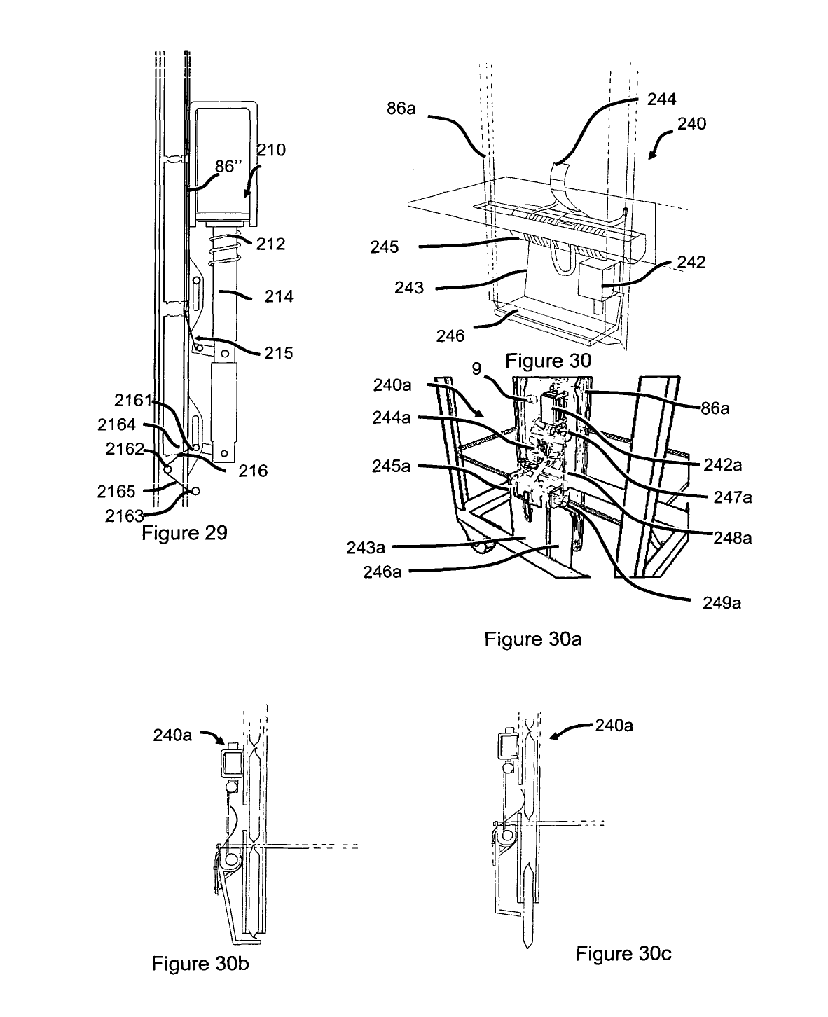

FIG. 29 shows a side view of another product cassette 86″ provided with a further product dispensing mechanism 210 comprising two hinged trap-doors: a first hinged trap-door 215 and a second hinged trap-door 216, both actuated by a common solenoid 212. Each trap-door comprises three parallel pivots and two plates. As referenced in FIG. 29 in relation to the second hinged trap-door 216, the pivots include a first pivot 2161, a second central pivot 2162 and a third pivot 2163 and the plates include an upper plate 2164 and a lower plate 2165. The upper plate 2164 bridges the first and second pivot, and the lower plate 2165 bridges the second and third pivot. The first pivot of the first hinged trap-door and the third pivot 2163 of the second hinged trap-door are pivotally fixed relative to the cassette 86″ adjacent to respective first and second openings defined in the cassette 86″. In use, the hinged trap door either extend through the openings into the interior of the cassette 86″, or lie flat about the opening as will be described. The product dispensing mechanism 210 further comprises a solenoid arm 214 that is pivotally connected to the first hinged trap-door 215 at its third pivot and is also pivotally connected to the second hinged trap-door 216 at its first pivot. In use, the solenoid arm 214 is biased by a compression spring towards one extent of its travel—as shown in FIG. 29—extended away from the body of the solenoid 212. In this first configuration, the first trap-door 215 is straightened to lie flat about the opening and so allow passage of products through the product cassette 86″ and the second trap-door is bent through the opening into the product channel defined by the product cassette 86″ to block passage of products through the product cassette 86″. When the solenoid arm 214 is energised and so retracted against the spring bias into the body of the solenoid 212, the trap-door formations are reversed. In this second configuration, first trap-door is bent to block passage of products through the product cassette 86′″ and the second trap-door is straightened to allow passage of products through the product cassette 86″. Thus, only a single product is permitted through the product cassette 86′″ at any one time.

In alternatives, a single solenoid may be used to actuate a single hinged trap-door. Although there is a cost and efficient saving to use a single solenoid to actuate two trap-doors, it may be necessary for some products to have independent control of each of the trap-doors. In further alternatives, another driving means may be used to drive the trap-doors or out from the product channel defined within the product cassette 86″. For example, one or more hinged trap-doors may instead be actuated by a motor. For example, a motor may be connected to the trap doors via a tether and linkage such that rotation of the motor in one direction winds the tether onto a motor spindle, and so draws the trap-doors from a first configuration to a second configuration. Conversely, driving the motor in the other direction unwinds the tether from the spindle allowing, for example, a compression spring to restore the first configuration. In other alternatives, a pair of tethers, or band, or chain may be driven by the motor to alternate the configurations of one or more hinged trap-doors. Such alternatives with tethers may comprise a pulley system to control the tension and speed with which the trap-doors may be actuated.

FIG. 30 shows a partial perspective view of a further product dispensing mechanism 240 for the vending machine of FIG. 2, comprising a solenoid-actuated combined trap-door and leaf-spring. The trap-door 243 and the leaf-spring 244 are linked to one another and pivotable about a common pivot 245. The pivot 245 is spring-loaded to bias the trap-door 243 so that a ledge 243a of the trap-door 243 covers the opening of the product cassette 86a. At the same time, the pivot spring holds the leaf-spring 244 away from the product pathway defined through the product cassette 86a. During the dispensing of products, the solenoid 242 bears against the sloped surface of the trap-door 243 against the bias of the pivot spring to slide the ledge 246 of the trap-door 243 away from the opening—allowing a product contained in the product cassette 86a to drop through. At the same time, the leaf spring 244 is pivoted into the product pathway defined by the product cassette 86a and is urged against a product to hold it within the pathway. A stack of products above that held by the leaf spring 244 also remain within the product pathway. Accordingly, the product dispensing mechanism 240 is controlled to dispense a single product at a time. Again, here the drive for controlling product dispensing is a solenoid. However, in alternatives, this may be another drive means such as a motor.

For example, FIG. 30a shows a reverse perspective view of such an product dispensing mechanism 240a alternative to that of FIG. 30. Here, the product dispensing mechanism comprises a motor-actuated combined trap-door and leaf-spring. The principles and operation of this product dispensing mechanism 240a is very similar to that described and shown in FIG. 30, in that there is a trapdoor 243a with a ledge 246a and a leaf spring 244a, pivotable about a common pivot 245a to control the dispensing of products 9 one at a time. However, instead of a solenoid, a motor 242a is provided to actuate these components. The motor 242a linked via gears to a spindle 247a around which one end of a tether 248a is wound. The other end of the tether 248a is wound around a further spindle 249a which is rotationally coupled to the trapdoor 243a and leaf spring 244a about the pivot 245a. Thus rotation of the motor 242a in one direction causes the trapdoor 243a to open (as shown in FIG. 30c), and the leaf spring 244a to bear through the aperture of the cassette 86a against a penultimate product in the stack. Here, the motor 242a works against the bias of the pivot spring. When the motor 242a is rotated in the other direction, the tether 248a slackens and the biasing of the pivot spring closes the trapdoor 243a and pulls the leaf spring 244a away from the aperture in the cassette 86a (as shown in FIG. 30b).

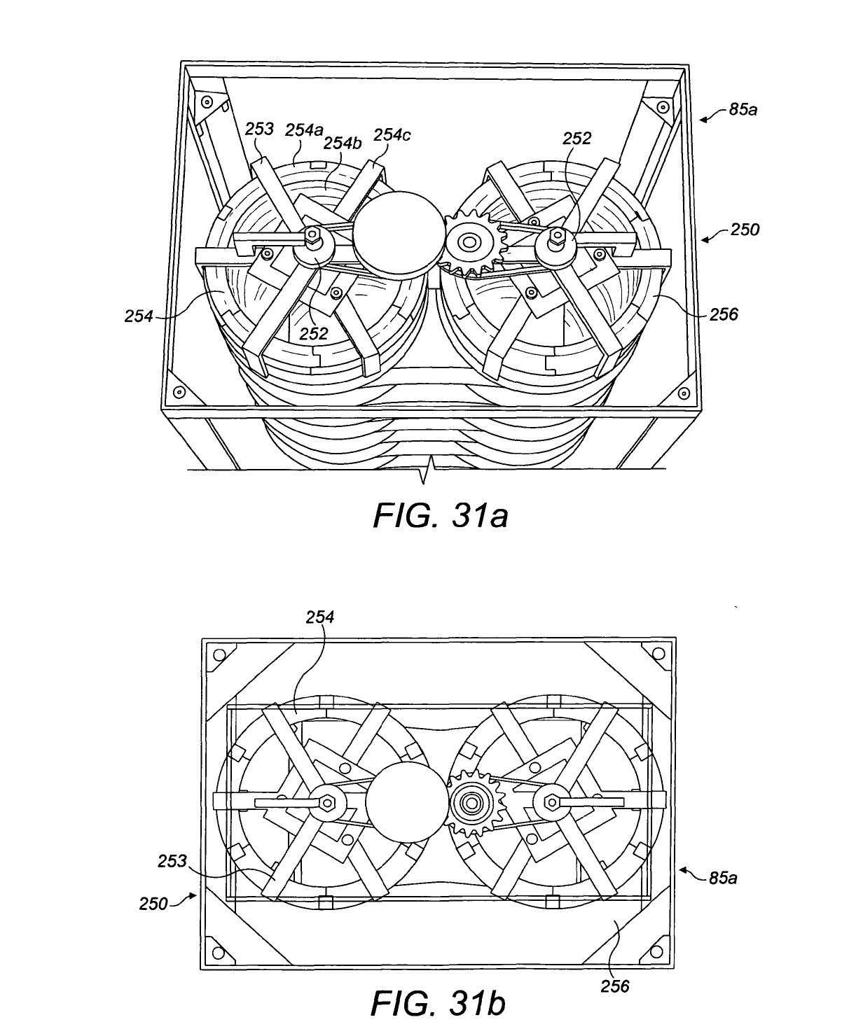

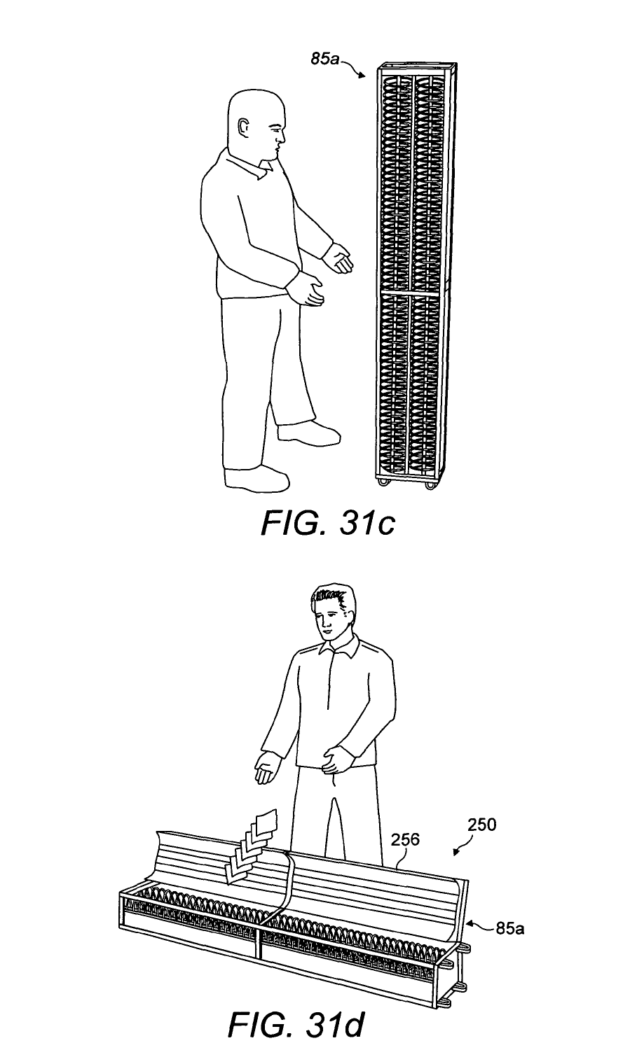

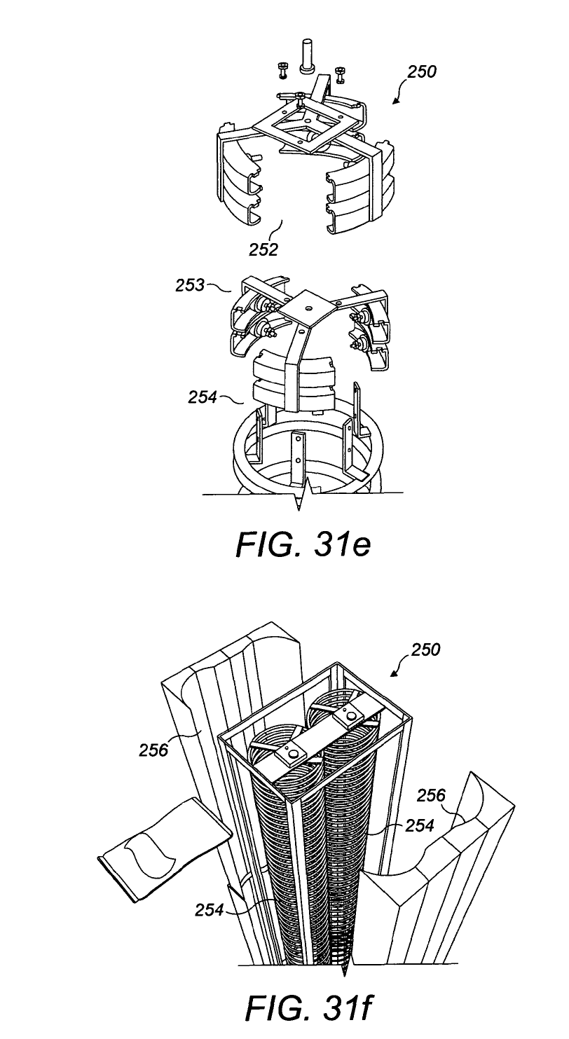

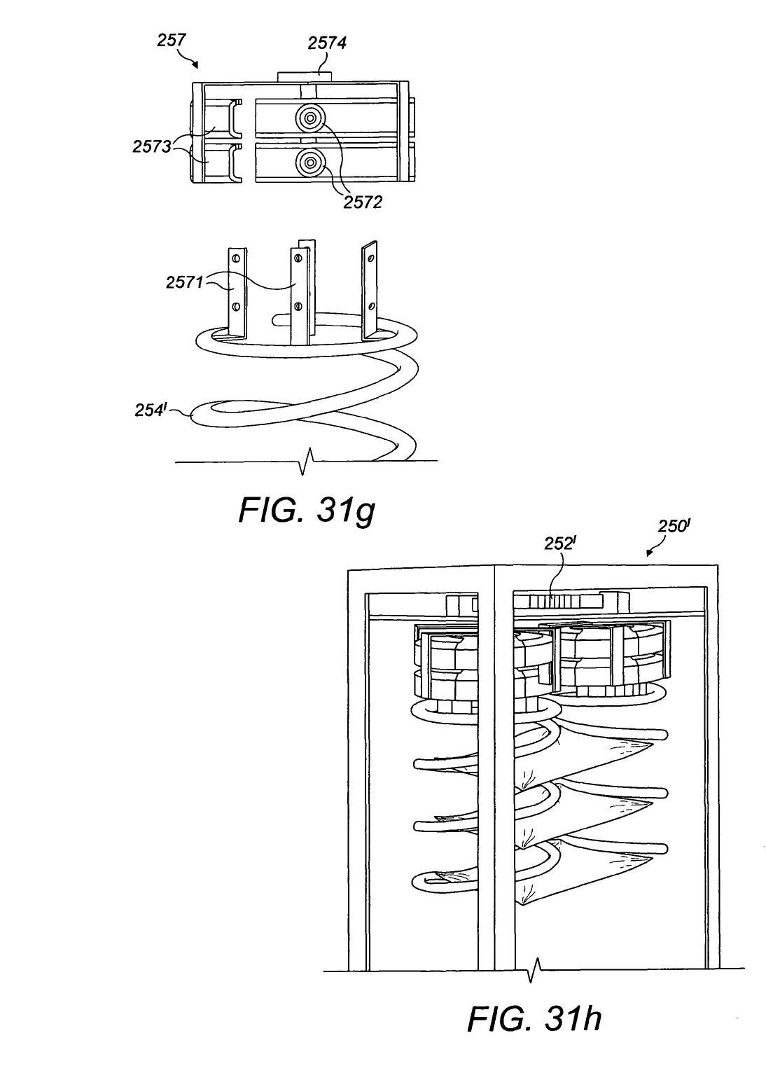

FIGS. 31a to 31g show various perspective schematic views of a further product dispensing mechanism 250 for the vending machine of FIG. 2, comprising motor-driven product spirals. Referring to FIG. 31a a top perceptive view of a trolley 85a fitted with this product dispensing mechanism 250 is shown. The product dispensing mechanism comprises two motors 252 each attached via spokes 253 to a respective wire spiral 254 extending along the height of the trolley 85a. The pair of spirals 254 are positioned relative to one another so that aligned successive turns 254a, 254b 254c of each spiral 254 form successive product supports. A plurality of products can thus be accommodated between the pair of spirals 254, each product residing between successive product supports. Referring to FIG. 31b, in which an underneath view of the trolley 85a is shown, a product in the form of a packet of crisps is shown supported between turns of the pair of spirals 254. The pair of spirals 254 are encapsulated within sidewalls 256 to ensure the products do not fall out of the spirals 254 unintentionally during operation of the product dispensing mechanism 250. A schematic exploded perspective view of the sidewalls 256 separated from the spirals 254 is shown in FIG. 31f. As shown in FIGS. 31c and 31d, the trolley 85a fitted with this product dispensing mechanism 250 can be laid flat by restocking staff, a sidewall 256 of the trolley 85a can be hinged open, and products can be inserted into each space between the product supports defined by the successive spiral 254 turns. Referring to FIG. 31e, an enlarged perspective exploded view of a spiral 254, a respective spoke 253 and motor 252 is shown. The motor 252 may utilise gearing to increase the torque imparted via the spoke 253 to the spiral 254.

In use, to dispense a product, the motors 252 are simultaneously activated to rotate respective spirals by one turn in a direction translating the products downward, towards the bottom of the trolley 85a. Accordingly, a product at the bottom-most and free ends of the spirals 254 will drop out onto product delivery nets 40 as previously discussed.

FIGS. 31g and 31h show partial side views of a product dispensing mechanism 250′ similar to those detailed in relation to FIGS. 31a to 31f. For brevity, the main differences will be described. This alternative product dispensing mechanism 250′ comprises only a single motor 252′ which is activated to rotate two spirals 254′ via gearing and spindles 253′. However, the weight of the spirals 254′ and held products is borne mainly by a pair of support assemblies 257. A partial exploded view of a support assembly 257 is shown in FIG. 31g. The support assembly 257 comprises a set of five vertical struts 2571, a set of five pairs of rollers 2572, a respective pair of circular tracks 2573 and a hanger 2574. Each strut 2571 is connected at a lower end to an upper end of the spiral 254′ and each strut 2571 is rotatably coupled at an upper end to a respective pair of rollers 2572 that are, in turn, caged within the pair of respective circular tracks 2573. The circular tracks 2573 are fixed securely via the hanger 2574 to the trolley 85a. The rollers 2572 and tracks 2573 thus together define bearings that support the weight of a spiral 254′ in the axial direction whilst permitting free rotation of that spiral 254′ about said axis; spindle arms connected to the struts transmitting the torque of the motor to the spirals 254′.

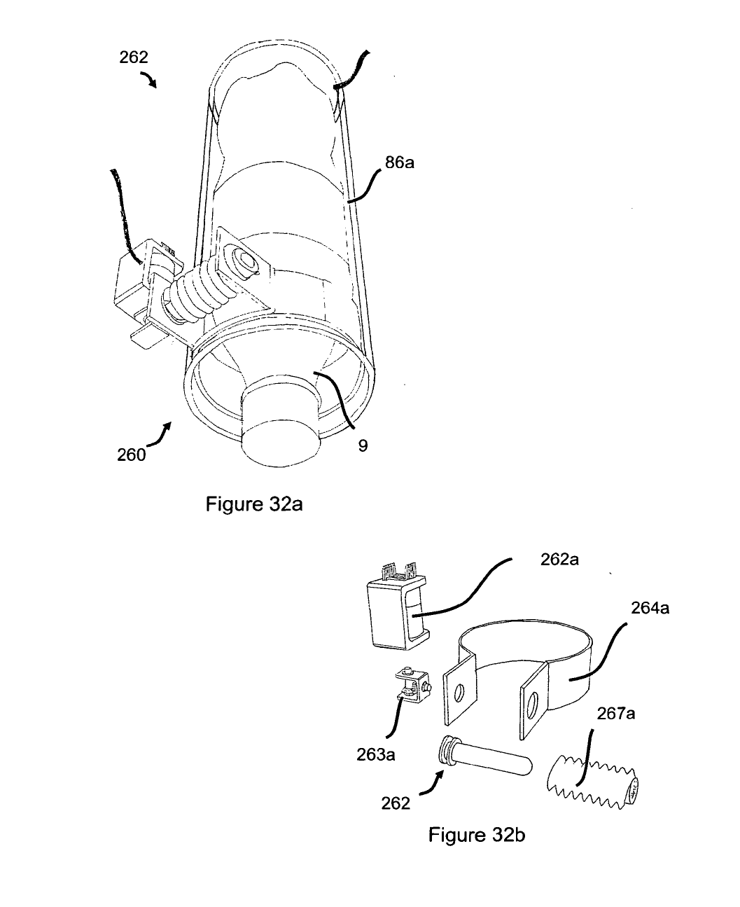

FIG. 32a shows a perspective view of another product dispensing mechanism 260 comprising a product channel restrictor 262 fitted relative to a product cassette 86a within which products 9 are stored and from which the products are dispensed under the control of the product channel restrictor 262. Only a partial view of the cassette 86a is shown holding a single product 9, but it will be understood that the cassette is of a length permitting many products to be held within it—for example, seven or eight products per cassette 86a. Also, although only a single product channel restrictor 262 is shown in FIG. 32a, it will be understood that typically a pair of product channel restrictors 262 is employed per cassette 86a. The cassette 86a has an annular cross-section and the products 9 within it are bottles. The interior of the cassette 86a thus defines a tubular product delivery channel.

FIG. 32b shows an exploded perspective view of one of said product channel restrictors 262. Each product channel restrictor 262 comprises a motor 262a which is linked by gearing 263a to a worm drive 267a threaded to ends of a band 264a so that the effective circumference of the band 264a can be altered by driving the motor 262a one way or the other. Referring back to FIG. 32a, the band is positioned inside the product channel defined by the cassette 86a and the ends of the band 264a to which the worm drive 267a connect project through an opening in the cassette 86a. In use, the motor 262a is operated to control the effective circumference of the band 264a and as such permit or deny passage to the products 9 beyond the band and through the product channel under action of gravity. Naturally, if the motor 262a is controlled such that the effective circumference of the band is less than the outer circumference of the product 9, then the product 9 will be unable to pass through. Further, as mentioned, two product channel restrictors 262 are typically employed and are controlled in sequence to ensure that a single product 9 is dispensed at a time.

In alternatives, the product channel restrictor 262 may act to restrict the product channel by constricting a flexible region of that channel. In further alternatives, the drive for the product restrictor may be of another form—for example, a solenoid. In such a case, the solenoid can be energised to tighten the band, for example by translating the linear motion of the solenoid to compress the ends of the band together thereby reducing the effective circumference of the band.

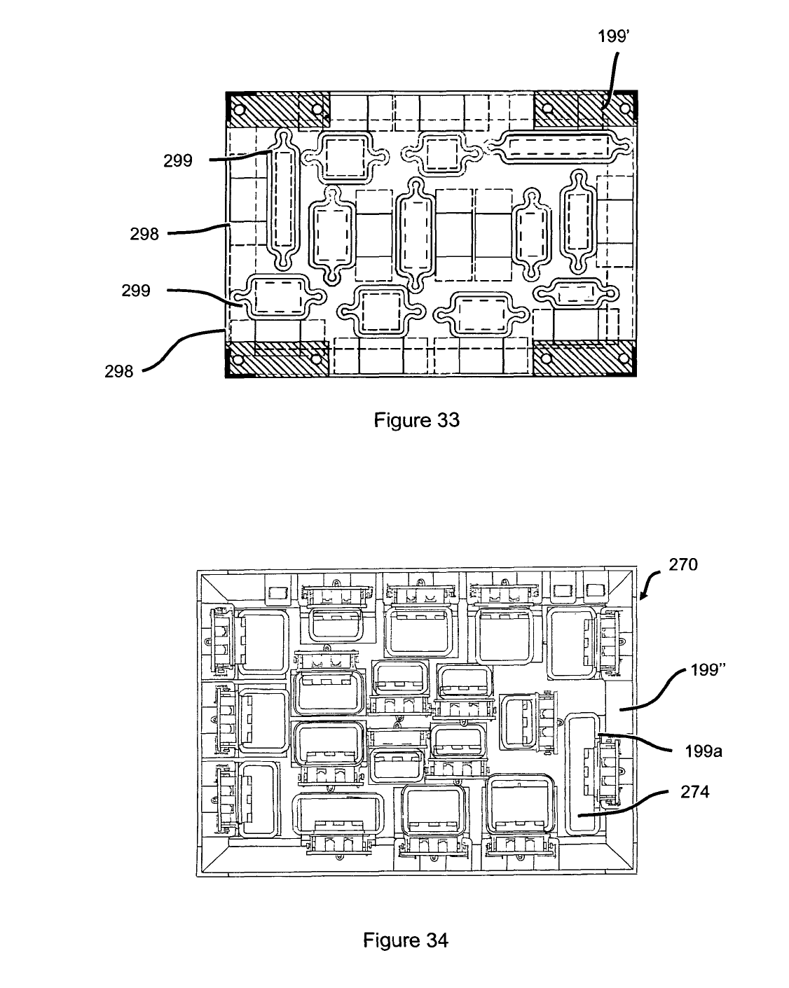

FIG. 33 shows a schematic view of a trolley base-plate 199′ alternative to that shown in FIG. 28, with regions of the trolley base-plate 199′ designated for supporting a variety of product dispensing mechanisms. An outline 299 of each product cassette and an outline of a respective actuator 298 driving the respective product dispensing mechanism is shown on this schematic view. Dotted outlines within the product cassette outlines 299 denote openings in the trolley base-plate 199′ through which products may be dispensed. As can be seen, the cross-sectional size and shape of each product cassette is different to accommodate different products. Here twelve product cassettes are supported by the single trolley base-plate 199′.

FIG. 34 shows a underneath view of another trolley base-plate 199″ alternative to FIG. 33, showing an alternative arrangement of product dispensing mechanisms 270 supported by the trolley base-plate 199″. Each product dispensing mechanism 270 comprises a motor-driven, spring-loaded trap-door 274 as will be described. Again, openings 199a are provided in the base-plate 199″. Each opening 199a is covered by the spring-loaded trap-door 274.

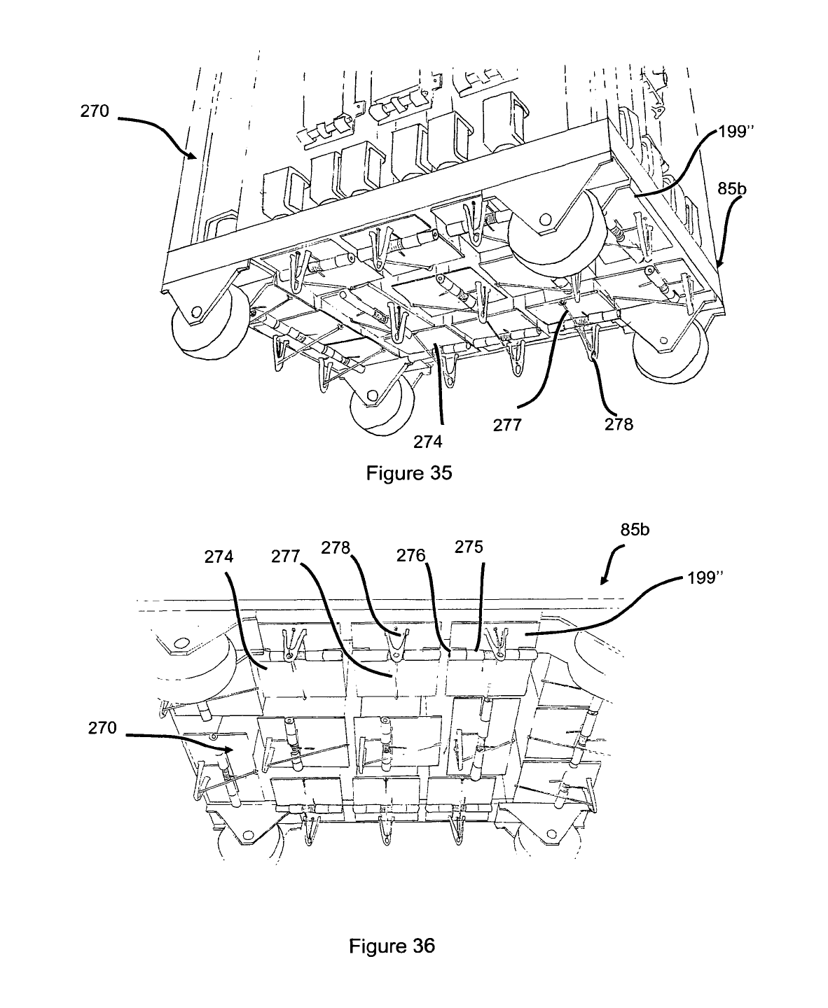

FIGS. 35 and 36 show partial underneath perspective views of a trolley 85b having the trolley base plate of FIG. 34. The trolley base plate 199″ supports a plurality of product dispensing mechanisms 270 having motor-driven, spring-loaded trap-doors 274 and hinged trap-doors 274a similar to that described above. Each spring-loaded trap-door 274 is hinged via a pivot 276 relative to the base-plate 199″. Furthermore, each trap-door 274 is biased against the base-plate 199″ about the pivot 276 to close against a respective opening 199a by a torsion spring 275. A tether 277 linked to the end of a trap-door 274 remote from the pivot 276 is threaded via a routing member 278 and via an opening in the base-plate 199″.

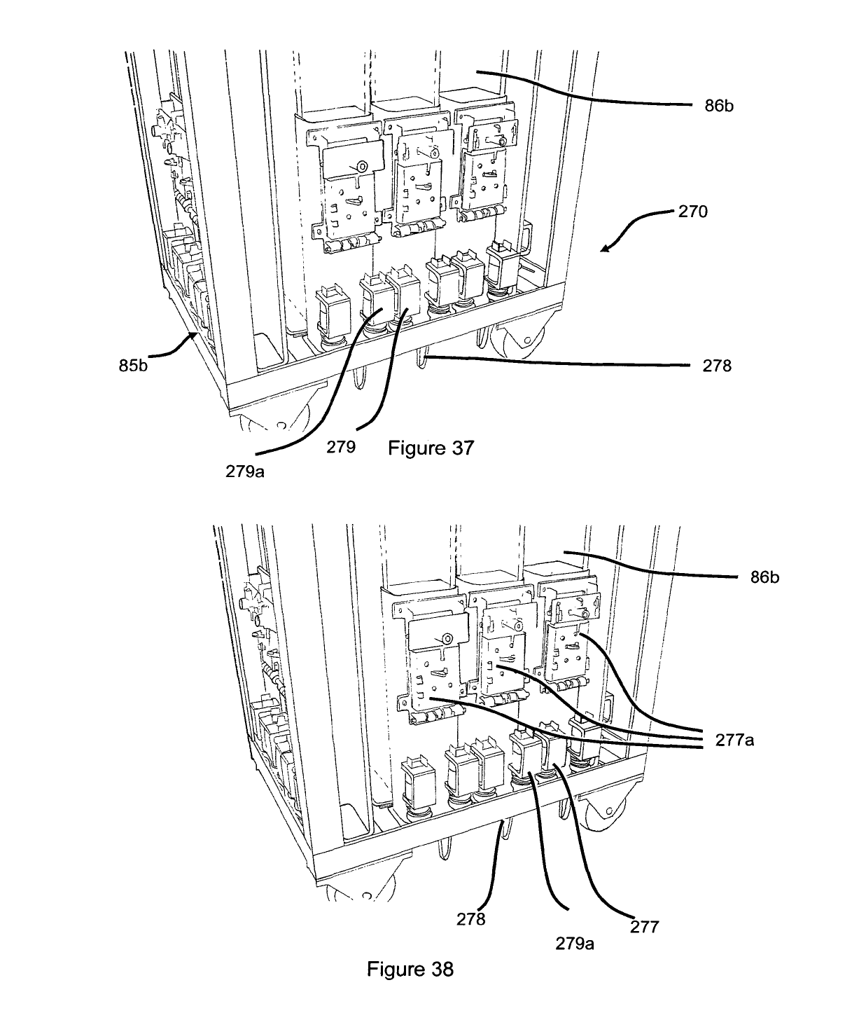

FIGS. 37 and 38 show partial perspective views of the trolley 85b and the product dispensing mechanisms 270 of FIGS. 35 and 36. The base-plate 199″ supports the product dispensing mechanisms 270 as well as associated product cassettes 86b. Each tether 277 passes through the opening in the base-plate 199″ and linked to a respective motor 279 via a spindle and gearing. When the motor is driven, the tether is wound around the spindle and pulls the trap-door 274 against the biasing of the torsion spring 275. When the motor is driven in reverse, the tether 277 is kept taut by the torsion spring 275 which returns the trap-door 274 to close the opening in the base-plate 199″.

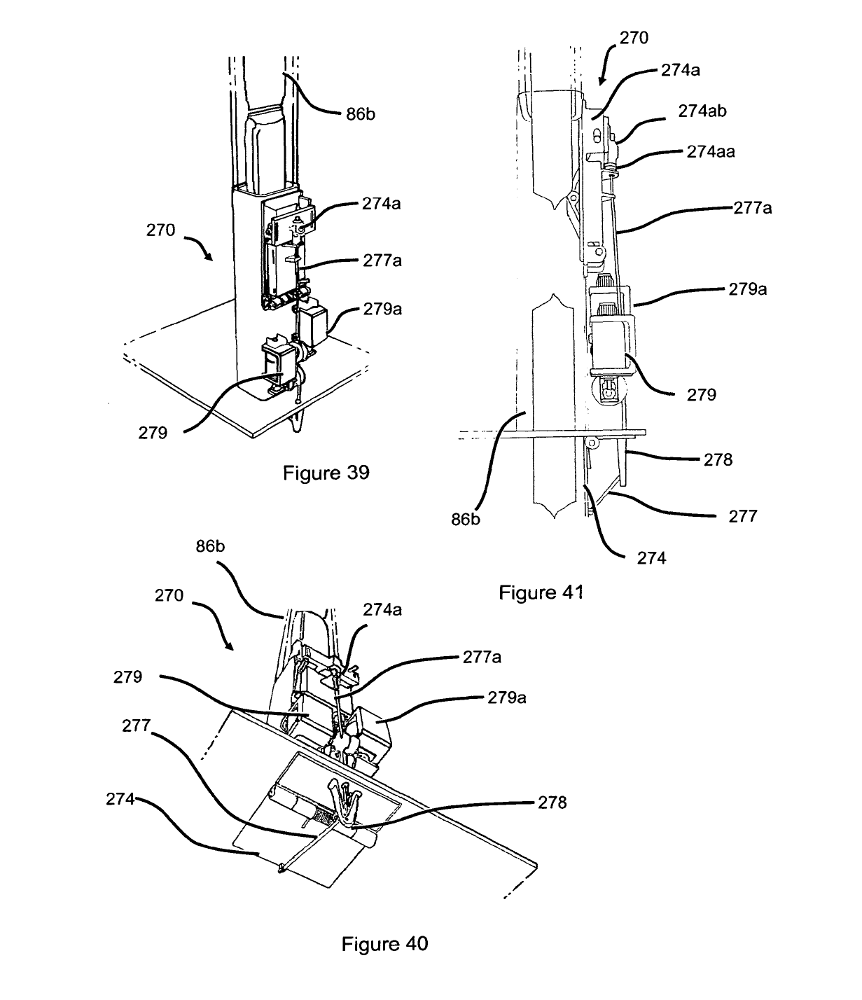

FIGS. 39 to 41 show various perspective views of each of the product dispensing mechanisms 270. Each product dispensing mechanism 270 comprises a second motor 279a which is linked via gearing, a spindle and a tether 277a to a hinged trap-door 274a similar to that described in relation to FIG. 29. Here, a compression spring 274aa normally biases a linkage 274ab which is attached to a hinged trap-door 274a into a straightened position allowing a product to pass through the product cassette. One end of the tether 277a is wound onto the motor 279a spindle and the other is attached to the linkage 274ab. When the motor 279a is driven, the tether 277a winds around the spindle and pulls on the linkage 274ab against the biasing of the compression spring 274aa to fold the hinged trap-door 274a, thereby interrupting the passage of a product through the cassette 86b. When the motor 279a is driven in reverse, the tether 277a is kept taut by the compression spring 274aa which returns the hinged trap-door 274a to the straightened configuration allowing the passage of a product through the product cassette 86b.

During product dispensing the motors 279, 279a are activated to operate the respective trap-doors 274, 274a in a sequence that ensures that only a single product is dispensed at a time. In particular, the lowermost trap-door 274 is opened and then closed during a period when the uppermost hinged trap-door 274a interrupts the passage of subsequent products through the product cassette 86b.

As has been demonstrated, the vending machine 1′ of FIG. 2 can employ a variety of different dispensing mechanism—each suitable to handle different types of product. Accordingly, the vending machine 1′ is capable of dispensing multiple products and, moreover, different types of product at the same time. Thus, multiple and heterogeneous products can be dispensed more quickly than prior known vending machines. In addition, the way in which products are provided within the vending machine 1′—i.e. through the use of removable and substitutable trolleys, product cassettes and product dispensing mechanisms—is both modular and scalable. As such, if it is desirable to add in or remove a particular product line within the vending machine, it is possible to easily to do by removing the appropriate module, and programming the user interface accordingly.

The concept of modularity and scalability can be extended to the vending machine itself, as well as the components within it. The vending machine 1′ of FIG. 2 is approximately 10 feet in height, width and depth. Naturally only a finite number or size of products (and components) can be contained within this space. However, the capacity can be extended by enlarging the vending machine—for example, by providing additional storage and dispensing regions. Such storage and dispensing regions can be linked side-by-side or in a stacked configuration, the latter minimising the footprint of the vending machine. In such a case, two sets of product delivery nets may be provided.

It will be appreciated that in extensions or alternatives other complementary features may be provided. For example, the vending machine may be provided with refrigeration units to cool products. Alternatively, the vending machine may comprise a hot beverage vending system for dispensing beverages such as coffee and tea. Furthermore, the vending machine may comprise a user-operable microwave in which chilled products such as pasties may be heated on-demand by a user after they have been dispensed.

As already discussed with reference to FIG. 1, the general arrangement of the product provisioning system 1 and process 1a is applicable to several different embodiments of the present invention, ranging from a relatively small, self-contained vending machine 1′ described in relation to FIG. 2 to larger embodiments as will now be described.

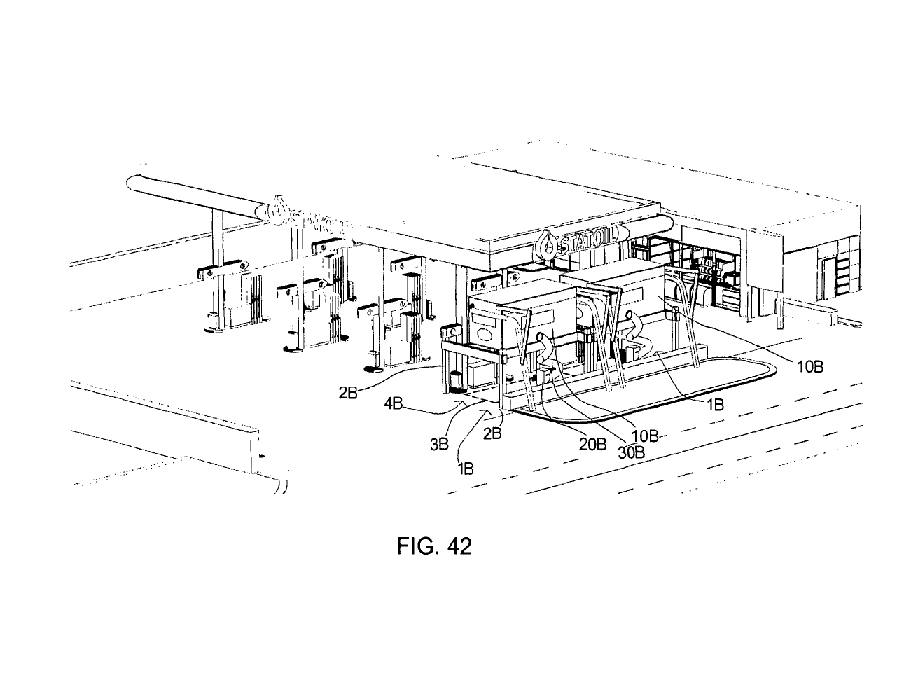

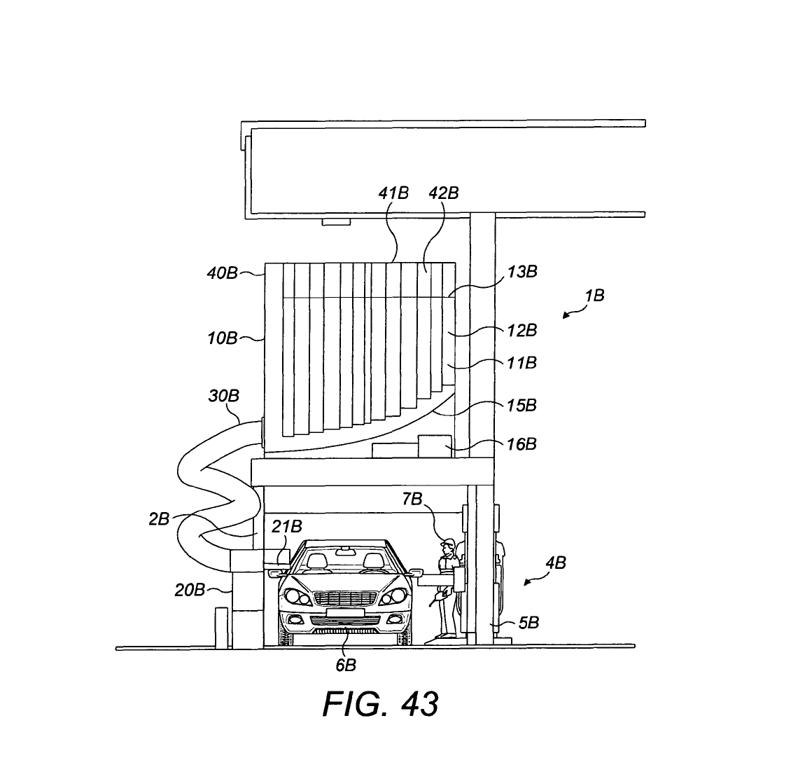

FIG. 42 shows a schematic perspective view of a vehicle service station in which two product provisioning systems 1B according to a second embodiment of the present invention are installed. The product provisioning systems 1B are sized and arranged to be retrofitted to a standard petrol station without significant modification of that petrol station. Furthermore, it will be noted that these retrofitted product provisioning systems do not overly interfere with the operation of, or convenience of access to other standard petrol delivery stations. Accordingly the product provisioning system 1B can be maintained in conjunction with the layout of a standard petrol station. However, as will be described in greater detail below and in keeping with other embodiments, the product provisioning systems 1B provide a faster way in which users can receive discrete products.

Each product provisioning system comprises a storage region 10B in which discrete products are stored. Stilts 2B support the storage region 10B at approximately two metres from the ground above a vehicle bay 3B. As such, the product provisioning system 1B defines a delivery station 4B at which products can be delivered to vehicles and/or users of those vehicles.

FIG. 43, shows a schematic front view of one of the product provisioning systems 1B. The stilts 2B space the storage region 10B at a sufficient height from the ground to permit users and vehicles to safely pass underneath the storage region 10B. As shown, a vehicle 6B and a service attendant 7B are easily accommodated within the delivery station 4B.

The delivery station 4B, comprises a fuel pump 5B as well as a product dispenser 20B. The storage region 10B, which is schematically shown as a cross-sectional view, is connected to the product dispenser 20B via a chute 30B. In use, discrete products are dispensed from the storage region 10B and are delivered via the chute 30B to the product dispenser 20B. In parallel, during ordering and delivery of those products, the service attendant 7B is able to refuel the vehicle 6B. Advantageously, this can significantly improve the speed at which a vehicle 6B can be loaded with fuel and products over a conventional vehicle service station.

The storage region 10B comprises a plurality of product dispensing mechanisms 11B, each defining at least one product channel 12B in which discrete products can be stored and controllably released under control of a respective product dispensing mechanism 11B.

Examples of such product dispensing mechanisms have already been described in relation to the first embodiment, and those are equally applicable to the present embodiment. Moreover, product dispensing mechanisms described in the present embodiment are also compatible with the first and other embodiments.

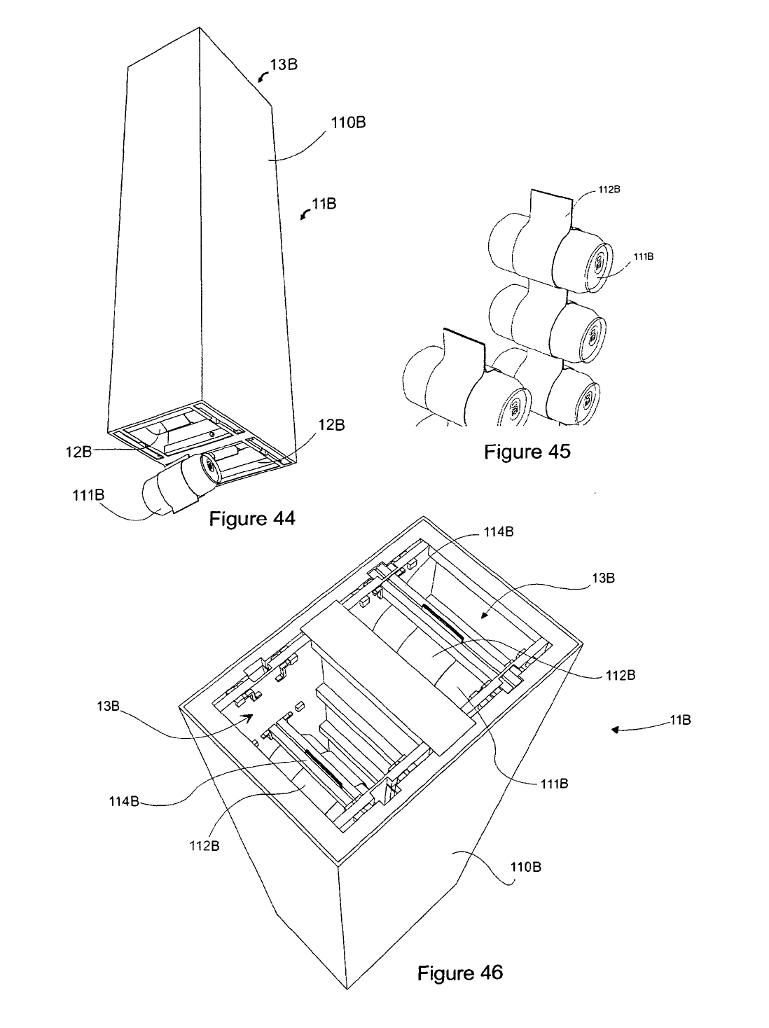

FIG. 44 shows a schematic perspective view of one the product dispensing mechanisms 11B of FIG. 42. The product dispensing mechanism 11B comprises a vertically oriented tube of rectangular cross section 110B defining a pair of product channels 12B. At the top of each product channel 12B is a channel inlet 13B through which products can be introduced into each respective product channel 12B and so into under the control of respective product dispensing mechanism 11B. Products 111B, in the form of beverage cans 111B, are dispensed from underside of this product dispensing mechanism 11B. However, it will be appreciated that other products of different types may be dispensed from other product dispensing mechanisms. Example products types may include soft drinks, energy drinks, sandwiches, confectionary, crisps, snacks, cigarettes, medial products, toiletries, frozen goods such as ice-cream and media products such as DVDs.

FIG. 45 shows how the products 111B are contained within the product channels 12B and under control of a respective dispensing mechanism 11B. In particular, a belt 112B links a stack of products 111B together, and so the belt and attached products can be vertically supported within the product dispensing mechanism 11B.

This is shown in more detail in FIG. 46, in which a perspective view of the top of the dispensing mechanism 11B is shown. A belt 112B supporting a series of products 111B can be accommodated within each product channel 13B. Within each product channel 13B is a carriage, comprising a gripper 114B. The gripper carries the belt 112B and is operable to shift the belt 112B and attached products 111B vertically along the length of the product channel 13B.

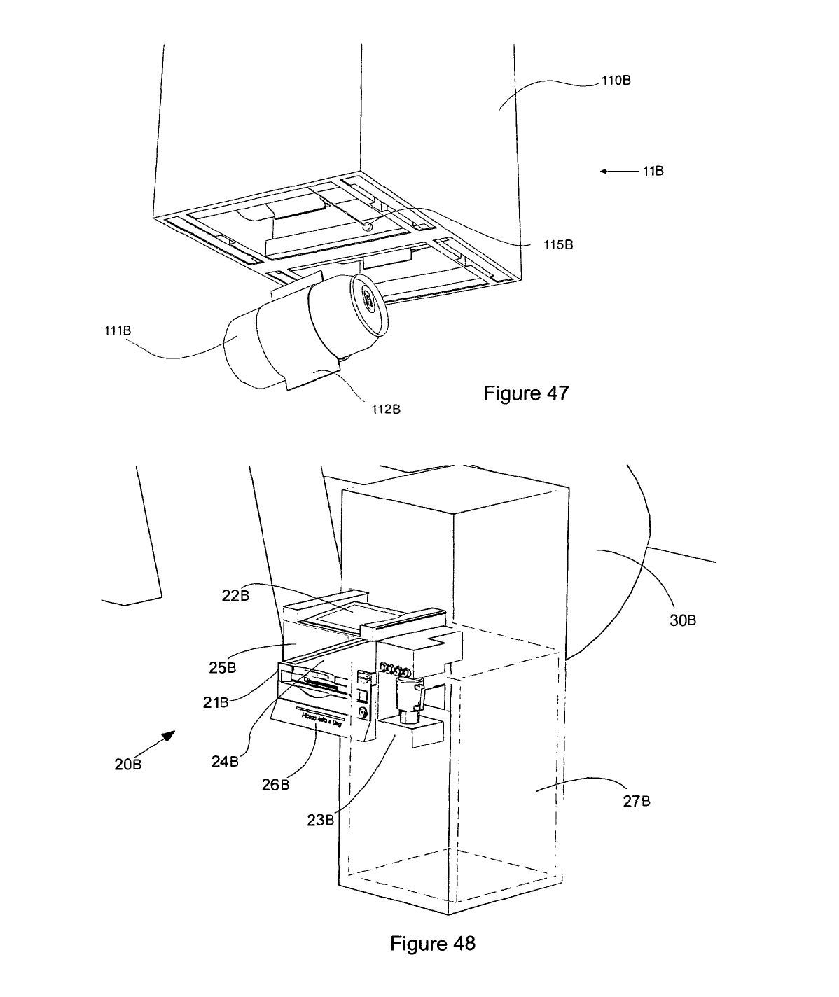

FIG. 47 shows a detailed view of the underside of the product dispensing mechanism 11B. As a belt 112B is shifted vertically downward, a product 111B hangs out of the underside of its respective channel 113B. To dispense that product 111B, a blade 115B cuts through the belt 112B, thereby allowing the product 111B to fall, and so be dispensed from the underside of the product dispensing mechanism 11B. The belt is constructed of a sectile material such as paper that is strong enough to hold a stack of products 111B in a hanging arrangement, but can be easily cut through to dispense a product.

Referring back to FIG. 43, multiple product dispensing mechanisms 11B are contained within the storage region. These may be of the type as shown in FIG. 43, or they may be of a different type such as those described in relation to the first embodiment. However, advantageously, all are substantially vertically-oriented, adjacent to one another and aligned with one another maximising the utilisation of space within the storage region 10B.

The product provisioning system 1B also comprises a product refill module 40B sitting atop the storage region 10B. The product refill module 40B comprises a product buffer 41B divided into a plurality of buffer sections 42B. The product refill module 40B is aligned with the storage region 10B such that each of the buffer sections 42B align with the product channels 12B of the storage region 10B. As will be described in greater detail below, this allows the product refill module 40B to refill the appropriate products within the product channels 11B.

The storage region 10B comprises other hardware 16B, for example a power supply unit for powering the product dispensing mechanisms, refrigeration modules to chill discrete goods, control modules for controlling product dispensing mechanisms and the like.

Some of the product dispensing mechanisms 11B may be arranged to dispense hot food. In particular, products can be dropped from a chilled region into a heating section—for example, a microwave—to cook products for a predetermined period. The cooked product can then be packaged within the product dispensing mechanism 11B for subsequent delivery, as other discrete products would be.

The storage region also comprises a product collector 15B arranged to collect together dispensed products released by the product dispensing mechanisms 11B and guide them under the action of gravity towards the chute 30B.

The product collector 15B comprises a net fitted with rotatable balls and rollers similar to that described in relation to the first embodiment. The net cushions the impact of products being dispensed from the product dispensing mechanisms 11B, and the rollers reduce the friction between the products and the product collector 15B. Dispensed products can therefore flow freely from the product collector 15B, down the chute 30B and into the product dispenser 20B.

The product dispenser comprises an arm 21B that is extendible towards an open window of the vehicle 6B. Products can therefore be delivered within reach of a product-ordering user—without the user needing the leave the vehicle 6B.

Referring to FIG. 48, a perspective view of the dispenser 20B is shown. The dispenser 20B comprises a product-ordering interface 22B. In particular, the product-ordering interface 22B comprises an electronic menu system in the form of a touch-screen computing device 22B. The product dispenser 20B further comprises a beverage dispenser 23B, product delivery tray 24B, a window 25B, a plastic bag dispenser 26B and a product rejection bin 27B.

When a vehicle 6B parks alongside the delivery station 20B, the arm 21B automatically extends toward the window of the vehicle 6B, thereby easing a users reach of the components supported by the arm 21B (including the product-ordering interface 22B, beverage dispenser 23B, product delivery tray 24B, window 25B and plastic bag dispenser 26B).

A user can take hold of the touch-screen computing device 22B from the supporting arm 21B into the vehicle, and use it to make product selections. The touch-screen computing device 22B is tethered to the product dispenser 20B via a power and data cable. As well as providing power and data, the cable also prevents the removal of the touch-screen computing device 22B from the product dispenser 20B.

The touch-screen computing device 22B presents a list of orderable products to the user and can guide the user through the product selection process. By way of example, a user may be prompted by the touch-screen computing device to select the quantity of fuel with which to refill the vehicle 6B. This can be communicated electronically to the service attendant 7B, who can then refill the vehicle 6B whilst the user is guided through the rest of the ordering process. In particular, once fuel has been ordered, the user may be prompted to order a beverage from the beverage dispenser 23B and/or continue with ordering discrete products.

Once a user has selected discrete products, the product selections are communicated to the product dispensing mechanisms 11B within the storage region 10B. The appropriate product dispensing mechanisms 11B are operated to release the ordered quantity and brand of products. These are dispensed onto the product collector 15B and slide down the chute 30B and into the product delivery tray 24B.

The user is able to view the ordered products via the window 25B before the user is obliged to pay for those ordered products. The touch-screen computing device 22B is arranged to prompt the user to either pay for the goods on display, or reject the products. If the user chooses to reject the products, then the product delivery tray 24B can actuate to tip the products into the rejection bin 27B contained within the product dispenser 20B.

If the user would like to buy the products then payment is possible via the touch-screen computing device 22B. In particular, the touch-screen computing device 22B comprises a payment card reader into which a user may insert a payment card—such as a credit card, and undergo a payment authentication process. At the same time, payment can be made for the fuel being dispensed (or having been dispensed) to the vehicle 6B.

After the payment authentication process is complete, and the ordered products have been paid for, the product dispenser 20B actuates the window 25B to allow the products on the product delivery tray 24B to be retrieved by the user. If many products have been ordered, a user may choose to make use of a plastic bag, as available via the plastic bag dispenser 26B.

After the vehicle 6B has been refuelled, and the user has collected the ordered and paid for products, the vehicle can be driven away to free the delivery station 4B for another vehicle.

To maximise the effectiveness of the product provisioning system as provided in the present context of a product provisioning system 1B provided within a service station, certain measures can be implemented. Firstly, in the early implementation of the present product provisioning system 1B, users may need to be educated and encouraged to use the product provisioning system 1B. In particular, users may not know about the benefits associated with using the product provisioning system 1B. Accordingly, as users drive their vehicles into the service station, they may be presented with a sign to indicate that the route towards the product provisioning system 1B is a ‘fast lane’ as opposed to a ‘normal service’—see, for example, FIG. 54.

Furthermore, as users become familiar with the product provisioning system 1B—either by using it, or by observing other users using it from a ‘standard’ service fuel station bay, certain advantages and features will become apparent to them. Firstly, the fast lane ‘pit stop’ service is intended to provide a full fuel tank fill up service—and may have a minimum spend associated with it. This helps pay for the service attendant who fills the petrol tank, thereby obviating the need for the user to leave their vehicle. Furthermore, this is a better use of the time for which a vehicle is occupying a ‘pit stop’ delivery bay as it allows parallel processing of the ordering and delivery of products whilst the vehicle is being refuelled. Secondly, payment is intended to be by payment card only—no cash. This reduces the burden of cash handling, speeds up processing, and improves the security associated with the product provisioning system 1B. Thirdly, the portable electronic computing device 22B that is used to order products can be taken into the comfort of the users vehicle, and so users do not need get out or lean out of the vehicle to make orders. As a further incentive to users to use the system, a beverage, such as coffee may be dispensed ‘free of charge’ from the beverage dispenser 23B. Also, an introduction period may be in effect allowing users to claim a certain number of free products, assuming they are new users to the system.

As will be appreciated, as the product provisioning system 1B is used to dispense products, the products within the storage region 10B will be depleted. In view of this, it is necessary to restock the storage region 10B. As mentioned above, the product refill module 40B is able to refill the appropriate products within the product channels 11B of the storage region 10B as will now be described.

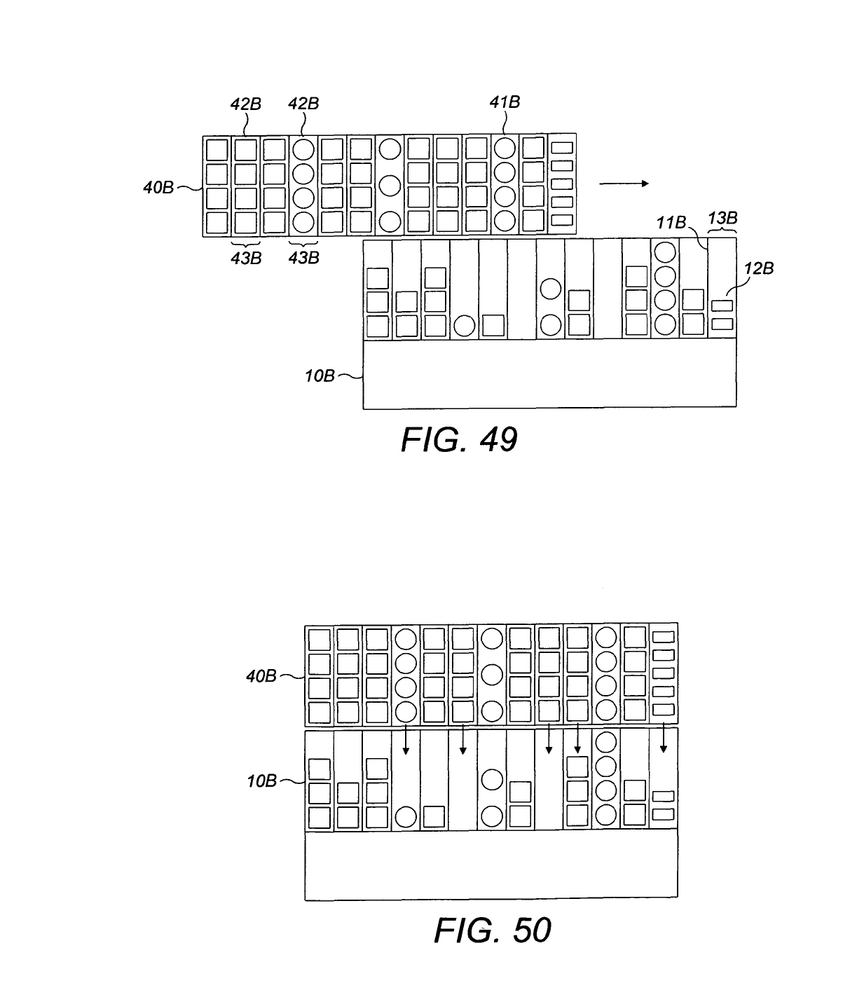

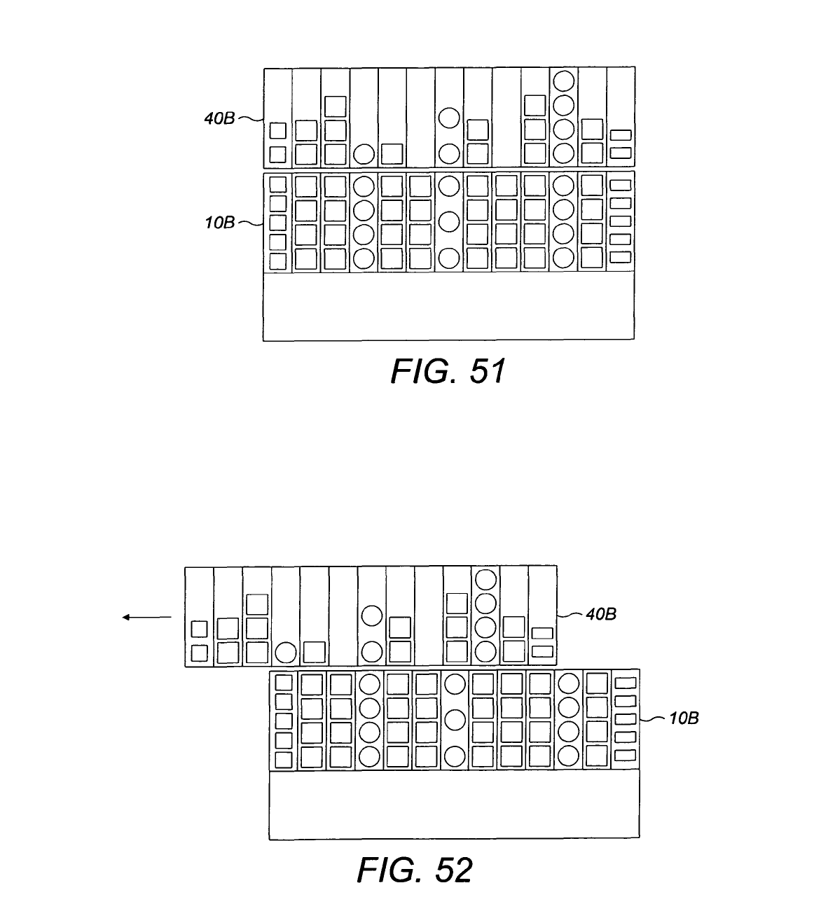

FIGS. 49 to 52 show schematic cross-sectional views of a sequence in which a product refill module 40B is actioned to restock the storage region 10B. In particular, FIG. 48 shows a fully-stocked product refill module 40B separate from, and out of alignment with a depleted storage region 10B. FIG. 50 shows the product refill module 40B in alignment with the storage region 10B, and prior to dispensing products thereto. FIG. 51 shows the product refill module 40B in alignment with the storage region 10B, and after dispensing products thereto, the storage region 10B being fully restocked. FIG. 52 shows the product refill module 40B having served to replenished the storage region 10B being moved out of alignment with the storage region 10B. Another fully-stocked product refill module 40B can then be brought into alignment with the storage module 10B, ready to replenish the products lines within the storage region 10B.

Referring back to FIG. 49 the product refill module 40B is located above and separated from the storage region 10B. The product buffer 41B of the product refill module 40B is fully stocked with products. Each buffer section 42B comprises a plurality of outlets 43B which have release mechanisms that remain closed to prevent the products contained in each section from falling out of the product refill module 40B unintentionally.

Referring to FIG. 50, it can be seen that the buffer sections 42B align with corresponding product channels 12B of the storage region 10B. In particular, the outlets 43B of the product refill module 40B face respective channel inlets 13B of the storage region 10B.

Referring to FIG. 51, the outlets 43B at the bottom end of the product refill module 40B are opened, allowing the products to fall out under the action of gravity. Thus, products can be transferred from the product buffer 41B of the product refill module 40B into respective product channels 11B within the storage region 10B.

It will be appreciated that each of the product channels 11B is dedicated to a single brand or type of product. Thus different product channels 11B hold heterogeneous discrete products. As such, the product buffer 41B has products arranged within its buffer sections 42B so as to restock the product channels 11B with the correct product lines.

Each buffer section 42B is independently operable to allow products of the same type to be individually transferred into the storage region 10B. Advantageously, this allows product channels 11B to be restocked independently. It will be appreciated that certain products may be more popular than others. As such, some product channels 11B may be more depleted of products than others. Thus the independent operation of each buffer section 42B of the product refill module 40B provides a convenient way in which depleted product lines can be restocked to the same level as less popular items.

Movement of the product refill module 40B into alignment with the storage region 10B can be achieved in a number of different ways.

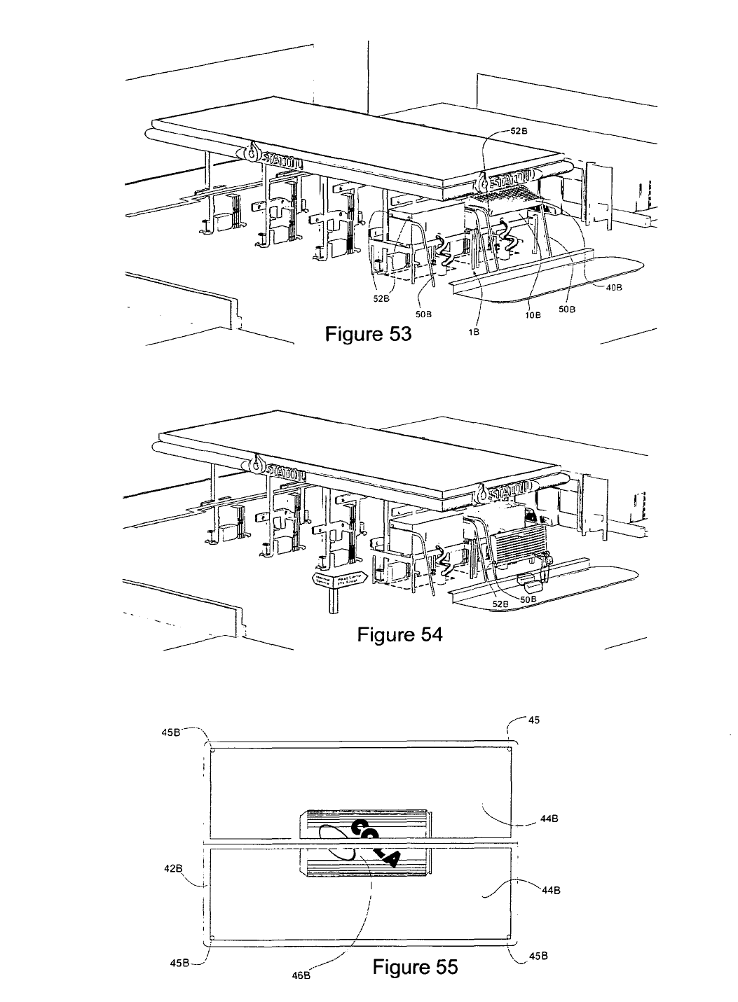

Referring to FIGS. 53 and 54, the product provisioning systems 1B of FIG. 42 can be reconfigured so that the product refill module 40B is made accessible to restocking staff. In particular, the product refill module 40B can be separated from the storage region 10B to bring the product refill module 40B closer to ground level to allow manual restocking of the product refill module 40B.

To this end, each product provisioning system 1B comprises guides 50B along which the appropriate product refill module 40B is slidable by virtue of rollers 52B. A product refill module 40B can thus be moved between a first position, as shown in FIG. 42 in which the product refill module 40B is engaged with the storage region 10B, via an intermediate position—as shown in FIG. 53, to a second position, as shown in FIG. 54 in which the product refill module 40B is separated from the storage region 10B. The second position is a lowered position at which the product refill module 40B is easily accessible to restocking staff.

The guides substantially support the weight of the product refill module, as well as any products contained within the product refill module. Furthermore, the product refill module 40B is counterweighted to facilitate manual handling of the product refill module 40B between the first and second positions, and reduce the chance of injury to restocking staff.

Once at the lowered position, as shown in FIG. 54, restocking staff can thus easily load the upper end of each buffer section 42B of the product refill module 40B with an appropriate product. To this end, the product refill module 40B, at its upper end is provided with indicia 46B to guide correct manual restocking of the product refill module 40B.

Referring to FIG. 55, the upper end of an individual buffer section 42B is shown. The upper end of the buffer section 42B defines an opening in which is provided a pair of flaps 44B. An image of a product 46B is printed across the pair of flaps 44B. Each flap 44B comprises a hinge 45B that biases the flap to close the opening of the buffer section 42B. However, each flap 44B opens as a product is pushed into the buffer section 42B.

Thus, indicia 46B, in the form of images of a product can indicate to restocking staff where specific products are to be inserted. Advantageously, this can improve the speed of restocking, as there can be very little confusion as to where a product is to be loaded.

It will be appreciated that there may be a number of different ways in which the product provisioning system 1B can be restocked with products. For example, instead of rollers, a hinging mechanism can be utilised to lower the product refill module 40B relative to the storage region 10B to allow for manual restocking of products. In a further alternative, the product provisioning system 1B may be provided with an access means, such as a ladder, to allow restocking staff to refill the storage region 10B. In such an arrangement, the storage region 10B may comprise a carriage to safely carry the restocking staff along with the products to be inserted into the storage region 10B. In further alternatives, restocking of the products may be carried out automatically. Rather than the product refill module 40B being restocked manually, a depleted product refill module 40B can be replaced in its entirety by another product refill module 40B that is fully stocked. Advantageously, this permits can quickly replenish multiple product lines in parallel.

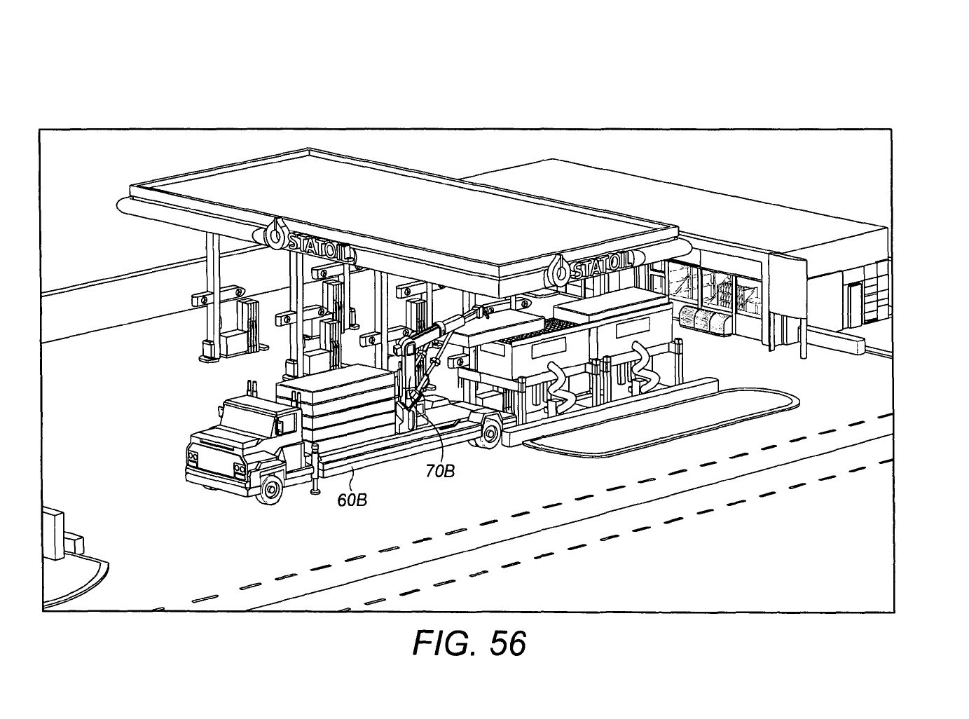

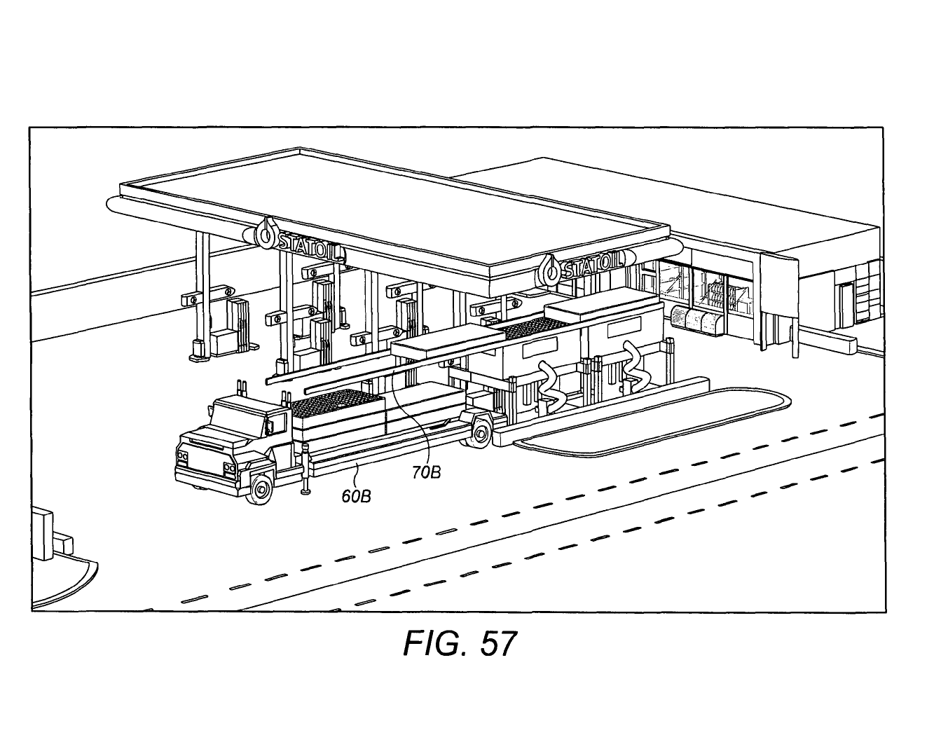

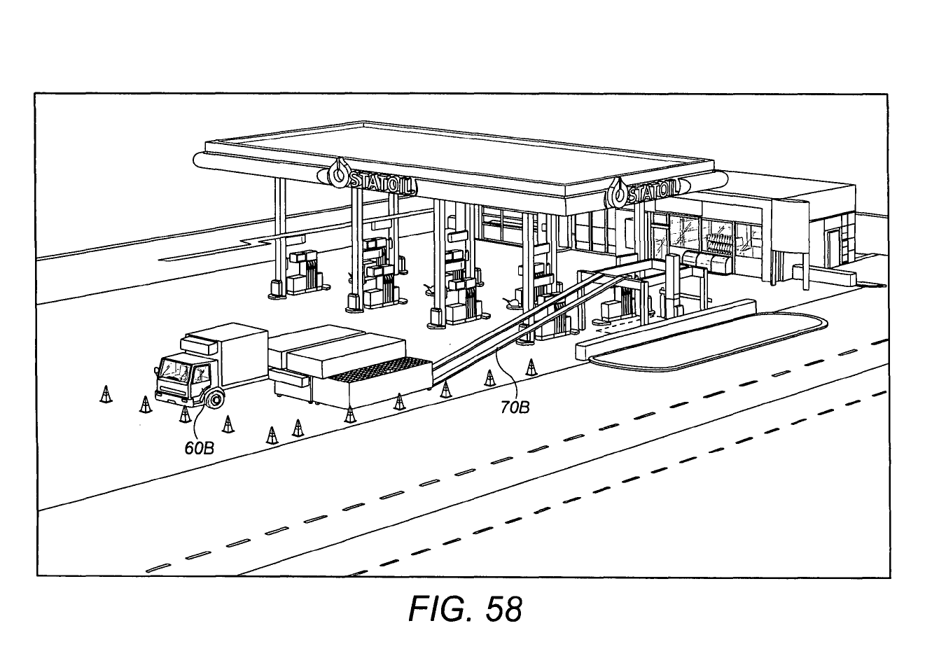

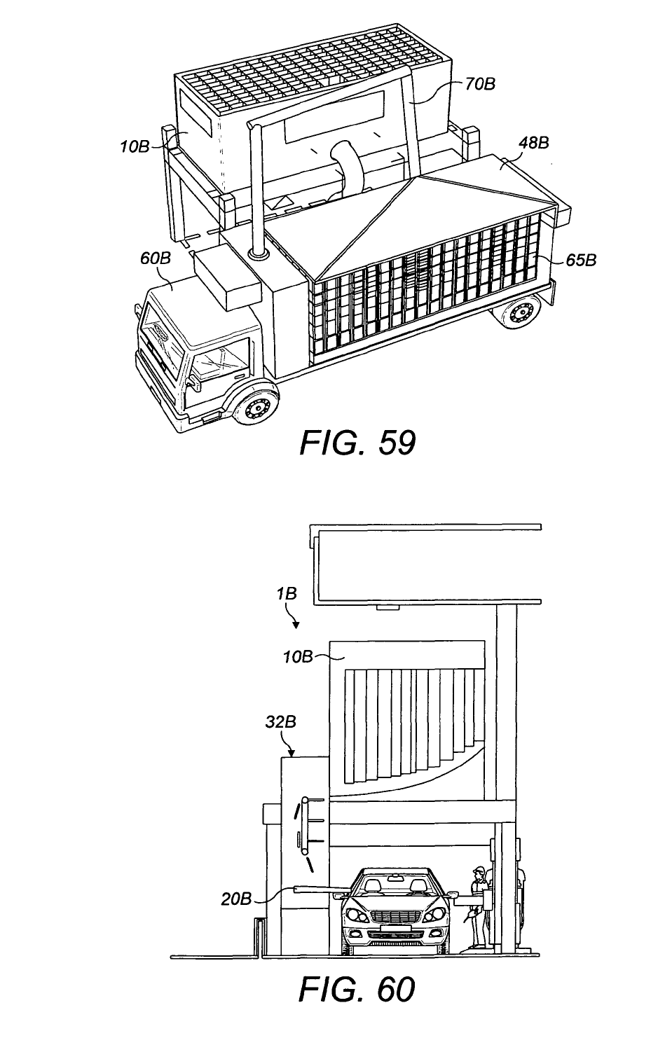

FIGS. 56 to 59 illustrate examples of automated product refill. In these examples, a depleted product refill module 40B of the product provisioning systems 1B is automatically restocked or otherwise substituted for a replenished product refill module. In each case, a truck 60B for transporting fully-stocked product refill modules 40B is provided with a loading system 70B. In FIGS. 56 and 59, this loading system is in the form of a crane arm 70B that is able to unload depleted product refill modules 40B, and replace the depleted product refill modules with fully-stocked product refill modules 40B. In FIG. 57 the loading system 70B comprises transfer rails 70B for sliding product refill modules 40B between the storage region 10B and the truck 60B. To aid sliding movement, the underside of the product refill modules 40B may be provided with rollers. In FIG. 58, the loading system 70B comprises ramps facilitating the removal of both the product refill module 40B and the storage region 10B. This allows for the substitution of the product refill modules 40B to occur at ground level.

Referring in more detail to FIG. 59, a depleted product refill module 40B can be removed from the storage region 10B through the use of a crane arm 70B mounted on a transport truck 60B. The depleted product refill module 40B can then be aligned with and mounted to a product restocking system 65B mounted on a carriage of the truck 60B. Once fitted, products can be driven up into the depleted product refill module 40B—thereby replenishing it. Thus, the replenished product refill module 40B can be returned via the crane arm 70B to its original position on the storage region 10B to restock the product lines therein. This process may be repeated several times if necessary. This parallel replenishing of the product channels is achieved using similar principles as set out in FIGS. 49 to 52.

It will be appreciated that clearance above the product provisioning system 1B is required for the crane arm to operate. Thus, the product provisioning system 1B may be situated outdoors rather than under the roof of a traditional petrol station—as shown in FIG. 42. Accordingly, a covering 48B is provided to protect the top of the product refill module 40B from the elements. Such a covering 48B can also prevent authorised access into the product refill module 40B. The covering 48B may be a retractable roof, and may comprise water drainage means to channel water away from the covering 48B.

It will be appreciated that the product provisioning system 1B may have alternative configurations or structures borrowed from other embodiments. For example, with reference to FIG. 60, instead of a chute, a vertical conveyor system 32B may be provided instead to route products from the storage region 10B to the product dispenser 20B. It will be noted that this vertical conveyor system is similar to the principles of operation of the dispensing mechanism 140 described above in relation to FIGS. 22 and 23.

Furthermore, other modifications may be made to the product provisioning system 1B affecting the routing of products.

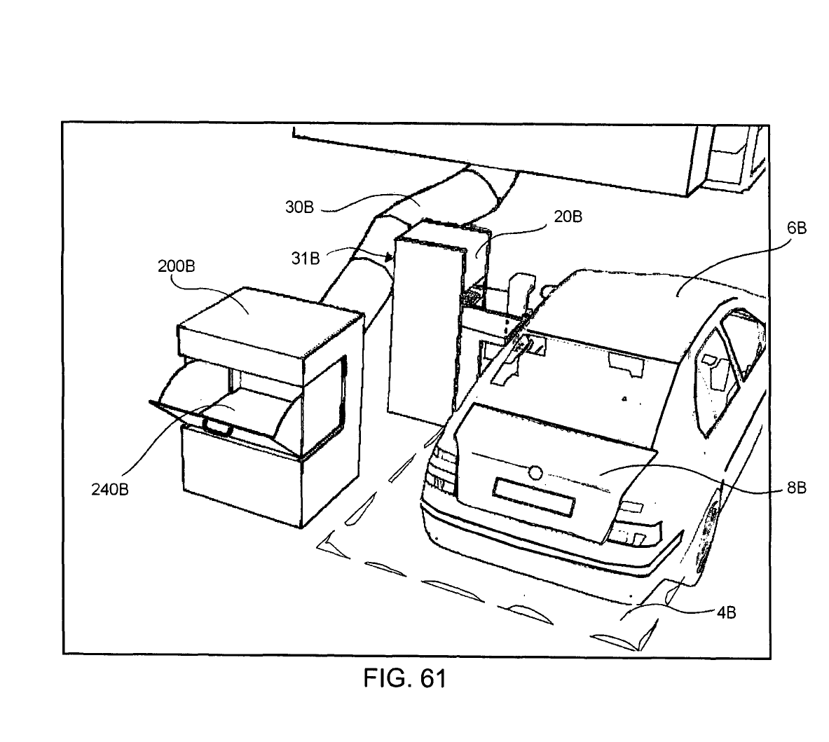

FIGS. 61 to 63 show perspective schematic views of an alternative product provisioning system to that shown in FIG. 42, comprising a product chute of an alternative configuration. In particular, the chute 30B is connected to both the product dispenser 20B situated relative to the delivery station alongside the driver's window, and also a supplementary product dispenser 200B situated relative to the delivery station 4B adjacent to the boot 8B of the vehicle 6B.

The supplementary product dispenser 200B comprises a product delivery tray 240B, and is intended to be the target for products dispensed by the product dispensing mechanisms 11B within the storage region 10B that cannot be accommodated by the product dispenser 20B.

In this alternative configuration, the chute 30B is bifurcated, terminating in two lower ends, one of which is connected to the product dispenser 20B, and the other being connected to the supplementary product dispenser 200B.

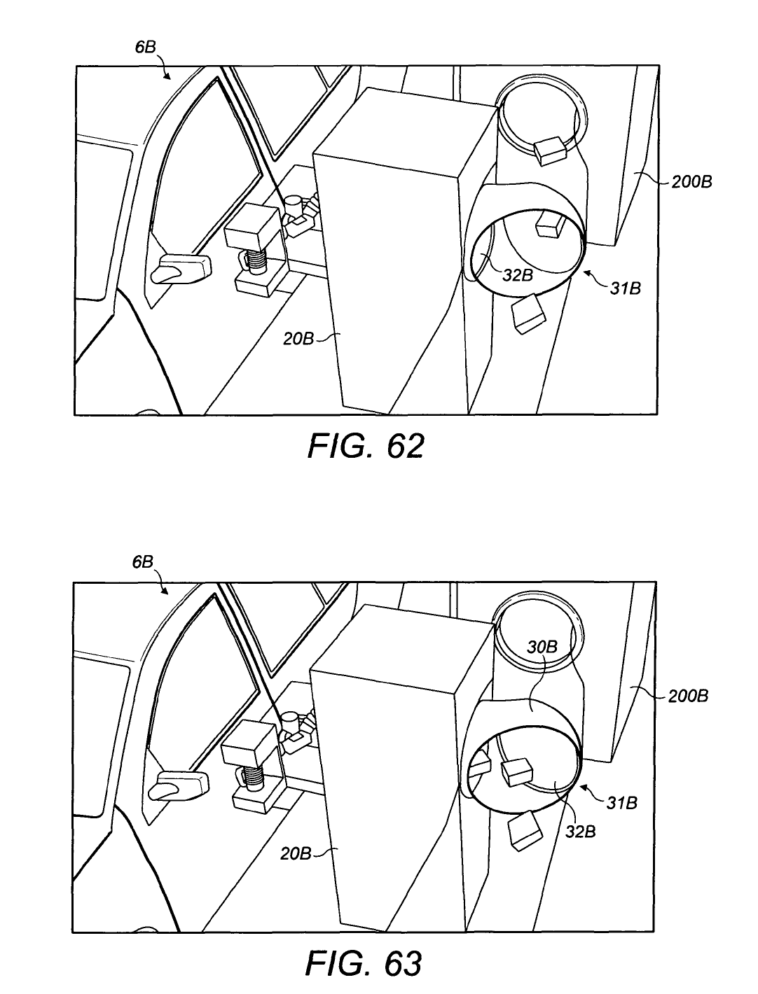

Referring to FIGS. 62 and 63, a chute flap 32B is disposed at the chute bifurcation 31B. The chute flap 32B is hinged and operable to divert products either into the product dispenser 20B or into the supplementary product dispenser 200B.

FIG. 62 shows the chute flap 32B hinged to close access to the product dispenser 20B, thus opening a route within the chute 30B to the supplementary product dispenser 200B. FIG. 63 shows the chute flap 32B hinged to close access to the supplementary product dispenser 200B, thus opening a route within the chute to the product dispenser 20B.

The hinged chute flap 32B is actuated under the control of the product provisioning system 1B, and in response to the number of and type of ordered products. Specifically, if a user orders products the number or quantity of which cannot be accommodated by the product dispenser 20B, then these products can be diverted to the supplementary product dispenser 200B instead. The products are accessible via the product delivery tray 240B which is unlocked after purchase of the products. After the product delivery tray 240B is open, a user, or a service attendant 7B is able to conveniently open the boot 8B of the vehicle 6B, situated adjacent to the supplementary product dispenser 200B and easily transfer the ordered and paid-for items across into the boot 8B of the vehicle 6B.

Further modifications to the product provisioning system 1B will be apparent to a person skilled in the art.

Furthermore, the product provisioning system 1B may be useful in scenarios other than the dispensing of products within vehicle service stations.

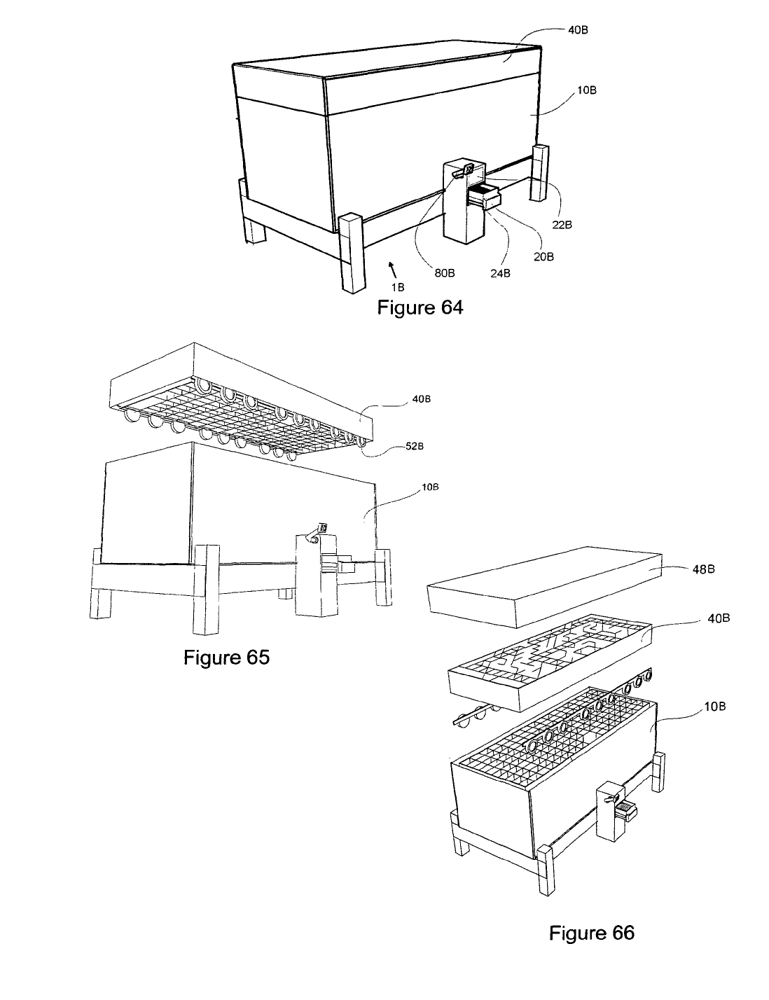

FIG. 64 shows a perspective view of a similar product provisioning system 1B applied to a different scenario. Again, this product provisioning system 1B comprises a storage region 10B and a product refill module 40B. However, in the present scenario, the product provisioning system 1B is stocked to dispense discrete products in the form of medicines and/or other emergency aid products. Thus, the product provisioning system 1B can be provided for use in the fair rationing of products to users in emergency conditions (for example, suffering from an epidemic, famine or other such emergency conditions).

The product provisioning system 1B comprises a delivery station including a user interface comprising a display screen 22B and an also an authentication device in the form of an iris scanner 80B. The product provisioning system 1B also comprises a product dispenser 20B comprising a product delivery tray 24B. These components are used to address the important consideration of fair rationing of aid packages, and the delivery of medicines to the correct users.

A user is guided by the display screen 22B to position their eye relative to the iris scanner 80B. In particular, guiding instructions or information may be provided by the display screen 22B in a set of different languages—and can also be provided pictorially.

The iris scanner 80B then scans a user's eye and determines a unique identity for the user. The determined unique identity of the user is used to query a database. The database can be used to determine whether that user is registered on the system, and to which products the user is entitled. Typically, an authority like a doctor or a clinician will have registered a user onto the system, along with the products the user is entitled to receive.

If an unregistered user attempts to access the product provisioning system 1B, the user can be instructed to register. In addition, the product provisioning system 1B may issue a basic aid package, for example including food and water.

If a registered user is attempting to access repeat prescriptions of a medicine too early, then these medicines will not be dispensed. Instead, the user-interface may provide the user with a message to signify that the user has attempted to access the medicines too early, and may also provide information about when the user should next return to access medicines.

Assuming that a user is registered with the system, and is due to receive medicines or other products, these can then be dispensed in the manner described in relation to the first embodiment to the product delivery tray 24B of the product dispenser 20B. The users can thus retrieve the products to which they are entitled, freeing the delivery station 4B for another user.

Thus, this arrangement unambiguously authenticates the identity of a user to ensure that users cannot take more than their fair share of aid packages. Furthermore, it correctly identifies users, so that the correct products can be dispensed—especially important if those products are medicines. If medicines are incorrectly dispensed, then this could have disastrous implications for the recipients of that medicine. Even if the recipient of a medicine realises that an incorrect medicine has been dispensed, then this still presents a problem of depleting the stock of medicines that can otherwise go towards helping others.

It is envisaged that the product provisioning system 1B in the present example, would be used in a scenario where users requiring medicines would pre-register themselves with the system—for example, via a doctor or clinic. At this stage, the doctor or clinician—or other authority—could specify a number of different parameters to the product provisioning system 1B. For example, the identity of the user could be associated with the type of medicine required for that user and/or dependent users. The language that the user understands may be recorded by the system. Furthermore, data relating to repeat prescriptions can be entered into the system. Also at this pre-registration stage, data associated with uniquely identifying a user can be received. For example, the user's eyes can be scanned with an iris scanner 80B for the purposes of registering that user onto the system.

Once a user has been registered with the system, the user does not necessarily need to consult the doctor for prescriptions. The user simply needs to approach the product provisioning system 1B, provide the system with information relating to user's identity—and receive the appropriate products and repeat prescriptions.

Referring to FIGS. 65 and 66, an exploded perspective view of the product provisioning system 1B is shown. As can be seen, the product refill module 40B may comprise rollers 52B to aid product refill. Furthermore, a covering 48B is provided to cover the top of the product refill module 40B to prevent authorised access therein, and also to protect the top of the product refill module 40B from the elements.

Thus it can be seen that the second embodiment of the product provisioning system 1B and its alternatives comprise features set out in the overview relating to FIG. 1. Specifically, the product ordering interface 22B of the second embodiment corresponds to the product ordering interface 2 of FIG. 1, hardware 16B corresponds to control system 3, dispensing mechanisms 11B correspond to dispensing mechanisms 4 of FIG. 1, product collector 15B corresponds to product collector 5 of FIG. 1, chute 30B corresponds to product router 6 of FIG. 1 and touch-screen computing device 22B comprising a payment card reader or iris scanner 80B corresponds to the release authorisation controller 7.

The product provisioning systems so far described may, as demonstrated, vary in terms of both size and applicability to various product dispensing scenarios. Nonetheless, the product provisioning systems and methods according to embodiments of the present invention are primarily envisaged for use at a vehicle service station. Moreover, they are intended to address the shortcomings of prior known service station arrangements for delivering products quickly and efficiently thereby maximising vehicle flow through the service station.

For example, users within a service station shop can spend a long time looking for the items that they might want to purchase. Once found, the amount of items that can be purchased is limited by how much a user is able to carry to their vehicle. If a large number of items are required, or if bulky items are desired, then a user may need to make several trips between their vehicle and the shopping area. As will be appreciated, shopping trolleys are not desirable within a vehicle service station as these can be very space inefficient, and also present a damage hazard to vehicles, especially on a crowded forecourt. Once at the checkout, service station staff may need to spend a significant amount of time registering the items via a manual product scanner, and bagging the purchased items. If a user wants to purchase hot food, this must be prepared and heated. Each of these steps take time that add up and so further exacerbates the problem associated with vehicle of that user occupying space within the service station. The shopping area of the traditional service station can suffer from other problems such as shrinkage of products. This may be as a result of the products being out-of-date, being incorrectly handled or stored (e.g. kept at an unsuitable temperature) and/or may be easily stolen by users or staff of the service station. Out-of-date items need to be disposed of, and new items need to be stacked and displayed. Such product handling issues are particularly an issue in a traditional service station environment which are usually not well staffed and only provide a shopping area as an ancillary function to the primary purpose of selling fuel.

These issues are addressed, at least in part by the above mentioned embodiments of the product provisioning system. However, to further address such issues, it is preferable that the product provisioning system is integrated into the underlying design of the service station. Such an integrated product provisioning system according to a third embodiment of the present invention will now be described. As ever, features of different embodiments—such as product dispensing mechanisms—may be substituted or combined where possible.

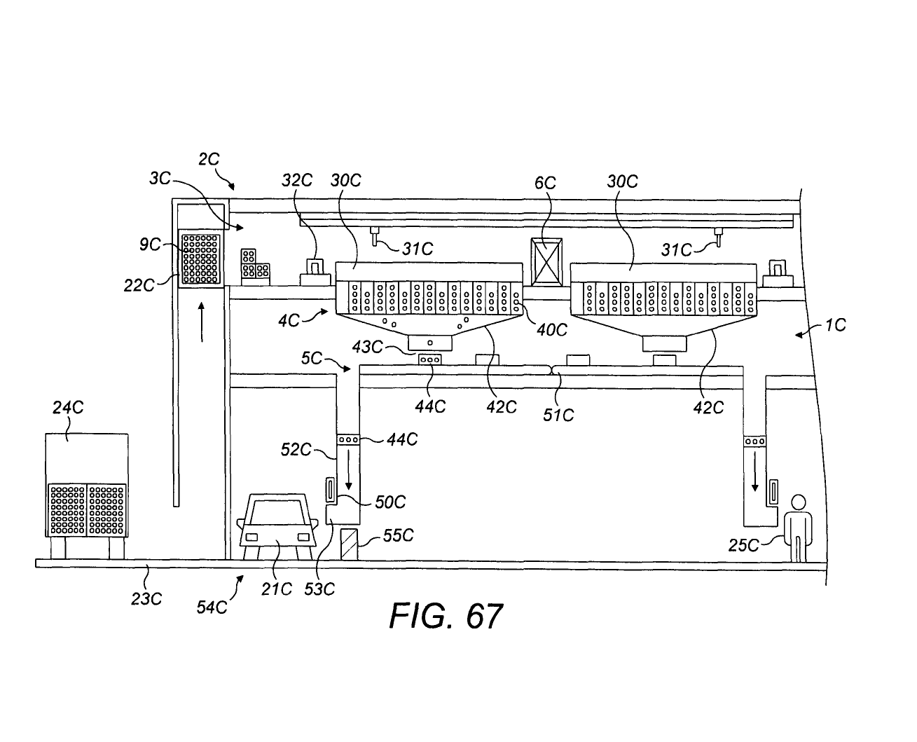

FIG. 67 shows a schematic overview of a multi-storey vehicle service station 2C comprising a product provisioning system 1C according to a third embodiment of the present invention. The product provisioning system 1C has features similar to previous embodiments described, but rather than being a self-contained unit that can be retro-fitted to the forecourt of a vehicle service station, the present product provisioning system 1C is integrated with the vehicle service station 2C.

The product provisioning system 1C comprises three sub-systems, namely a semi-automated refilling system 3C an automated product picking system 4C and an automated product routing and delivery system 5C. Notably, the product picking system 4C comprises a plurality of product dispensing mechanism 40C similar to those described in previous embodiments. A control system 6C of the product provisioning system 1C is connected to each of the sub-systems and is operable to control them and their sub-components.

As shown, these sub-systems span multiple floors and operate in a manner to effect vertical delivery of ordered products 9C to vehicles 21C and users 25C at various delivery stations 54C within the service station ground-floor forecourt below. In particular, the semi-automated refilling system 3C is provided on the second floor of the multi-level service station 2C. Pallets of goods 9C are unloaded at the ground floor from a lorry 24C to a loading bay 23C and then transported up to the second storey by means of a service lift 22C. At the second storey, the goods 9C are unpacked from their pallets and distributed to a plurality of stacking stations 30C. Specifically, products are placed into an appropriate vertically-oriented dispensing channel of an appropriate stacking stations 30C. The channels of stacking stations 30C align with the vertically-oriented channels of product dispensing mechanisms 40C below. The control system 6C controls product stacking systems 31C to ensure that the correct products are placed in the correct stacks and that products do not get damaged during the refilling of each vertical stack.

It will be understood that in alternative arrangements of the service station 2C, multi-function lifts may be provided at one or more of the delivery stations 54C. These multi-function lifts can not only allow goods to be delivered to restock the service station as described, but also provide a convenient way of delivering bulky items to vehicles 21C that cannot be transported via normal delivery channels.

The automated product picking system 4C is provided adjacent and beneath the semi-automated refilling system 3C. Each product dispensing mechanism 40C of the product picking system 4C is controlled by the control system 6C to enable selective release of products from different stacks. Typically, product release from a given product dispensing channel is one product at a time to avoid the potential for product damage. However, as before, the control system 6C can control multiple product dispensing mechanisms 40C to dispense in parallel to thereby dispense products simultaneously.

As before, a user interacts with a product ordering interface 50C to compose a product order and gain authorisation to fulfil that product order. From this product order, the control system 6C determines which products are to be dispensed to fulfil that order, and so determines how to control the appropriate product dispensing mechanisms 40C independently and in parallel to release those products from the relevant stack.

The released products 9C selected as part of a goods order are collected in one of a plurality of collection funnels 42C located beneath the dispensing mechanisms 40C and distributed via a respective outlet 43C of a collection funnel 42C to a smart box 44C positioned below the outlet 43C.

The automated product routing and delivery system 5C comprises smart box conveyor belts 51C on which smart boxes 44C are loaded. The control system 6C interfaces with the automated product routing and delivery system 5C to operate the conveyor belts 51C to position a smart box corresponding with an order directly below the outlet 43C of a collection funnel 42C such that products dispensed in parallel pertaining to that order are collected into that box. As there are multiple collection funnels 42C, then the conveyor belts 51C may be operated to route a smart box 44C to receive dispensed products from more than one collection funnel 42C, depending on which goods are required to fulfil an order. Smart boxes 44C are then routed by the automated product routing and delivery system 5C to the correct delivery location. For example, the routing may be achieved via extendible deflector arms that divert smart boxes 44C to the appropriate delivery location.

With the product provisioning systems described in relation to previous embodiments, product routing is relatively straightforward in that each product delivery location is served by a dedicated product store. Thus, routing merely concerns how best to transport the ordered products to the product delivery location. By contrast, in the present embodiment, multiple delivery locations are served by a common product picking system 4C. Therefore, it is important for the automated product routing and delivery system 5C to control the position of each smart box 44C to ensure that the correct smart box is routed to its intended recipient.

In the schematic view shown in FIG. 67, the conveyor belts 51C are shown to route smart boxes 44C directly to one of two shown product delivery channels 52C. However, it should be noted that more than two product delivery channels 52 are provided and also other intermediate components are present to route the smart boxes 44C on their way to the product delivery channels 52C as will be described in further detail below. Nonetheless, once a smart box 44C has been correctly routed to a delivery channel 52C, the smart box is lowered to a product dispenser 53C at the delivery station 54C, at the location from which the order was originally placed via the product ordering interface 50C.

Ordered products may then taken be taken from the smart box 44C by the ordering user (e.g. driver) and the order is thus completed. The empty smart box 44C can then be returned ready for use again. Advantageously, the vehicle 21C can be serviced over the same period over which product ordering, dispensing and delivery occurs. For example, fuel pumps 55C located at the delivery station 54C allow the vehicle to be refuelled. Thus, products can be delivered and the vehicle can be serviced far more quickly than is possible with presently known service station layouts.

Having described the overall operation of the provisioning system 1C, each one of the sub-systems is now described in greater detail starting with the semi-automated refilling system 3C.

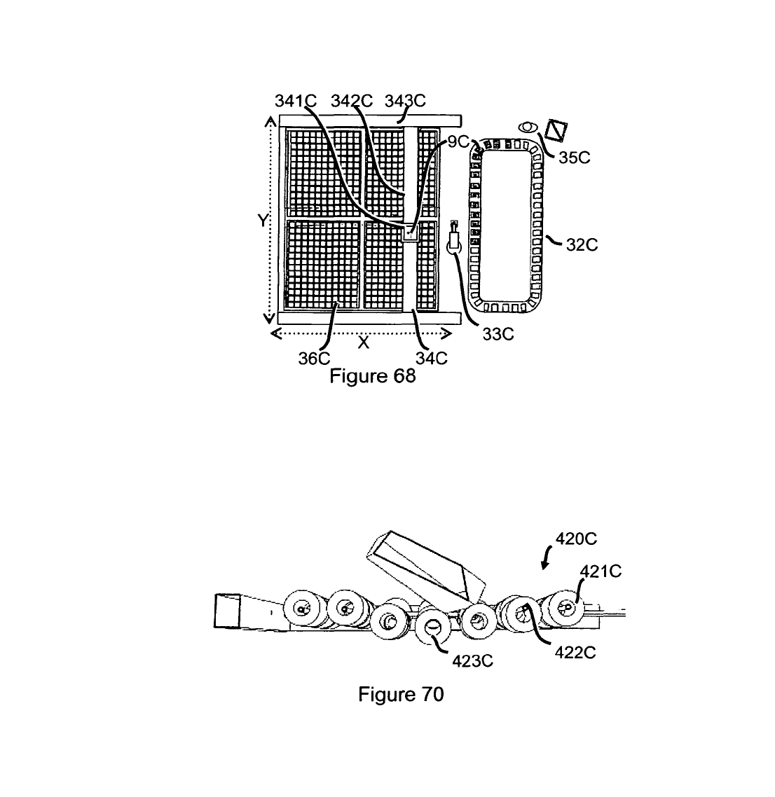

FIG. 68 shows a schematic overhead view of part of the semi-automated refilling system 3C. As mentioned, each stacking station 30C comprises a plurality of vertically-oriented dispensing channels 36C the openings of each of which are shown as a grid in FIG. 68. Directly below the stacks defined by the dispensing channels 36C are the channels of product dispensing mechanisms 40C.

As already described, pallets of goods are delivered to the second floor so that the product provisioning system 10 may be stocked via the semi-automated refilling system 30. The filling system 3C is semi-automated as it uses a combination of manual labour and automatic product stacking systems 31C. Restocking staff 35C unpacks pallets of goods and places individual items on restocking conveyors 32C manually. Once on the restocking conveyors 32C, the automatic product restacking systems 31C take over. Advantageously, this arrangement is flexible and can permit products that are popular to be restocked as a matter of priority.

The product restacking systems 31C comprises a robotic arm 33C and an X-Y placement mechanism 34C and is fed from the restocking conveyors 32C which functionally define a refill buffer.

Briefly, the robotic arm 33C takes unpacked products 9C from the refill buffer and carries it to the X-Y placement mechanism 34C. The robotic arm 33C is arranged to recognise the type of product 9C and thereafter instructs the X-Y placement mechanism 34C to place the item into the stack within the correct dispensing channel 36C.

The circular refill buffer conveyor 32C retains a set of refill boxes. Each refill box is loaded onto the conveyor and rotated around until it reaches a position adjacent to the robotic arm 33C. The robotic arm 33C picks up the contents of a refill box, scans it to identify what type of product it is and then places it onto a movable X-Y placement mechanism The X-Y placement mechanism 34C comprises a box receptacle 341C moveable on a cross beam 342C in the Y-direction and the cross beam itself being moveable in the X-direction on guide sections 343C by virtue of drive motors. Once a product has been placed into the box receptacle 341C by the robotic arm 33C, the X-Y placement mechanism 34C transports the product 9C to the correct location for stacking and drops it from the box receptacle into the top of the stack 36C that has corresponding products stored there. To effect this, the box receptacle 341C comprises a hatch to release a product stored within into an appropriate vertical stack 36C.

The robotic arm 33C comprises several sections enabling movement in three-dimensional space. The robotic arm 33C further comprises a grab head adapted for handling different shapes and sizes of product via a flexible membrane. In use, the flexible membrane comprises a plurality of suction cups that can be used to suck the product to the grab head. Alternatively, the grab head can be gently closed by pincer movement of jaws of the grab head or a combination of suction and jaw movement. The amount of jaw movement required can be determined by the recognition of the product being handled. This is achieved by virtue of several scanning sensors provided in the grab head, which scan the product before it is picked up, and identify it. The grab head also has within it illumination sources which illuminate the product such that the scanning sensors can detect a product identifier. In one embodiment, this can be done by means of an identification barcode that is provided on all conventional products. The barcode identification enables dimensions of the product to be looked up from a database and this information can be used to control movement of the jaws. Also, optionally, the grab head can be fitted with pressure sensors that sense when a sufficient amount of pressure has been applied by the grab head to the product either through suction or by jaw movement to pick it up reliably but without damaging the product itself.

Thus the robotic arm 33C picks up the product, identifies it, and conveys it to the box receptacle and releases the product into the box receptacle 341C. The identification information is also provided to the X-Y placement mechanism 34C and is used to control its movement to the appropriate product stack 36C, where the product is released into the stack 36C.

It is to be appreciated that the X-Y placement mechanism 34C may place a product into a single stack of products or to a particular position within a cassette provided at a stack location. Also it is possible for multiple products to be handled in parallel by a single grab head and placed into a single layer of a cassette simultaneously.

Once a product has been deposited into a stack, it is lowered gently into the cassette of the corresponding product dispensing mechanism 40C using a sequential dropping mechanism, which moves a layer of products in the stack down a single level at a time. The layer may comprise one or a plurality of products. This mechanism comprises control sections at each level of the stack which in a closed configuration protrude into the core of the stack, effectively preventing product from moving down the stack, and which in an open configuration allow products in the stack to pass through that level unobstructed. Individual control and timing of the movement of the control sections enables controlled progression of the product to the correct position within the stack without any damage which could have been caused by the product falling from a significant height. Advantageously, products already in the stack are not disturbed during refilling. In contrast with other dispensing mechanisms, empty spaces within the stack can be filled without displacing existing products in the stack.

It will be appreciated that such semi-automated refilling systems 3C and its components such as the robot arm are applicable in other scenarios apart from product delivery at a service station, and so may constitute further inventive aspect of the present invention.

It will also be appreciated that different types of products may have different types of handling and storage requirements. For example, it may be necessary for products to be stored at different temperatures to avoid spoilage. To this end different stacking stations 30C may be arranged to handle such different sets of products—for example by dedicating one stacking station 30C to a first set of products requiring chilling at a few degrees Celsius, and dedicating another stacking station 30C to a second set of product requiring freezing below zero degrees Celsius. Each corresponding dispensing mechanism 40C may also be suitably refrigerated to guarantee the products are at the appropriate temperature during storage, prior to dispensing.

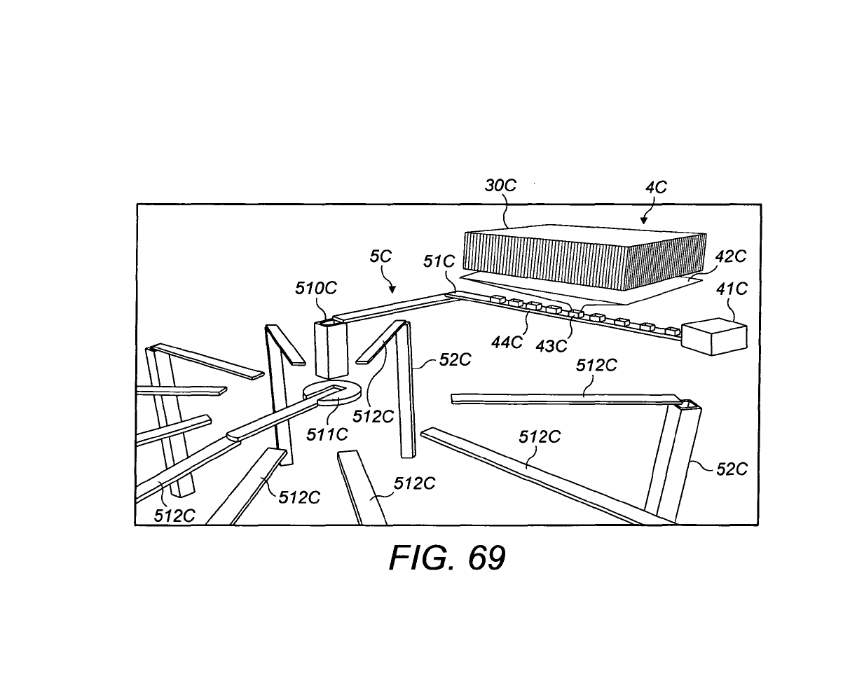

FIG. 69 shows a perspective schematic view of the automated product picking system 4C and the automated product routing and delivery system 5C.

The automated product picking system 4C comprises a series of smart collection box conveyor belts 51C each of which run from a smart box storage location 41C to directly underneath the collection funnel 43C of a respective stacking station 30C.

The smart box storage location 41C comprises an empty smart box store and a test station. The test station is provided for testing that the unique identity of a smart box is not being used elsewhere and that the functions of the smart boxes are working correctly (as will be described later). The testing station can also be used to apply a carrier bag as a lining to each smart box.

The series of smart collection box conveyor belts 51C converge at a drop chute 510C which takes the boxes to the product routing and delivery system 5C of the provisioning system. Specifically, and as will be described in greater detail below, the product routing and delivery system 5C comprises a rotatable directing hub conveyor belt 511C and ten distribution conveyor belts 512C, each of which lead to a corresponding product delivery channels 52C. The directing hub conveyor belt 511C is fed by the drop chute 510C and it in turn feeds the ten distribution conveyor belts 512C smart boxes 44C.

Although not shown in FIG. 69, it will be appreciated that there are a plurality of stacking stations 30C, each dedicated to different types of products. Accordingly, there are a corresponding plurality of smart box conveyor belts 51C. Furthermore, products may be treated prior to being deposited into a smart box and/or be fed from sources other than the stacking stations 30C.

For example, the automatic product picking system 4C may comprise a hot food processing conveyor belt. The hot food conveyor belt takes frozen/chilled items along a pathway through a microwave oven. The microwave oven defrosts the frozen food product and heats it up to the required temperature or simply heats the chilled food product. Then the product is moved along the hot food conveyor belt and is packaged by either a conventional packaging machine or a packaging operator. At the end of the hot food conveyor belt the packaged hot food is placed back onto a smart box 44C. In terms of how an order combining hot food and other items would be handled, the order would be split up and processed in two smart boxes each with slightly different delivery times. For the avoidance of doubt, it will be noted that delivery of chilled, non-chilled and even cooked products may also be applied to other embodiments of the product provisioning system 10.

Products are vertically stacked within stacking stations 30C and at any point in time there will be different amounts of product available for selection. Also the stacking station 30C is able to accommodate different sizes of each product by having different sized channels, as described in relation to the previous embodiments.

Although the stacking station 30C can release items substantially simultaneously, it is preferred to control the dispensing of products 9C from the stacking station to be controlled in a way that minimises damage to the items. In particular, it is preferred that heavy items are dispensed first and/or are disposed closer to the outlet of the funnel 43C such that the heavy items fall to the bottom of a smart box, with the lighter items on the top.

A further cushioning device may be provided in the form of a trap-door located at the outlet of the funnel 43C. The trap-door (not shown) comprises spring-loaded hinges that allow the trap-door to open gently under the weight of products collated by the funnel 43C, for delivery into the smart boxes 44C.

FIG. 70 shows an enlarged sectional schematic view of a cushioning structure 420C used in the collating funnel. Functionally, this is similar to the product delivery net 40 described in relation to the first embodiment.

The cushioning structure 420C is provided in the dropping surface of the collating funnel 42C and is comprised of a flexible structure 4210, which cushions the impact of a product 9C when it is released from a vertical stack of the stacking station 30C, and falls into the collating funnel 42C. The flexible structure 421C is made from a grid of wires 422C each having a plurality of rollers 423C provided thereon. The wire grid is tensioned so as to provide a degree of flexibility in the structure and the rollers 423C enable the released products to travel along the funnel under action of gravity to the opening 43C. To this end, and as shown in FIG. 69, the cushioning structure is sloped rather than flat as shown in FIG. 70. The rollers 423C can be made of various materials such as rubber (which itself provides additional cushioning) or even ceramic material (which is extremely durable).

For food items which have expiry dates, the automated product picking system 4C can record this date information when the particular product is entering the stacking station 30C from the semi-automated refilling system 3C and store the information for later use. On expiry of that product's sell by date, the product 9C can be expelled from the stacking station into a collection box that will be routed away from the customers and discarded at a trash location point. Thus a purge procedure of all expired items is provided for periodically removing any expired goods from the system.

As mentioned previously the automated product picking system 4C utilises product dispensing mechanisms 40C disposed at each product channel to effect controlled dispensing of product 9C under the control of the control system 6C and in response to receipt of a product order from a product ordering interface 50C. Such product dispensing mechanisms have already been described in relation to previous embodiments of the product provisioning system, and which are applicable in the present embodiment of the product provisioning system 1C. Similarly, various product dispensing mechanisms 40C of the present product provisioning system 10 will now be described, but the structure and principles of operation are also applicable to other embodiments.

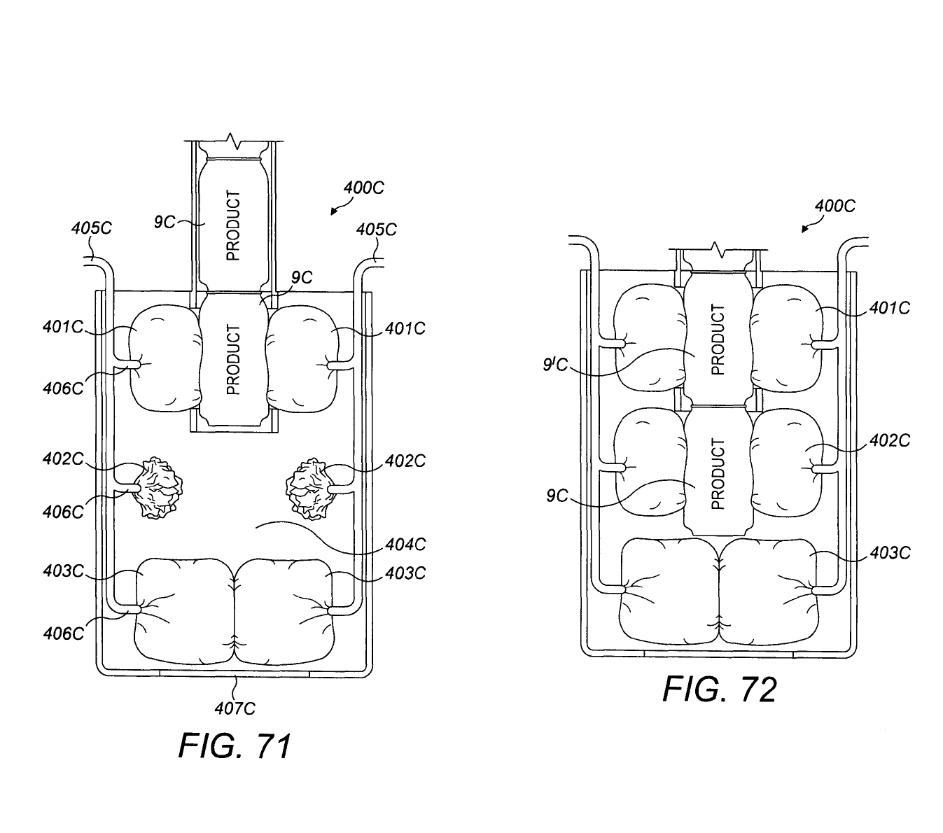

Referring to FIG. 71 there is a shown a schematic sectional view of an air-pressure powered product dispensing mechanism 400C for use with the stacking station 30C.

This product dispensing mechanism 400C comprises three sets of bladders or balloons 401C, 402C, 403C, each set positioned at intervals along a product dispensing channel 404C and within its internal periphery. The first set 401C—shown in an inflated state—is located at a first position above the second set 402 and the third set 403C. The second set 402C—shown in a deflated state—is located between the first and third set of balloons. The third set 403C—shown in an inflated state—is located below the first and second set within the channel 404C and adjacent to an exit aperture 407C of the channel 404C. Therefore, the balloons sets are provided in layers within the dispensing channel 404C—the first layer being defined by the first set, the second layer being defined by the second set and the third layer being defined by the third set. Each layer can engage or disengage a product provided in a central position from a vertical stack of products 9C coming from the stacking station 30C, depending on the state of inflation of its balloons. The advantage of this particular dispensing mechanism 400C is that the balloons can conform to a variety of differently shaped products, and so maximises the flexibility of the dispensing mechanism and provides a more sensitive product handling apparatus, which prevents damage to the products.

The balloons are connected to air-pressure supply tubes 405C via respective two-way valves 406C located at the interface between the balloons and air-pressure tubes 405C. Control of the air-pressure values 406C enables controlled inflation or deflation of a respective balloon. This control is exercised by the control system 6 in the following predetermined order of operation to dispense a single product 9C at a time.

Incidentally, the operation of the air-pressure powered product dispensing mechanism 400C is similar to the sequential dropping mechanism described earlier, in that a single product can be passed through at a time by controlling the engagement state of vertically-distributed actuators (such as balloons) in a predetermined order.

FIG. 72 shows Step 1 of said predetermined order of operation comprising inflating all three layers. The first layer, defined by the first set of balloons 401C engages an upper drinks can product 9′C, the second layer, defined by the second set of balloons 402C engages a lower drinks can product 9C and the lowermost or third layer defined by the third set of balloons 403C is fully inflated to act as a product supporting layer which prevents the product from progressing toward the exit aperture 407C. Step 2 comprises deflating the second and third layers thereby disengaging and removing the supporting layer under the lowermost drinks can 9C which is then free to fall towards the exit aperture 407C to be dispensed to the collating funnel 43C. Notably, the first layer remains inflated to prevent the entire stack of products from fall through. Step 3 comprises re-inflating the third layer to close the exit aperture 407C and so redefining the product supporting layer—as shown in FIG. 71. Once re-inflated Step 4 comprises deflating the first layer of balloons to disengage the drinks can product 9′C thereby indexing the stack down one place under the influence of gravity onto the product supporting layer defined by the third layer 403C. Step 5 comprises re-inflating all the layers to return the product dispensing mechanism to the first configuration shown in FIG. 72.

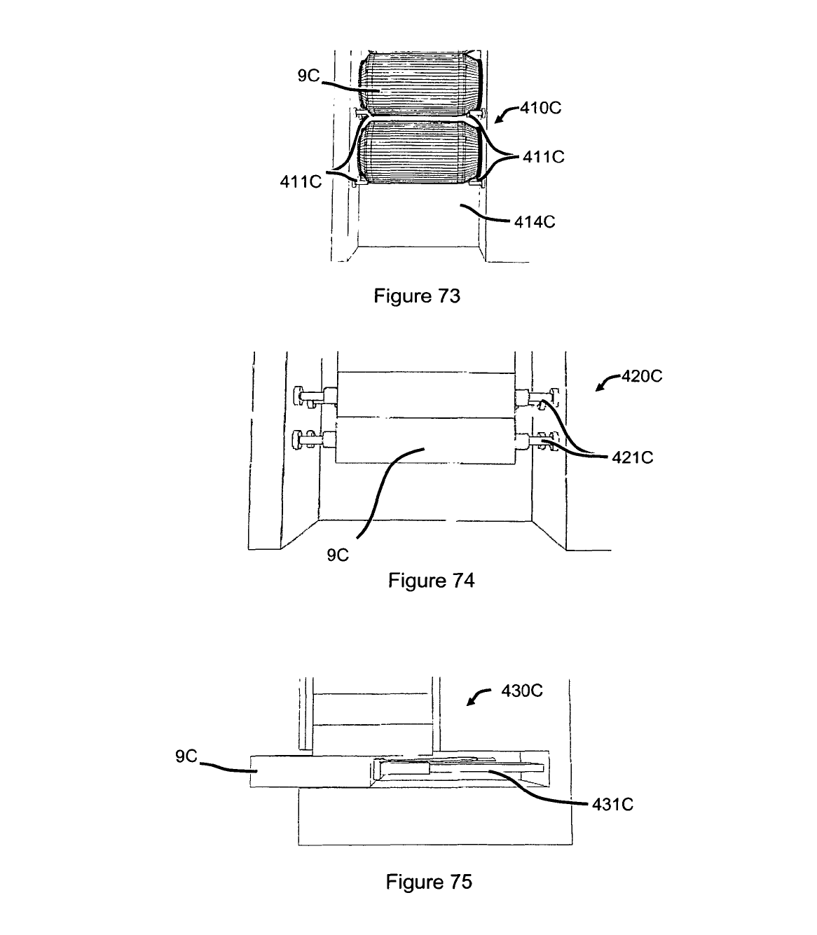

Referring now to FIGS. 73 to 76 in which sectional schematic views of many different types of vertically-orientated dispensing mechanisms 40C are shown which may be provided for use with the refilling and automated picking systems 3C, 4C. Some of these variations may be used individually or in combination for different types of products either individually or via a cassette. Each of these alternative mechanisms is provided at the bottom of a stack of the stacking station 30C.

In FIG. 73, a product dispensing mechanism 410C in the form of a can dispenser is shown which is arranged to dispense the cans 9C, one at a time, by controlling the position of retractable fingers 411C within the cassette 414C. FIG. 74 the same principle using retractable fingers 421C can be applied to box-like products. Alternatively, referring to FIG. 75, a push-rod system 431C is arranged to dispense products 9C sitting in a stack by pushing out the lowermost product in the stack.

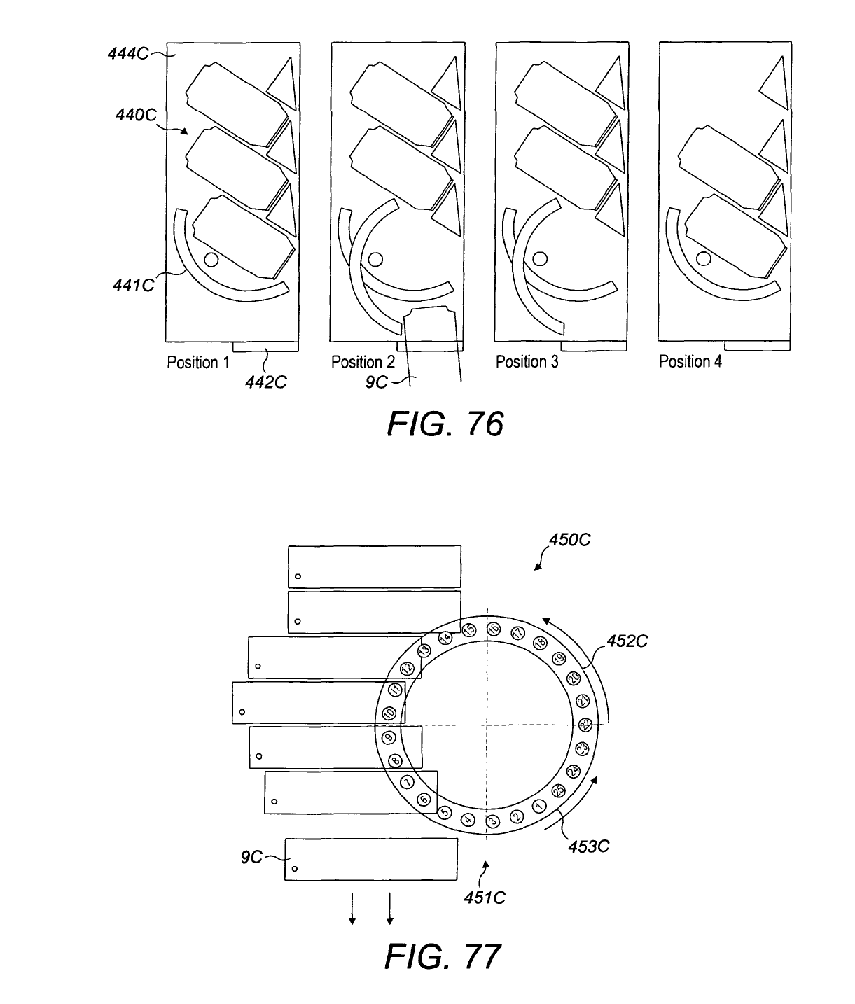

Referring to FIG. 76, there is shown a sequence of positions can dispensing mechanism 440C that may be used in such automated picking system 4C. As the can dispensing mechanism cycles through positions 1 to 4, it dispenses cans 9C, one at a time, which are dropped out of the underside of the can dispensing mechanism 440C. More specifically, at Position 1, a rotatably movable door 441C, which has a curved profile, is in a closed state. Here an exit aperture 442C of the dispensing mechanism 440C is obstructed thereby preventing delivery of the lowermost can 4C of a vertical stack of drinks cans. The cans are stacked at an angle with the sides of the cans touching each other. When in this orientation, no drinks can exit the dispensing mechanism, as the cans 9C are not aligned with the exit aperture 442C. In Position 2, the door 441C is rotated clockwise until the door 441C does not obstruct the exit aperture 442 anymore. In doing so the door rotation also rotates the lowermost drinks can, which is engaged with the door, to make it align with the exit aperture 442C. At this stage, the lowermost drinks can 9C is dispensed though the exit aperture. As shown in both Positions 2 and 3, the other end of the movable door acts to abut the next drinks can in the stack above the currently dispensed can. This reliably prevents dispensing of more than one drinks can at a time. Subsequently in Position 4, the door 441C is rotated back to its closed state and this enables the next drinks can in the stack to fall one position lower ready for dispensing.

The can dispensing mechanism comprises a cassette 444C that can be used to load a series of cans into the mechanism, even during operation. The cassette 444C makes the angle orientation of each can possible whilst at the same time generally storing the cans in a vertical orientation. This enables the mechanism 440C to take advantage of gravity to expel the cans from the exit aperture 442C. Also multiple cassettes can be stacked on top of each other thereby making the storage and refilling of the vertical stack more efficient. Multiple cans can, in this manner, be handled as a single unit in a single cassette. Further space saving advantages are realised with such vertically oriented dispensing mechanisms 440C.

FIG. 77 shows a schematic sectional view of a further product dispensing mechanism in the form of a boxed product dispenser 450C used for dispensing boxed products 9C from the bottom of a stacking station 30C. This boxed product dispenser 450C comprises a drive mechanism 451C that operates on rotational displacement of the boxed products 9C for dispensing of the products 9C from the stack. The mechanism comprises two indexing wheels 452C (only one shown in figures) each of which has a plurality of different product engaging elements 453C distributed around its circumference. The indexing wheels 452C are located on opposite sides of a vertical stack of boxed products 9C and are centred out of the line of the stack. This positioning enables an ideal trade off between unwanted lateral displacement of the engaged box products 9C and desirable increased number of engaged box products to be realised. In this embodiment, the indexing wheels engages five boxed products at a time but only displaces the boxes laterally by a maximum of 26%. The way in which the indexing wheels operate to reliably dispense one product box at a time is now described.

Five of the lowermost boxes 9C are engaged with the engaging elements 453C of the index wheels 452C. On rotation of the indexing wheels by one position and simultaneous release of the engaging elements coupled to the lowermost box in the stack, the lowermost box 9C can be released and dropped from the stack. Further rotation of the indexing wheels moves all of the product boxes to lower positions. There is lateral displacement of most boxes to different degrees depending on the position of the box in relation to the centre of rotation of the index wheels. Simultaneously, engaging elements become engaged with a product box which was previously not engaged with the mechanism. On rotation of the indexing wheels by one position and simultaneous release of engaging elements next in the series the next lowermost product element can be released and dropped from the stack. This process repeats to dispense further products. The advantage of this system is that it is very easy to control reliably the release of one box at a time and this mechanism is relatively cheap to manufacture. Furthermore the mechanism is very robust and reliable.

Each dispensing mechanism 40C mentioned above is, in general terms, a vertically-oriented tube of regular, usually rectangular cross-section. A large number of mechanisms can be mounted adjacent to one another to define the stacking station 30C. Each dispensing mechanism 40C of the dispensing system can be independently operated, and so products can be dispensed simultaneously from each dispensing mechanism 40C. As a result dispensing mechanisms 40C can together simultaneously dispense multiple goods of different types in parallel.

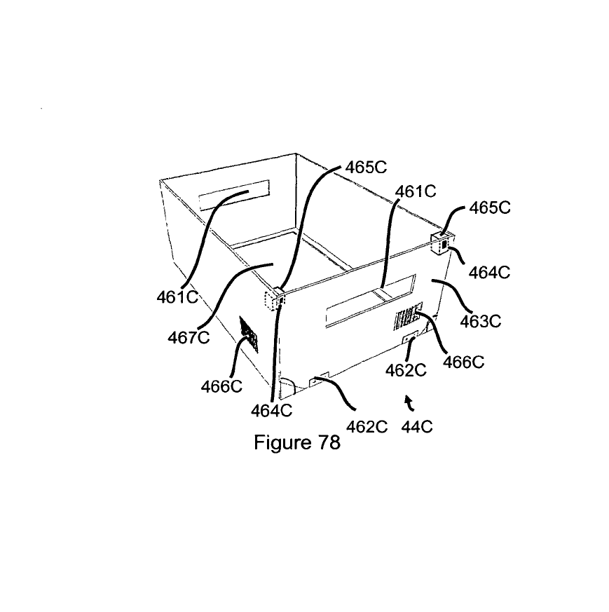

FIG. 78 shows a schematic perspective view of the smart box 44C described generally above and handled specifically by the automated product picking system 4C. The smart box 44C generally comprises a rectangular shaped body and is constructed of a lightweight but durable plastics material. Two carrying handles 461C are provided as cut out apertures in the end walls of the smart box 44C. One these end walls comprises two hinges 462C which enable the appropriate end wall 463C to open 90 degrees thereby enabling access to the box 44C from the front. The hinged end wall 463C is retained in a closed state by means of steel places 464C which are provided at the side and upper corners of the end wall, which in use engage two magnets 465C, provided at corresponding positions on the side walls of the box 44C. If enough force is applied to the hinged end wall, the box 44C opens.

The smart box 44C is also provided with identifying markings on each of its exterior walls. These markings take the form of an identifying barcode 466C, which enables a tracking system to assign a unique identity to the smart box 44C as it moves through the product provisioning system 1C. A conventional barcode reader can read each bar code 466C at any stage during its progression through the provisioning system.

The smart box can also comprise a power source in the form of a battery and a microprocessor chip (not shown). The microprocessor can control the feedback of the location of the device and its current state. Also a radio localisation module (akin to a GPS module) is provided for determining the exact location of the box, which can then be communicated to the control system 6C of the product provisioning system 10 together with an identity of the box 44C to determine an exact location at any time. In this way, the box 44C can by itself determine its position within the provisioning system 1C at any time and this can be used in tracking the delivery of the appropriate box to the correct delivery location.

In addition, the smart box 44C has provided in its base a scale in the form of a digital weight sensor 467C. The scale 467C enables the box 44C to determine if it has any items within it and also how heavy the products are. This is important when the box is being emptied as it enables the box 44C to provide feedback to a control system 6 to indicate when it has been emptied by a product ordering customer. Also during a filling stage within the product picking system 4C, the smart box 44C can determine when a maximum weight of goods has been reached and feed this back to the product picking system 4C to signal the need to use a second box for the rest of the order. Furthermore, if a product contents estimation (e.g. via a weight reading, as measured by the sensor in the base of the smart box 44C), does not tally with the number of products that have been dispensed into the box 44C, then the box can be flagged to an operator so that the mismatch can be inspected and rectified.

A carrier bag can be fitted to the smart box 44C before any products 9C are added to the box. Typically, the bags are applied to the boxes at the beginning of the smart collection box conveyor belt 51C from the empty box storage area 41C, such that the bag lines the box. In use the carrier bag is attached loosely to the edges of the box and have enough slack at the hinged end wall portion to enable the hinged end wall to open without difficulty. Nevertheless, the act of opening the hinged end wall, helps to disengage the bag from the other walls of the box and makes its removal by a user relatively easy.

Referring back to FIG. 69, as mentioned, the smart collection box conveyor belts 51C converge at a drop chute 510C which takes the boxes to the product routing and delivery system 5C of the provisioning system after the automated product picking system 4C has deposited the required goods into the smart box 44C.

The drop chute 510C leads to the rotatable directing hub conveyor belt 511C. The rotatable directing hub conveyor belt 511C can be controlled by the delivery system to connect to any one of the ten distribution conveyor belts 512C provided. At the end of each of the ten distribution conveyor belts, there is provided an appropriate drop down delivery channel 52C to the corresponding delivery point. Rotation of the rotatable directing hub conveyor belt 511C is controlled by the control system 6C, which determines the exact location that each smart box needs to be conveyed to and controls the rotatable directing hub conveyor belt 511C accordingly. Thus each smart box 44C emerging out of the drop chute 510C is connected to an appropriate distribution conveyor belt 512C, which creates a path to the appropriate drop down delivery channel 52C.

The drop chute 510C interfaces between the different storeys. The distribution conveyor belts 512C can be sloped from the rotatable directing hub conveyor belt to the actual delivery channels. Alternatively, instead of conveyor belts 512C, slides can be provided. It will be understood that the advantage of using slides is the reduced complexity and maintenance cost. The advantage of using conveyor belts is the increased control over exactly when smart boxes are delivered to delivery channels 52C.

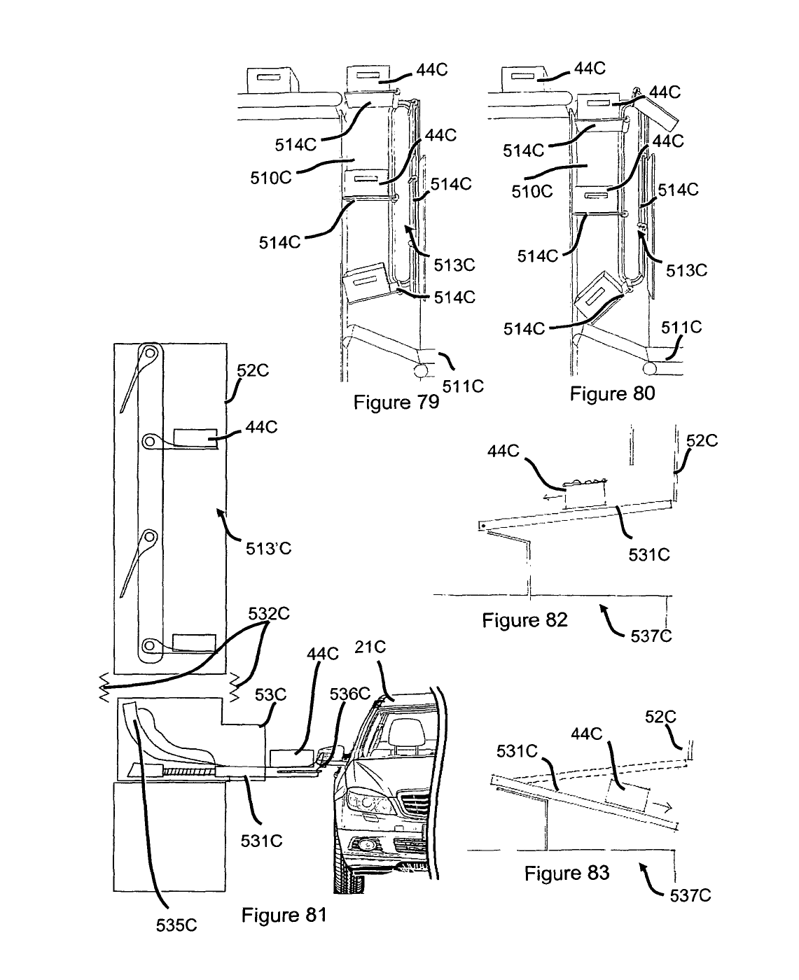

FIGS. 79 and 80 show schematic side views of the drop chute 510C in greater detail. The drop chute comprises a vertical conveyer system 513C that provides a stable platform for each smart box 44C as it feeds into the drop chute 5100. Rotatable arms 514C are provided on the vertical conveyor system 513C for retaining each box. When the arms are travelling in a downward direction they are positioning in an open configuration to retain a smart box 44C. However when travelling in an upward return direction, the arms 514C are in a folded condition. Advantageously, this saves space within the product provisioning system 10.

Thus as smart boxes 44C are fed into the drop chute 510C each box slides onto a rotatable holding arm 514C in a horizontal position and is reliably conveyed from the top of the chute 510C to its bottom. The vertical conveyor system 513C is actively controlled via a motor to control the position of smart boxes within it. However, it will be appreciated that in alternatives, a drop control mechanism may be provided that locks the vertical conveyor belt system until a box is fully loaded onto it at its upper end, and then releases the vertical conveyor system—being propelled under the weight of the smart box 44C.

At the bottom of the drop chute 510C the smart box 44C is gently delivered to the rotatable directing hub conveyor belt 511C and the holding arms 514C of the vertical conveyor system 513C are returned in sequence to the top of the drop chute 510C. A similar mechanism is used in each final delivery drop channel 52C.

FIG. 81 shows a sectional schematic view of a similar vertical conveyor system 513′C that conveys smart boxes 44C to the product dispenser 53C, as shown schematically in FIG. 67.

The product dispenser defines a collection booth 53C which comprises a curved sliding surface 535C, which is used to slide a dropped smart box 44C from the bottom of the final delivery drop channel 52C to an extendable delivery arm 531C of the collection booth.

The extendable delivery arm 531C of the collection booth 53C can be extended to reach the vehicle 21C window over a range of distances. The extendable delivery arm 531C has on it formations which provide an end stop 536C to travel of the smart box towards the vehicle window. Also the entire collection booth 53C is connected to the final delivery drop channel 52C by means of an extendable bellows 532C structure, which can be manipulated to control the relative height of the collection booth 53C and thus the height of the delivery arm 531C. In this way the delivery arm 531C can be positioned over a range of heights and distances to accommodate the range of positions of vehicle windows of different vehicles 21C.

In alternatives, the delivery arm may be rotatable about a pivot at the collection booth to adjust the delivery height to window of different sized vehicles 21C. The alternative rotatable arm is extendible to ensure delivery to the vehicle regardless of parking distance from the final delivery drop channel.

Once the smart box 44C and its contents is adjacent the vehicle window, the end wall of the box 463C, facing the vehicle window, can then be opened towards the vehicle driver. The carrier bag which lines the smart box 44C, and within which ordered product are contained can be thus removed without undue difficulty. Once the carrier bag containing all of the ordered products has been removed from the box, the delivery arm 531C is retracted and the empty smart box 44C is returned via a tilt and slide recycling mechanism so it may be returned to the empty box storage location 41C.

FIGS. 82 and 83 show schematic side views of the tilt and slide mechanism 537C. The initial positioning of the delivery arm 531C shown in FIG. 82 is in a downward titled position from the base of the final delivery channel 52C to the vehicle window. Once the box has reached the delivery arm 531C, it slides along the arm 531C towards the vehicle window. Once the user has taken the products from the smart box 44C, the delivery arm 531C, which is also pivoted at its free end, changes the direction of the tilt as shown in FIG. 83. The result is that the empty smart box 44C slides away from the vehicle window and towards a transport system (not shown), which conveys it to the empty smart box storage area 41C.

1-15. (canceled)

16. A product provisioning system arranged, in use, to deliver to a user substantially simultaneously a plurality of heterogeneous discrete products, the product provisioning system comprising:
a plurality of different and independently-controllable product dispensing mechanisms being arranged to dispense different product types from one another, each product dispensing mechanism being arranged to dispense discrete products of a uniform type;
a product collector arranged to collect together products dispensed by the plurality of product dispensing mechanisms; and
a control system in communication with the product dispensing mechanisms, the control system being arranged to receive a user-specified product order for multiple heterogeneous products and, in response, control a set of the plurality of product dispensing mechanisms in parallel to dispense, substantially simultaneously, the products specified in that product order.

17. A product provisioning system according to claim 16, wherein at least one of said product dispensing mechanisms comprises a substantially vertically-oriented channel through which said discrete products travel under action of gravity during product dispensing, said product dispensing mechanism being configured to control the passage of products through the channel.

18. A product provisioning system according to claim 17, wherein the at least one product dispensing mechanism comprises a restriction means for controlling the effective cross-sectional area of the channel through which said discrete products travel under action of gravity during product dispensing, the restriction means thereby controlling the passage of products through the channel.

19. A product provisioning system according to claim 16, further comprising a plurality of product channels that are aligned relative to one another to maximise the utilization of space.

20. A product provisioning system according to claim 19, wherein each product channel is adapted to contain a stack of discrete products of a uniform type, the products in that stack being dispensable by a respective one of the product dispensing mechanism

21. A product provisioning system according to claim 20, wherein each product channel comprises a respective channel inlet, each inlet being arranged to admit a plurality of discrete products of the same predetermined type into the respective channel, the channel inlets being located adjacent to one another to facilitate product restocking.

22. A product provisioning system according to claim 21, wherein each product channel and respective dispensing mechanism is arranged so that products are dispensed by the dispensing mechanism from the product channel in the same sequence as they are inserted into the product channel via the channel inlet.

23. A product provisioning system according to claim 22, further comprising a product tracking means for tracking an expiry date of products loaded into the plurality of product channels, the product tracking means being arranged to determine when products have exceeded their expiry date and, in response, control respective product dispensing mechanisms to purge those expired products from the product channels.

24. A product provisioning system according to claim 16, further comprising a receptacle dispenser, arranged to dispense receptacles such as plastic bags, and operable to dispense a number of receptacles in response to size of the product order.

25. A product provisioning system according to claim 16, wherein the product collector comprises a cushioned surface onto which said dispensed products are dropped.

26. A product provisioning system according to claim 16, further comprising a product ordering interface configured to display a list of orderable products to a user, receive a user interaction to select multiple products of that list, and receive a user-driven command to transmit said selected multiple products as the user-specified product order to the control system.

27. A product provisioning system according to claim 26, wherein the product ordering interface is configured to display the multiple selected products together with their total price to the user, prior to receiving the user-driven command to transmit the product order to the control system.

28. A product provisioning system according to claim 16, further comprising an authentication device arranged to determine that a product-ordering user is authorized to receive products of the user-specified product order, and in response control user-access to said products.

29. A product provisioning system according to claim 28, wherein said authentication device comprises a payment card reader.

30. A product provisioning system according to claim 16, further comprising a product router for routing products of a product order to one of a plurality of delivery locations, each delivery location being associated with an individual product-ordering user.

31. A product provisioning system according to claim 16, further comprising a product ordering system that is arranged to present an electronic menu system to a user, the electronic menu system being configured to:
display a list of orderable products to the user;
receive a user selection of multiple products of that list to form a user-specified product order; and
communicate the user-specified product order to the control system via a wireless communication link.

32. A product provisioning system according to claim 31, wherein the electronic menu system is arranged to present a series of pages to a user in a sequence to receive user selections of products having longer delivery times before those having a relatively shorter delivery times.

33. A product provisioning system according to claim 31, wherein the product ordering system presents a progress indicator configured to provide dynamic feedback to the user about the progress of the delivery of at least one of the ordered products.

34. A product ordering system in combination with a product provisioning system, the product ordering system being arranged to present an electronic menu system to a user, the electronic menu system being configured to:
i. display a list of orderable products to the user;
ii. receive a user selection of multiple heterogeneous discrete products of that list to form a user-specified product order; and
iii. communicate the user-specified product order to the product provisioning system;
the product provisioning system being operable to receive the user-specified order for multiple heterogeneous products and, in response, deliver every product of the order to the user.

35. A product provisioning method for delivering to a user substantially simultaneously a plurality of heterogeneous discrete products, the method comprising receiving a user-specified product order for multiple heterogeneous products and, in response, controlling a set of a plurality of product dispensing mechanisms in parallel to dispense, substantially simultaneously, products of that product order.
